(19) United States
(12) Patent Application Publication
(10) Pub. No.: US 2026/0361942 A1
(43) Pub. Date: Nov. 12, 2026

(54) DISPLAY APPARATUS AND METHOD FOR DISPLAY APPARATUS

(71) Applicant: VIDAA (NETHERLANDS) INTERNATIONAL HOLDINGS B.V., Duiven (NL)

(72) Inventors: Yunying HAO, Qingdao (CN); Aiju SANG, Qingdao (CN); Jianlei LI, Qingdao (CN); Xingwei YANG, Qingdao (CN); Fang YAN, Qingdao (CN)

(21) Appl. No.: 19/286,596

(22) Filed: Jul. 31, 2025

Related U.S. Application Data
(63) Continuation of application No. PCT/EP2024/065558, filed on Jun. 6, 2024.

(30) Foreign Application Priority Data
Jun. 16, 2023 (CN) 202310717571.6
Jun. 30, 2023 (CN) 202310802436.1
Jul. 7, 2023 (CN) 202310833613.2
Jul. 7, 2023 (CN) 202310834840.7

(51) Int. Cl. H04N 21/422; G10L 15/18; G10L 15/22; G10L 15/30; H04N 21/437; H04N 21/475; H04N 21/482; H04N 21/485

(52) U.S. Cl. CPC H04N 21/42203; G10L 15/1815; G10L 15/1822; G10L 15/22; G10L 15/30; H04N 21/437; H04N 21/4828; H04N 21/485; G10L 2015/223; H04N 21/4753

(57) ABSTRACT

Embodiments of the disclosure disclose a display apparatus and a method for the display apparatus. The method can include: sending a voice command to a server through the communicating device, to cause the server to parse the voice command and determine semantic information corresponding to the voice command; receiving the semantic information sent from the server, and determining setting parameters corresponding to the voice command according to the semantic information; and controlling the display to display a target setting interface according to the setting parameters, and setting the target setting option in the target setting interface according to the setting parameters.

### CROSS-REFERENCE TO RELATED APPLICATIONS

The disclosure is a continuation application of International Application No. PCT/EP2024/065558, filed on Jun. 6, 2024, which claims the priorities of the Chinese patent applications No. 202310717571.6 filed on Jun. 16, 2023, No. 202310802436.1 filed on Jun. 30, 2023, No. 202310833613.2 filed on Jul. 7, 2023, and No. 202310834840.7 filed on Jul. 7, 2023, of which the entire contents are incorporated herein by reference.

### TECHNICAL FIELD

The disclosure relates to the technical field of voice processing, in particular to a display apparatus, a voice processing method and apparatus, and a storage medium.

### BACKGROUND

With the continuous development of a voice technology, voice interaction has become an important way in human-computer interaction. For example, in the field of intelligent home interfaces, a user may control an intelligent device to operate through a voice command.

However, with the gradual diversification of functions and services that the intelligent device can provide, the demand for the user to control the intelligent device to complete operations through the voice command is also increasing. However, an existing voice control method can only recognize simple user commands, such as opening or closing an application, starting or pausing playback, and cannot control complex functions, nor can it adjust apparatus parameters of a display apparatus according to the voice command from the user. Therefore, the intelligence level of voice control for the intelligent device is not high, and the user experience is also relatively poor.

### SUMMARY

Some embodiments of the disclosure provide a display apparatus, including:
a display, configured to display an image or a user interface, the user interface including a setting interface;
a communicating device, configured to receive a voice command input from a user, the voice command being configured for setting a target setting option of the display apparatus, wherein, the display apparatus includes a plurality of setting options, and the target setting option is any one of the plurality of setting options; and
at least one processor, coupled with the display and the communicating device respectively, and configured to execute computer instructions to cause the display apparatus to execute:
sending the voice command to a server through the communicating device, to cause the server to parse the voice command and determine semantic information corresponding to the voice command;
receiving the semantic information sent from the server, and determining setting parameters corresponding to the voice command according to the semantic information; and
controlling the display to display a target setting interface according to the setting parameters, and setting the target setting option in the target setting interface according to the setting parameters.

Some embodiments of the disclosure further provide a method for a display apparatus, including:
receiving a voice command input from a user, the voice command being configured for setting a target setting option of the display apparatus, wherein, the display apparatus includes a plurality of setting options, and the target setting option is any one of the plurality of setting options;
sending the voice command to a server, to cause the server to parse the voice command and determine semantic information corresponding to the voice command;
receiving the semantic information sent from the server, and determining setting parameters corresponding to the voice command according to the semantic information; and
controlling a display to display a target setting interface according to the setting parameters, and setting the target setting option in the target setting interface according to the setting parameters.

### BRIEF DESCRIPTION OF FIGURES

FIG. 1 is a schematic diagram of interaction between a display apparatus and a control device according to some embodiments of the disclosure.

FIG. 2 is a block diagram of configuration of a control device according to some embodiments of the disclosure.

FIG. 3 is a block diagram of hardware configuration of a display apparatus according to some embodiments of the disclosure.

FIG. 4 is a schematic diagram of software configuration in a display apparatus according to some embodiments of the disclosure.

FIG. 5 is a diagram of a system architecture of a television according to some embodiments of the disclosure.

FIG. 6 is a schematic diagram of a system architecture of a display apparatus according to some embodiments of the disclosure.

FIG. 7 is a flow diagram of a voice processing method according to some embodiments of the disclosure.

FIG. 8 is a flow diagram of another voice processing method according to some embodiments of the disclosure.

FIG. 9 is a schematic structural diagram of option configuration data according to some embodiments of the disclosure.

FIG. 10 is a flow diagram of a setting item setting method according to some embodiments of the disclosure.

FIG. 11 is a sub flow diagram of a setting item setting method according to some embodiments of the disclosure.

FIG. 12 is a flow diagram of another setting item setting method according to some embodiments of the disclosure.

FIG. 13 is a flow diagram of yet another setting item setting method according to some embodiments of the disclosure.

FIG. 14 is a flow diagram of yet another voice processing method according to some embodiments of the disclosure.

FIG. 15 is a flow diagram of yet another voice processing method according to some embodiments of the disclosure.

FIG. 16A is a schematic diagram of a target setting interface according to some embodiments of the disclosure.

FIG. 16B is a schematic diagram of another target setting interface according to some embodiments of the disclosure.

FIG. 17 is a schematic diagram of yet another target setting interface according to some embodiments of the disclosure.

FIG. 18A is a schematic diagram of yet another target setting interface according to some embodiments of the disclosure.

FIG. 18B is a schematic diagram of yet another target setting interface according to some embodiments of the disclosure.

FIG. 19 is a flow diagram of yet another voice processing method according to some embodiments of the disclosure.

FIG. 20 is a schematic diagram of prompt information according to some embodiments of the disclosure.

FIG. 21 is a schematic diagram of another prompt information according to some embodiments of the disclosure.

FIG. 22A is a schematic diagram of yet another target setting interface according to some embodiments of the disclosure.

FIG. 22B is a schematic diagram of yet another target setting interface according to some embodiments of the disclosure.

FIG. 23 is a schematic diagram of an automatic channel search page according to some embodiments of the disclosure.

FIG. 24 is a flow diagram of yet another voice processing method according to some embodiments of the disclosure.

FIG. 25A is a schematic diagram of yet another prompt information according to some embodiments of the disclosure.

FIG. 25B is a schematic diagram of yet another prompt information according to some embodiments of the disclosure.

FIG. 26 is a schematic diagram of another automatic channel search page according to some embodiments of the disclosure.

FIG. 27 is a schematic diagram of yet another automatic channel search page according to some embodiments of the disclosure.

FIG. 28 is a schematic diagram of interaction according to some embodiments of the disclosure.

FIG. 29 is a schematic structural diagram of a voice processing device according to some embodiments of the disclosure.

FIG. 30 is a schematic diagram of an effect of searching for a media resource through a preset key according to some embodiments of the disclosure.

FIG. 31 is a schematic flow diagram of executing a display method of a media resource recommendation page in a display apparatus according to some embodiments of the disclosure.

FIG. 32 is a schematic diagram of an effect of displaying media resource information in a display apparatus according to some embodiments of the disclosure.

FIG. 33 is a schematic diagram of an effect of displaying a channel list of a media resource in a display apparatus according to some embodiments of the disclosure.

FIG. 34 is a schematic flow diagram of generating a media resource recommendation page containing a recommended channel in a display apparatus according to some embodiments of the disclosure.

FIG. 35 is a schematic flow diagram of detecting a network connection status and a supporting channel status in a display apparatus according to some embodiments of the disclosure.

FIG. 36 is a schematic diagram of an effect of displaying a media resource recommendation page in a display apparatus in a floating form according to some embodiments of the disclosure.

FIG. 37 is a schematic flow diagram of setting a display parameter of a media resource recommendation page in a display apparatus according to some embodiments of the disclosure.

FIG. 38 is a schematic flow diagram of setting a dimension parameter in a display apparatus according to some embodiments of the disclosure.

FIG. 39 is a schematic flow diagram of a display method of a media resource recommendation page according to some embodiments of the disclosure.

FIG. 40 is a flow diagram of modifying a channel list to which a channel belongs in a display apparatus according to some embodiments of the disclosure.

FIG. 41 is a flow diagram of setting a first target channel as a favorite channel in a display apparatus according to some embodiments of the disclosure.

FIG. 42 is a flow diagram of modifying a channel list to which a channel belongs in a display apparatus according to some embodiments of the disclosure.

FIG. 43A, FIG. 43B, FIG. 43C, FIG. 43D and FIG. 43E are schematic diagrams of interaction of setting a first target channel as a favorite channel in a television according to some embodiments of the disclosure.

FIG. 44 is a flow diagram of deleting a favorite channel in a display apparatus according to some embodiments of the disclosure.

FIG. 45A, FIG. 45B, FIG. 45C and FIG. 45D are schematic diagrams of interaction of setting a second target channel as a non-favorite channel in a television according to some embodiments of the disclosure.

FIG. 46 is a flow diagram of modifying a list name of a favorite list in a display apparatus according to some embodiments of the disclosure.

FIG. 47 is a flow diagram of modifying a list name of a favorite list in a display apparatus according to some embodiments of the disclosure.

FIG. 48A, FIG. 48B, FIG. 48C and FIG. 48D are schematic diagrams of interaction of renaming a list name of a target favorite list in a television according to some embodiments of the disclosure.

FIG. 49 is a flow diagram of adding a shortcut of a channel on a home interface in a display apparatus according to some embodiments of the disclosure.

FIG. 50A, FIG. 50B, FIG. 50C and FIG. 50D are schematic diagrams of interaction of renaming a list name of a target favorite list in a television according to some embodiments of the disclosure.

FIG. 51 is a flow diagram of simultaneously providing an entry for modifying a channel list to which a channel in a list display region belongs and modifying a display manner of the channel in a display apparatus according to some embodiments of the disclosure.

FIGS. 52A and 52B are schematic diagrams of interaction of simultaneously providing an entry for modifying a channel list to which a channel in a list display region belongs and modifying a display manner of the channel in a display apparatus according to some embodiments of the disclosure.

FIGS. 53A and 53B are schematic diagrams of interaction of adjusting a status of a button in a display apparatus according to some embodiments of the disclosure.

FIG. 54 is a flow diagram of modifying a first type of a channel in a display apparatus according to some embodiments of the disclosure.

FIG. 55 is a flow diagram of changing a first channel to a favorite channel in a display apparatus according to some embodiments of the disclosure.

FIG. 56 is a flow diagram of modifying a first type of a channel in a display apparatus according to some embodiments of the disclosure.

FIG. 57A, FIG. 57B and FIG. 57C are first schematic diagrams of interaction of modifying a first type of a first channel in a television according to some embodiments of the disclosure.

FIGS. 58A and 58B are second schematic diagrams of interaction of modifying a first type of a first channel in a television according to some embodiments of the disclosure.

FIG. 59A, FIG. 59B, FIG. 59C and FIG. 59D are schematic diagrams of interaction of modifying a first type of a second channel in a television according to some embodiments of the disclosure.

FIG. 60 is a flow diagram of changing a first type of a switched second channel in a display apparatus according to some embodiments of the disclosure.

FIG. 61 is a flow diagram of changing a second type of a first channel in a display apparatus according to some embodiments of the disclosure.

FIG. 62 is a flow diagram of changing a second type of a first channel in a display apparatus according to some embodiments of the disclosure.

FIG. 63A, FIG. 63B and FIG. 63C are first schematic diagrams of interaction of modifying a second type of a first channel in a television according to some embodiments of the disclosure.

FIGS. 64A and 64B are second schematic diagrams of interaction of modifying a second type of a first channel in a television according to some embodiments of the disclosure.

FIG. 65 is a schematic diagram of a channel information bar simultaneously including a first control and a second control according to some embodiments of the disclosure.

FIG. 66 is a schematic diagram of a channel information bar including a progress bar according to some embodiments of the disclosure.

FIG. 67 is a flow diagram of displaying program information in a display apparatus according to some embodiments of the disclosure.

FIG. 68A, FIG. 68B and FIG. 68C are schematic diagrams of interaction of displaying program information in a television according to some embodiments of the disclosure.

FIG. 69A, FIG. 69B and FIG. 69C are schematic diagrams of interaction of displaying program information in a television according to some embodiments of the disclosure.

FIG. 70 is a flow diagram of switching a channel and displaying a program detail page in a display apparatus according to some embodiments of the disclosure.

FIG. 71 is a flow diagram of switching a channel and displaying a program detail page in a display apparatus according to some embodiments of the disclosure.

FIG. 72A and FIG. 72B are schematic diagrams of interaction of switching a channel in a television according to some embodiments of the disclosure.

FIG. 73A, FIG. 73B and FIG. 73C are schematic diagrams of interaction of displaying a program detail page in a television according to some embodiments of the disclosure.

### DETAILED DESCRIPTION

In order to make the objective and implementations of the disclosure clearer, the exemplary implementations of the disclosure will be described below clearly and completely with reference to the drawings in embodiments of the disclosure. Apparently, the described embodiments are only part of the embodiments of the disclosure, but not all the embodiments.

It should be noted that the brief description of the terms in the disclosure is only for conveniently understanding the following described implementations, and is not intended to limit the implementation of the disclosure. Unless otherwise noted, these terms should be understood according to their common and usual meanings.

Terms “first”, “second”, “third” and the like in the specification and the claims of the disclosure and the above drawings are used for distinguishing similar or homogeneous objects or entities, and are not necessarily meant to limit a specific order or a precedence order, unless otherwise noted. It should be understood that words used in this way can be interchanged where appropriate.

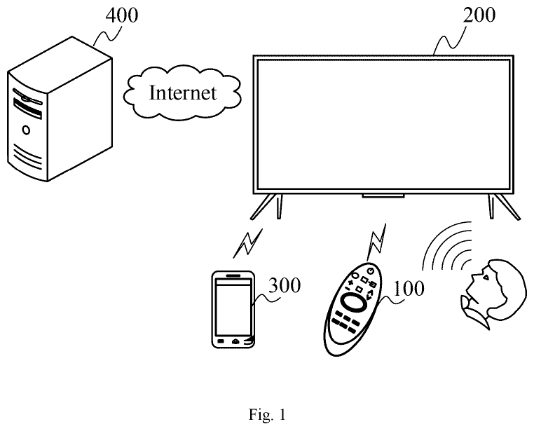

Embodiments of the disclosure provide a display apparatus and a voice processing method, and the voice processing method may be applied to the display apparatus. FIG. 1 is a schematic diagram of interaction between a display apparatus and a control device according to some embodiments of the disclosure. As shown in FIG. 1, a user may operate the display apparatus 200 through a mobile terminal 300 or the control device 100. The control device 100 may be a remote control, and the remote control and the display apparatus 200 may communicate through an infrared protocol and a Bluetooth protocol, or the remote control may also control the display apparatus 200 through wireless or other wired manners.

The user may control the display apparatus 200 by inputting a user command through keys on the remote control, voice input, a control panel, and the like. For example, the user may control the display apparatus 200 to switch displayed pages through up-down keys on the remote control, control playback or pause of videos played by the display apparatus 200 through a play-pause key, and input a voice command through a voice input key so as to control the display apparatus 200 to execute corresponding operations.

In some embodiments, the user may also control the display apparatus 200 by using a mobile terminal, a tablet computer, a computer, a notebook computer and other intelligent devices. For example, the user may control the display apparatus 200 through an application installed on the intelligent device, and the application may be configured to provide the user with various controls in an intuitive user interface on a screen associated with the intelligent device.

In some embodiments, the mobile terminal 300 may connect and communicate with software applications installed on the display apparatus 200 through a network communication protocol, achieving purposes of one-on-one control operations and data communication. For example, a command protocol may be established between the mobile terminal 300 and the display apparatus 200, a remote control keyboard is synchronized to the mobile terminal 300, and the function of the display apparatus 200 is controlled by controlling a user interface on the mobile terminal 300. Alternatively, a content displayed on the mobile terminal 300 may also be transmitted to the display apparatus 200 to achieve a function of synchronous display.

As shown in FIG. 1, the display apparatus 200 and a server 400 may be in data communication through various communication manners, and the display apparatus 200 may be allowed to be in communication connection through a local area network (LAN), a wireless local area network (WLAN), and other networks. The server 400 may provide various contents and interactions for the display apparatus 200. For example, the display apparatus 200 performs interaction by sending and receiving a message and an electronic program guide (EPG), receives software program update, or accesses a remotely stored digital media library. The server 400 may be one or more clusters, and may include one or more kinds of servers.

The display apparatus 200 may be a liquid crystal display, an organic light-emitting diode (OLED) display, a projection display apparatus, and an intelligent terminal, such as a mobile phone, a tablet computer, an intelligent television, a laser projection device, and an electronic table. The specific types, dimensions, resolutions, and the like of the display apparatus are not limited.

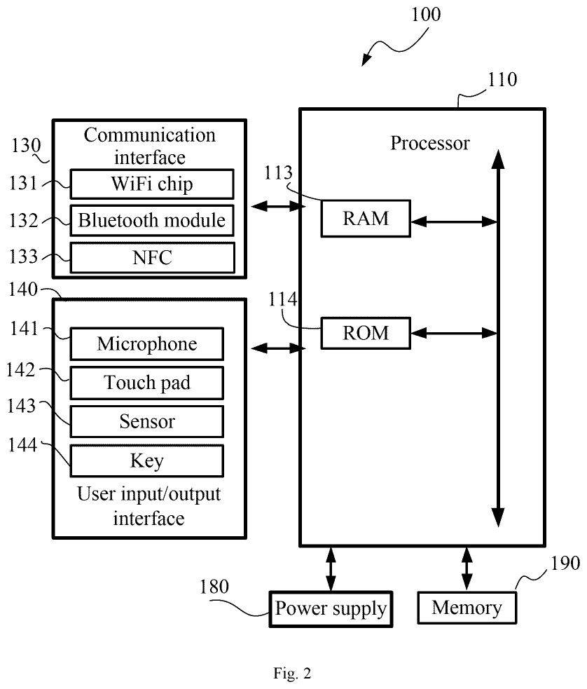

FIG. 2 is a block diagram of configuration of a control device 100 according to some embodiments of the disclosure. As shown in FIG. 2, the control device 100 may include at least one processor 110, a communication interface 130, a user input/output interface 140, a memory 190 and a power supply 180. The control device 100 may receive an operation command input from the user, and convert the operation command into a command available for being recognized and responded to by the display apparatus 200, thereby playing an interaction intermediary role between the user and the display apparatus 200.

The control device 100 is configured to control the display apparatus 200, may receive the operation command input from the user and convert the operation command into the command available for being recognized and responded to by the display apparatus 200, thereby playing an interaction intermediary role between the user and the display apparatus 200.

In some embodiments, the control device 100 may be an intelligent device. For example, the control device 100 may be installed with various applications for controlling the display apparatus 200 according to user needs.

In some embodiments, as shown in FIG. 1, the mobile terminal 300 or other intelligent electronic devices may play a similar function as the control device 100 after installing the applications for controlling the display apparatus 200.

The processor 110 may include a RAM 113, a ROM 114, and a communication bus. The processor 110 is configured to control running and operations of the control device 100, communication cooperation between all internal parts, and external and internal data processing functions.

Under control of the processor 110, the communication interface 130 realizes communication of a control signal and a data signal with the display apparatus 200. The communication interface 130 may include at least one of a WiFi chip 131, a Bluetooth module 132, an NFC module 133, or other near field communication modules.

The user input/output interface 140 may include a microphone 141, a touchpad 142, a sensor 143, a key 144, etc.

In some embodiments, the control device 100 is internally configured with the communication interface 130, for example modules such as WiFi, Bluetooth, and NFC, and the command input from the user may be encoded through a WiFi protocol, a Bluetooth protocol, or an NFC protocol and sent to the display apparatus 200.

The memory 190 is configured to store various running programs, data and applications for driving and controlling the control device 100 under control of the processor. The memory 190 may store various control signal commands input from the user.

The power supply 180 is configured to provide running power support for all elements of the control device 100 under control of the processor.

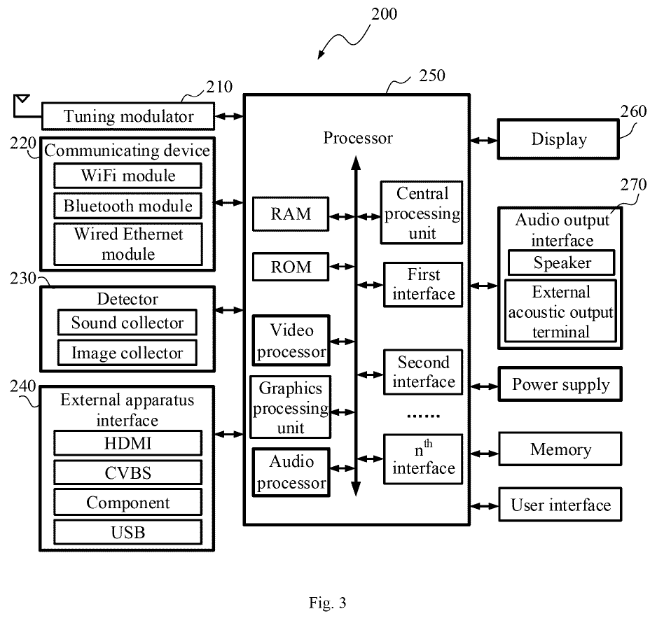

In some embodiments, taking the display apparatus being a television as an example, FIG. 3 is a block diagram of hardware configuration of a display apparatus 200 according to some embodiments of the disclosure. As shown in FIG. 3, the display apparatus 200 may include at least one of a tuning demodulator 210, a communicating device 220, a detector 230, an external apparatus interface 240, at least one processor 250, a display 260, an audio output interface 270, a memory, a power supply, or a user interface.

The tuning modulator 210 may receive broadcasting television signals in a cable or wireless receiving manner, and demodulates an audio and video signal, such as an EPG data signal, from the plurality of wireless or cable broadcasting television signals. The detector 230 may be configured to collect a signal of an external environment or a signal interacting with the outside.

In some embodiments, a frequency point demodulated by the tuning demodulator 210 is controlled by the processor 250, and the processor 250 can send a control signal according to the user's selection, so that a modem responds to a television signal frequency selected by the user and modulates and demodulates a television signal carried by the frequency.

The broadcasting television signals may be divided into a terrestrial broadcasting signal, a cable broadcasting signal, a satellite broadcasting signal, an Internet broadcasting signal and the like according to different broadcasting systems of television signals. Alternatively, the broadcasting television signals may be divided into a digital modulation signal, an analog modulation signal, and the like according to different modulation types. Alternatively, the broadcasting television signals may be divided into a digital signal, an analog signal and the like according to different kinds of signals.

In some embodiments, the processor 250 and the tuning modulator 210 may be located in different split devices. That is, the tuning modulator 210 may also be in an external device of a main body device where the processor 250 is located, such as an external set top box.

In some embodiments, the communicating device 220 may be a component configured to communicate with an external device or an external server according to various communication protocol types. For example, the communicating device may include at least one of a Wifi chip, a Bluetooth communication protocol chip, a wired Ethernet communication protocol chip, and other network communication protocol chips or near field communication protocol chips, or an infrared receiver.

In some embodiments, the detector 230 may be configured to collect a signal of an external environment or interacting with the outside, and may include an optical receiver, a temperature sensor, and the like.

The optical receiver may be configured for a sensor collecting environment light intensity and may be configured to adaptively adjust display parameters according to the environment light intensity. The temperature sensor may be configured to sense an environment temperature, so that the display apparatus 200 may adaptively adjust a display color temperature of an image. For example, when the environment temperature is relatively high, the display apparatus 200 may be adjusted to display a relatively cold tune of the color temperature of the image, or when the environment temperature is relatively low, the display apparatus 200 may be adjusted to display a relatively warm tune of the color temperature of the image.

In some embodiments, the detector 230 may further include an image collector, such as a camera and a webcam, may be configured to collect an external environment scenario and configured to collect attributes of the user or interact with user gestures, may adaptively change display parameters and may also recognize the user gestures, so as to realize an interactive function with the user.

In some embodiments, the detector 230 may further include a sound collector, etc., such as a microphone, and may be configured to receive a sound of the user. For example, a voice signal of a command from the user for controlling the display apparatus 200 may be included, or environmental sounds may be collected for recognizing environmental scenario types, so that the display apparatus 200 may be self-adaptive to environmental noise.

In some embodiments, the external apparatus interface 240 may include, but is not limited to the following: any one or more interfaces of a high definition multimedia interface (HDMI), an analog or data high-definition component input interface, a composite video input interface, a universal serial bus (USB) input interface, and an RGB port, or the above plurality of interfaces may form a composite input/output interface.

As shown in FIG. 3, the at least one processor 250 may include at least one of a central processing unit, a video processor, an audio processor, a graphics processing unit, a random access memory (RAM), a read-only memory (ROM), or a first interface to an n^{th} interface for input/output. The communication bus connects various parts.

In some embodiments, the processor may control work of the display apparatus and respond to operations of the user through various software control programs stored on the external memory. For example, the user may input a user command at a graphic user interface (GUI) displayed on the display, and then the user input interface receives the user input command through the graphic user interface, or the user may input the user command by inputting a specific sound or gesture, and then the user input interface receives the user input command by recognizing the sound or gesture through a sensor.

The user interface may be a graphic user interface, which can refer to the user interface displayed in a graphical manner and relevant to a computer operation. It may be an icon, a window, a control and other interface elements displayed in a display screen of an electronic device, where the control may include at least one of an icon, a button, a menu, a tab, a text box, a dialog box, a status bar, a navigation bar, a web widget (widget for short) or other visual interface elements.

In some embodiments, the RAM may be configured to store temporary data in an operating system or other running programs; and the ROM may be configured to store various system booting commands, for example, the ROM may be configured to store a command for booting a basic input output system (BIOS). The ROM may be configured to complete power-on self-test on the system, initialize various function modules in the system, provide basic input/output driver programs for the system, and guide the operating system.

In some embodiments, upon receiving a power-on signal, a power source of the display apparatus 200 starts to start, and the central processing unit runs a system booting command in the ROM, copies temporary data of the operating system stored in the memory into the RAM for easy booting or running the operating system. After the operating system is booted, the central processing unit copies temporary data of various applications in the memory into the RAM for easy launch or running of various applications.

In some embodiments, the central processing unit may be configured to execute commands of the operating system and the applications stored in the memory, and execute various applications, data and contents according to various received interaction commands input externally, so as to finally display and play various audio and video contents.

In some embodiments, the central processing unit may include a plurality of processors. The plurality of processors may include one main processor and one or more sub processors. The main processor is configured to execute some operations of the display apparatus 200 in a pre-power mode, and/or the operation of displaying pictures under a normal mode. The one or more sub processors are configured to execute one operation under a status such as a standby mode.

In some embodiments, the interface for input/output may be configured for audio output, that is, for receiving a sound signal output by the audio processor under the control of the processor 250, outputting the sound signal to a loudspeaker apparatus such as a speaker, and outputting the sound signal to an external audio output terminal, such as an external audio interface or a headphone interface, of a generating apparatus of an external device, in addition to the speakers carried by the display apparatus 200 itself. The audio output may further include a near field communication module in the communication interface, such as a Bluetooth module for speaker sound output for Bluetooth connection.

In some embodiments, the graphics processing unit may be configured to generate various graphic objects, such as an icon, an operation menu, and a user input command display graphic. The graphics processing unit may include an arithmetic unit, which performs computation by receiving various interaction commands input from the user and displays various objects according to a display attribute. The graphics processing unit may include a renderer, for rendering various objects obtained based on the arithmetic unit, and the above rendered objects are configured for being displayed on the display.

In some embodiments, the graphics processing unit and the video processor may be arranged integrally or separately. When integrated, the processing of the graphics signal output to the display may be executed, and when separated, different functions, such as the graphics processing unit (GPU)+frame rate conversion (FRC) architecture, may be executed separately.

The display 260 may be at least one of a liquid crystal display, an OLED display, a touch display or a projection display, and may further be a projection apparatus and a projection screen.

In some embodiments, the display 260 may be configured to display a user interface, for example, may be configured to display a display interface for an application. The display interface is any page in the application, for example, the display interface may be an interface corresponding to a certain channel in the application.

In some embodiments, the display 260 may be configured to receive audio and video signals output by the audio processor and the video processor, display video content and images, play audio of the video content, and display a component of a menu control interface.

In some embodiments, the display 260 may be configured to present the user operation interface UI generated in the display apparatus 200 and configured for controlling the display apparatus 200.

In some embodiments, the display apparatus 200 may establish sending and receiving of a control signal and a data signal with an external control device 100 or a content providing device through the communicating device 220.

In some embodiments, the memory may include various software modules stored for driving the display apparatus 200. For example, various software modules stored in a first memory may include at least one of: a basic module, a detection module, a communication module, a display control module, a browser module, or various service modules.

The basic module is a low-level software module configured for signal communication between various hardware in the display apparatus 200 and sending processing and control signals to an upper-level module. The detection module is a management module configured to collect various information from various sensors or user input interfaces, and perform analog-to-digital conversion and analysis management.

For example, the voice recognition module may include a voice parsing module and a voice command database module. The display control module is a module that may be configured to control the display to display an image content, and may be configured to play a multimedia image content, a UI and other information. The communication module is a module that may be configured for control and data communication with an external device. The browser module is a module that may be configured to execute data communication between browsing servers. The service module is a module configured to provide various services and various applications. At the same time, the memory may further be configured to store and receive external data and user data, an image of each item in various user interfaces, a visual effect drawing of a focus object, and the like.

In some embodiments, the user input interface may be configured to receive an infrared control signal sent from the control device 100, such as an infrared remote control.

The power supply may provide power to the display apparatus 200 through electric power input from an external power supply under the control of the processor 250.

In some embodiments, the display apparatus 200 may receive the operation input from the user through the communicating device 220. For example, when the communicating device is a touch component, the touch component and the display 260 may jointly form a touch screen. On the touch screen, the user May input different commands through touch operations. For example, the user may input touch commands such as click, swipe, long press and double click. Different touch commands may represent different control functions.

In order to achieve the different touch actions above, the touch component may generate different electrical signals when the user inputs different touch actions, and send the generated electrical signals to the processor. The processor may perform feature extraction on the received electrical signal, thereby determining a control function that the user needs to execute according to extracted features.

For example, when the user inputs a click touch action at the location of any program icon in the display interface of an application, the touch component 220 will sense the touch action and thus generate an electrical signal. After receiving the electrical signal, a duration of a level corresponding to the touch action in the electrical signal may be determined first. When the duration is less than a preset time threshold, it is recognized that the user inputs a click touch command. The processor then performs feature extraction on the location where the electrical signal is generated, so as to determine the touch location. When the touch location is within a display range of an application icon, it is determined that the user inputs the click touch command at the location of the application icon. Correspondingly, the click touch command is used in a current scenario for functions of executing an application corresponding to a running program chart or switching the display interface, that is, the processor may launch and run the application or control the switching of the display interface within the application.

In some embodiments, the user may input a voice command through the touch operation on the touch screen, for example, the user may trigger a voice input operation on the display 260 through a voice triggered gesture.

In some embodiments, the communicating device 220 may also be an external control component, such as a mouse and a remote control that establish a communication connection with the display apparatus. When the user executes different control operations on the external control component, the external control component may generate different control signals in response to a control operation of the user, and send the generated control signal to the processor. The processor may perform feature extraction on the received control signal, thereby determining a control function that the user needs to execute according to extracted features.

For example, when the user clicks a left mouse button at any location in the display interface of the application through the external control component, the external control component may sense the control action and then generate a control signal. After receiving the control signal, the processor may recognize that the user inputs a click command through the external control component according to a dwell time of the control action in the control signal at its location when the dwell time is less than a preset time threshold. The click command is used in the current scenario to open the corresponding interface of the application or switch the display interface within the application, or control a location of a mouse cursor.

For another example, when the user presses a voice key on the remote control, the remote control may activate a voice record function. In a process that the user records the voice command, the remote control may synchronize the voice command to the display 260, and the display 260 may display a voice record identifier at this time to indicate that the user is recording the voice command.

In some embodiments, the communicating device 220 may further be a control component connected with the display 260, and taking a desktop computer as an example, the control component may be a keyboard connected with the display. The user may input different commands, such as click, switch, and other operation commands, through the keyboard.

The user may input a click command, a switch command, and the like through corresponding shortcut keys. For example, the user may trigger a swipe operation by selecting a “Tab” key and a direction key. That is, when the user simultaneously selects the “Tab” key and the direction key on the keyboard, the processor may receive a key signal to determine that the user triggers an operation of performing a switch operation in a direction corresponding to the direction key. Then, the processor may control page turning or scrolling of the display interface in a media resource display page to display corresponding media resource options.

Correspondingly, the user may also input the voice command through the corresponding shortcut key. For example, when the user selects a “Ctrl” key and a “V” key, the processor may receive the key signal to determine that the user triggers a voice input operation. Then, the processor may receive the voice command input from the user and control the display 260 to execute the corresponding operation according to the voice command.

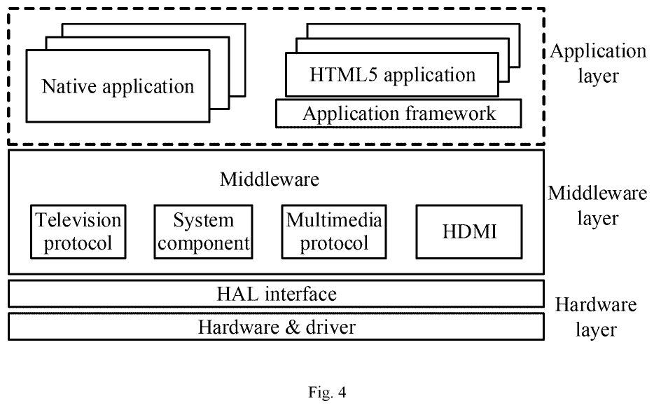

FIG. 4 is a schematic diagram of software configuration in a display apparatus in FIG. 1 provided by some other embodiments of the disclosure. In some embodiments, a system of the display apparatus 200 may be divided into three layers, which are an application layer, a middleware layer and a hardware layer from top to bottom respectively.

The application layer mainly contains common applications on a television, and an application framework, where the common applications are mainly applications developed based on a browser, such as HTML5 APPs, and native applications (native APPs).

The application framework is a complete program model, and has all basic functions required by standard application software, such as file access, data exchange . . . , and use interfaces (a toolbar, a status bar, a menu and a dialog box) of these functions.

The native applications (native APPs) may support online or offline, message push or local resource access.

The middleware layer may include middleware such as various television protocols, a multimedia protocol and a system component. The middleware may use a basic service (function) provided by the system software to link various parts of an application system on a network or different applications, thereby achieving purposes of resource sharing and function sharing.

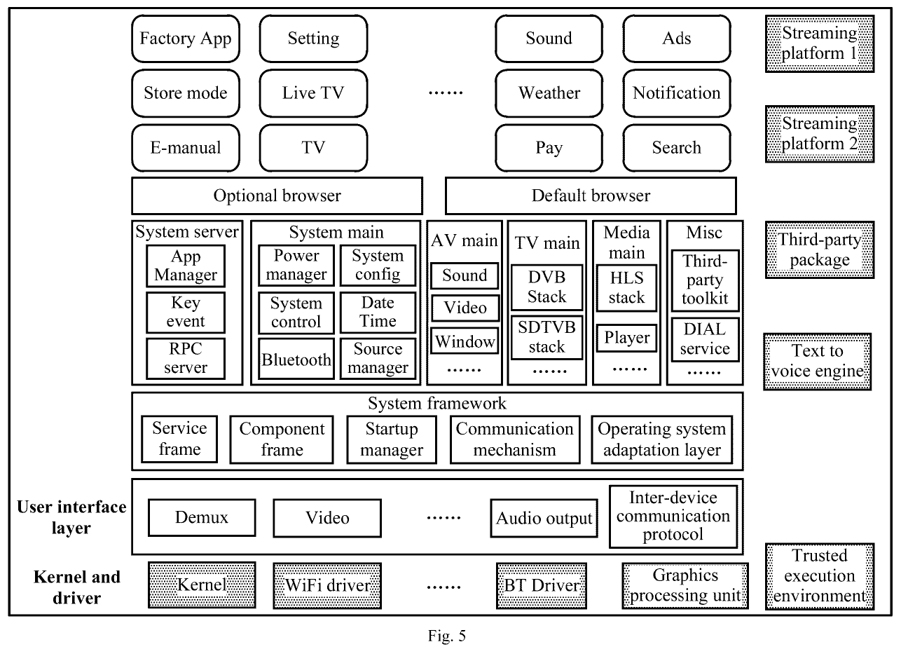

The hardware layer may mainly include an HAL interface, hardware and a driver, where the HAL interface is a uniform interface docked with all television chips, and a specific logic is implemented by all the chips. The driver mainly contains: an audio driver, a display driver, a Bluetooth driver, a camera driver, a WIFI driver, a USB driver, an HDMI driver, a sensor driver (such as a fingerprint sensor, a temperature sensor, a pressure sensor and the like), a power driver and the like. Taking a television as an example, FIG. 5 is a diagram of a system architecture of a television according to some embodiments of the disclosure. As shown in FIG. 5, the television system may include an application layer, a middleware layer, a framework layer, a graphic user interface layer, a kernel and a driver layer. The application layer may include various applications and functions supported by the display apparatus. The display apparatus may provide an application framework, allowing a developer to create and deploy various applications, such as a Factory App, a Store Mode, an E-manual, a Setting, a Live TV, a TV, a Voice, a Weather, a Pay, an Ads, a Notification, and a Search.

The middleware layer may be an intermediate logic layer that links the application layer of the television system and an underlying platform interface, and may provide all logical processing such as an image, a sound, an analog television (ATV), and a digital television (DTV). For example, as shown in FIG. 5, the middleware layer may include a system server, a system main, an AV main, a TV main, a media main, and misc.

The system server may include an App manager, a key event, an RPC Server, etc. The system main may include a power manager, a system control, Bluetooth, a system config, a date time, a source manager, etc. The AV main may include a sound, a video, a window, etc. The TV main may include a digital video broadcasting (DVB) stack, a standard digital TV broadcasting (SDTVB) stack, etc. The media main may include an HTTP live streaming (HLS) stack, a player, etc., and misc are miscellaneous logic layers, and may include third-party toolkits such as AVS SDK (a software development toolkit), and a digital service (DIAL service).

The framework layer may can refer to a software architecture part of the television system, is responsible for managing and organizing various functional modules and applications, and providing interfaces interacting with hardware and the operating system, and may include a service frame, a component frame, a startup manager, a communication mechanism such as a message queue (MQ)/Binder (an inter-process communication mechanism), an operating system adaptation layer (Osal), etc.

The user interface layer may can refer to a user interface part of a television interface, is responsible for displaying a content, receiving user input, and transmitting user operations to the application layer of the television, and may include a demux, a video, audio output (Aout), and an inter-device communication protocol, such as consumer electronics control (CEC, which is a standard allowing a plurality of consumer electronic devices to communicate with and control each other).

The kernel and driver layer can refer to the operating system and a device driver in a television device. The operating system is core software of the television device, manages and controls various functions and hardware resources of the device, and provides a user interface and an application framework. The device driver is a software module configured to communicate with different hardware components, such as a screen, audio, and a wireless network. The driver interacts with the hardware through an interface provided by the operating system, so that it can work normally and be used in conjunction with other software. The operating system and the device driver work together to ensure that the television device can run normally and provide the required functions.

As shown in FIG. 5, the kernel and driver layer may include a kernel, a WiFi driver, a Bluetooth driver (BT driver), a graphics processing unit (graphic), a trusted execution environment (TEE), a streaming platform such as Netflix and Prime Video, and a third-party package such as AirPlay SDK, and a text-to-voice engine.

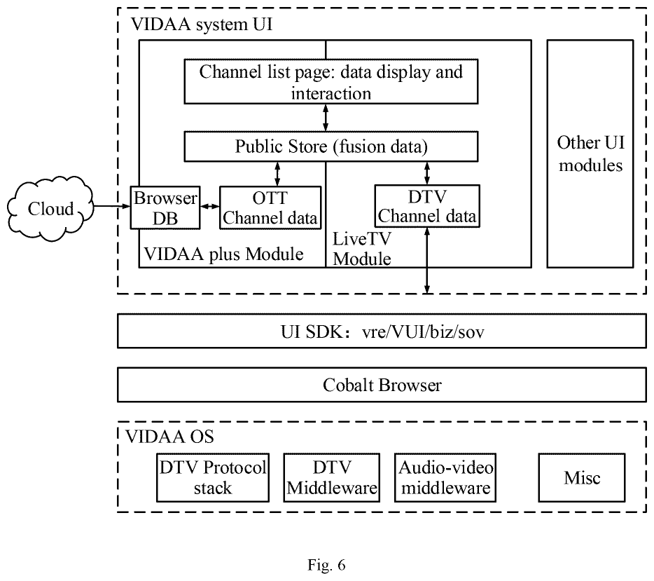

FIG. 6 is a system architecture according to some embodiments of the disclosure. The system architecture is configured for supporting a channel management method based on a channel list. As shown in FIG. 6, the system architecture may include a VIDAA system UI layer, a UI software development kit (SDK) layer, a browser (such as a Cobalt browser), and a VIDAA operating system (OS).

The system architecture is based on the VIDAA OS, provides an upper-level UI application with a runtime environment based on general web technologies such as a hyper text markup language (HTML), a cascading style sheet (CSS), and JavaScript through the Cobalt browser and the UI SDK layer, and provides a common component library and an interface library, such as a digital TV (DTV) protocol stack, DTV middleware, and audio-video middleware.

The VIDAA system UI layer may mainly include a VIDAA Plus Module and a Live TV Module.

The VIDAA Plus Module mainly processes an over-the-top (OTT) data stream, acquires channel data from a cloud through a data service, stores the channel data into a browser data base, and exposes the channel data in the browser data base to the Live TV Module for use via the data interface through public Store.

The main function of the Live TV Module is to process DTV data and fuse data. The Live TV Module performs data interaction with a DTV protocol stack in the television system through a middleware interface, acquires channel data obtained after channel search, then integrates the DTV data and OTT data together, and exposes the data to a UI page for use through the public Store. The data stored in the public Store is the fusion data, the fusion data has a unified format, and the unified format may be adapted to the display of the UI page. The channel list page displays the channel data and program data acquired through the interface exposed by the public Store of the VIDAA Plus Module and the Live TV Module.

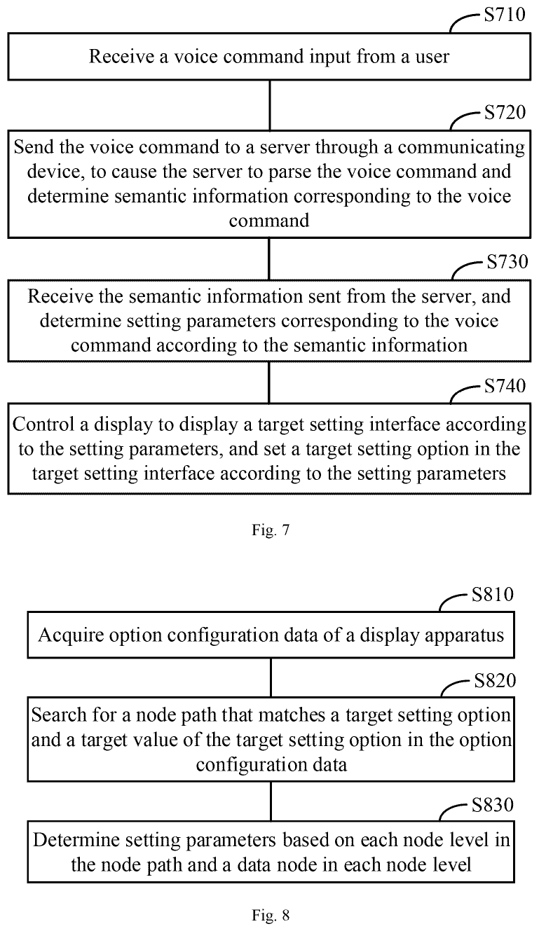

In order to facilitate the explanation of the voice processing method according to the embodiments of the disclosure, the voice processing method based on the display apparatus according to the embodiments of the disclosure is illustrated in detail below in conjunction with FIG. 7.

A voice processing method according to the embodiments of the disclosure may be applied to the display apparatus 200 shown in FIG. 1, and the display apparatus 200 may include a display 260, a communicating device 220, and at least one processor respectively coupled with the display 260 and the communicating device 220.

The display 260 may be configured to display a setting interface, and the setting interface may be an interface associated with setting options. The communicating device 220 may be configured to receive a voice command input from a user. The voice command may be configured for indicating the processor to set a target setting option of the display apparatus.

According to the voice processing method of the embodiments of the disclosure, the display apparatus may receive a voice command input from a user, and send the voice command to a server through the communicating device, so that the server parses the voice command and determines semantic information corresponding to the voice command. Then, the display apparatus may receive the semantic information sent from the server, determine setting parameters corresponding to the voice command according to the semantic information, control the display to display a target setting interface according to the setting parameters, and set the target setting option in the target setting interface according to the setting parameters. By applying this scheme, the user may use the voice command to set the setting options of the display apparatus according to his/her own needs, without the need to manually open the corresponding setting interface for setting. Especially when the setting interface is at a high level, the user may directly enter the corresponding setting interface through the voice command without manually opening a plurality of interfaces to search for an opening entry of the setting interface, thereby greatly improving operation convenience for setting the display apparatus by the user and improving operation efficiency.

As shown in FIG. 7, the processor may be configured to execute computer instructions to cause an electronic device to execute the following steps S710 to S740.

Step S710, a voice command input from a user is received.

The voice command is configured for setting a target setting option of the display apparatus.

The display apparatus may include a plurality of setting options, and the target setting option is any one of the plurality of setting options. For example, the setting options of the display apparatus may include an image, audio, a network, a language, time, and other personalized settings. In a setting menu, the user may adjust parameters such as brightness, contrast, a color, and sharpness of a picture through the setting options, and may further adjust a volume, a tone, and a sound effect of the audio. In addition, the user may further connect to the network, select preferred language and region settings, set the time for automatic shutdown, and adjust other personalized parameters through the setting options.

People communicate and negotiate with each other by voice and transmitting the voice to others. The voice may include a voice signal and a voice feature, and may convey languages, emotions, intentions, and other related information. With the development of a computer technology, people may also interact with the display apparatus by inputting voice information, such as controlling the display apparatus to execute corresponding operations. The voice command is sound information recorded by the user, and may be input from the user through a voice record function of the display apparatus 200, or may be recorded by the user through an external component communicatively connected with the display apparatus 200, such as a remote control, and a microphone. The setting options can refer to settable function options on the display apparatus, and for example, may include a volume, a sound mode, an image mode, an image quality, a picture ratio, etc. The user may set these function options according to his/her own needs. The target setting option is a setting option indicated by the voice command to be set, and is any one of the plurality of setting options of the display apparatus.

Step S720, the voice command is sent to a server through a communicating device, to cause the server to parse the voice command and determine semantic information corresponding to the voice command.

The semantic information corresponding to the voice command can refer to language information generated on the basis of natural language understanding of people, and may include the target setting option that the user wants to set, what value of the target setting option the user wants to set, and other information such as the time for setting the target setting option.

In a process that the user inputs the voice command, the processor may receive the voice command, and send the voice command to the server through the communicating device, so that the server may parse the voice command so as to determine the semantic information corresponding to the voice command. In the embodiments of the disclosure, the server may be a server, a server cluster consisting of a plurality of servers, or a cloud server that provides a voice processing service.

When the user inputs the voice command, the processor may receive streaming voice data, that is, continuously receive the voice command input from the user until the user completes the input of the voice command.

When receiving the voice command, the server may recognize the semantic information of the voice command through a voice recognition technology, a natural language processing technology, etc. For example, the server may first convert the received voice command into a voice text, converts the voice text into a plurality of segmentation words, and then extract keywords in the plurality of segmentation words by using a corresponding keyword extraction method, so as to determine the semantic information of the voice command according to the keywords.

Compared with the display apparatus, the server has powerful computing power, so by sending the voice command to the server and utilizing the computing power of the server to parse the voice command to obtain the semantic information of the voice command, the correctness of semantic information parsing may be ensured.

Step S730, the semantic information sent from the server is received, and setting parameters corresponding to the voice command are determined according to the semantic information.

After completing the parsing of the voice command, the server may send the semantic information of the voice command to the display apparatus. At the same time, in order to determine the control intention of the voice command, the electronic device may receive the semantic information sent from the server, and determine the setting parameters corresponding to the voice command according to the semantic information.

For example, the electronic device may query parameter sequences that match all keywords in the semantic information in a corresponding database according to the semantic information, thereby obtaining the setting parameters. According to the setting parameters, the electronic device may determine detailed information of the target setting option indicated to be set by the voice command input from the user. For example, the detailed information may include the target setting option, a location where the target setting option is located, a type of the target setting option such as a numeric value type or a switch type, a target value of the target setting option and other information.

By determining the setting parameters according to the semantic information, the semantic information may be converted into parameter information for setting the target setting option. By using the parameter information, detailed information of the target setting option may be determined, thereby providing great convenience for subsequent positioning and setting of the target setting option.

According to a function type and a service kind of the display apparatus, the setting parameters may include multiple parameter types. For example, the setting parameters may include at least one of a mode selection parameter, an on-off control parameter, a numeric value setting parameter, or a page control parameter. Table 1 is an implementation of the setting parameters for the embodiments of the disclosure, as shown below.

TABLE 1

| Category | Description |
|---|---|
| Mode selection | Setting a function mode of a display |
| parameter | apparatus, such as an image mode and |
| | a sound mode |
| On-off control | Being configured for turning on or |
| parameter | turning off a function switch, such |
| | as a Bluetooth switch |
| Numeric value | Being configured for setting a numeric |
| setting parameter | value of a function option |
| Page control parameter | Being configured for opening a page |

It should be understood that the parameter types of the setting parameters above are only for example. According to the content of the settable items in the display apparatus, the setting parameters obtained on the basis of the voice command may include more parameter types, for example, the setting parameters may further include various setting parameters such as a program setting parameter, and a software update parameter.

In some embodiments, the semantic information may include the target setting option and a target value of the target setting option. Thus, as shown in FIG. 8, the processor may be configured to execute computer instructions to cause the electronic device to execute the following steps.

Step S810, option configuration data of the display apparatus is acquired.

The option configuration data is configuration data pre-set by a developer for setting the setting options of the display apparatus, may include an operation path when operating the setting options, such as an interface path for opening an interface where the setting options are located, that is, an interface opening order of the reached setting option and interface information of each interface, such as an interface name and interface content, and may further include parent level options of the setting options, setting rules of the parent level options and setting rules of the setting options themselves.

That is, the option configuration data is the configuration data required to set the setting options of the display apparatus. In order to quickly determine the location and the setting rules of the setting options, the option configuration data may include interface path data for opening the interface where the setting options are located, option configuration data of the parent level options corresponding to the setting options, option configuration data of the setting options themselves, etc.

According to a level of the setting options, a parent level corresponding to the setting options may include a plurality of levels, such as a parent level directly associated with the setting options, and the parent level may further have its own corresponding parent level.

In some embodiments, the option configuration data may be configured by using a tree data structure. The tree data structure is an important data structure in computer science, and organizes and stores data in a tree like structure. A tree is composed of nodes, and each node may be connected to other nodes, forming a hierarchical relationship. A topmost-level node of the tree is called a root, and each node may have any number of child nodes. Except for the root, each node has a parent node, and the child nodes may have their own child nodes, forming a branching and hierarchical structure.

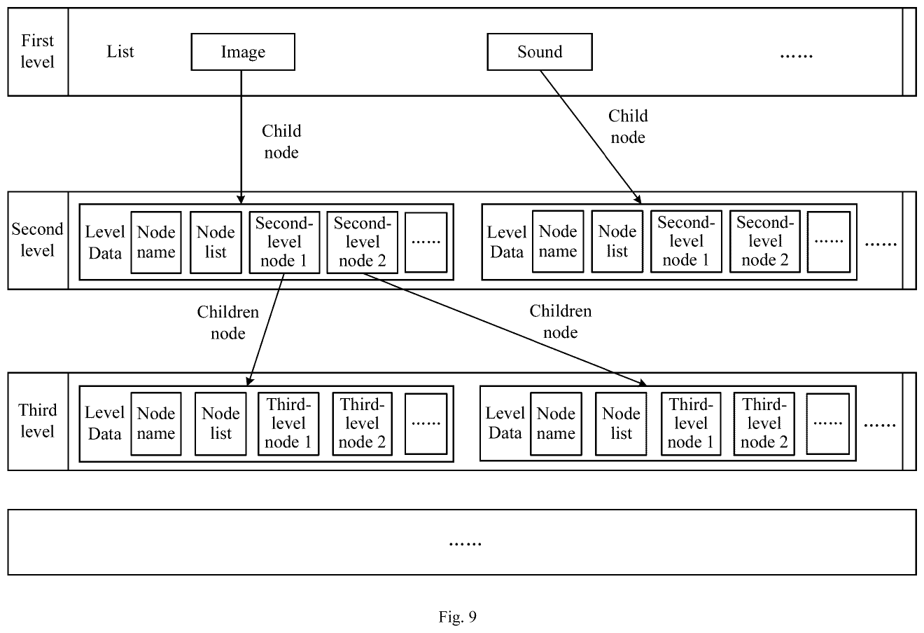

When setting the option configuration data, the configuration data of each setting option may be set according to the function category. As shown in FIG. 9, the option configuration data may be configured into a plurality of node levels by using the tree data structure, and each node level may include one or more data nodes.

For example, a first-level node may include an image and a sound, and the image and the sound respectively have their own child nodes (second-level nodes). In the second-level nodes, the level data of each node may include a node name, a node list, and a plurality of nodes, such as a second-level node 1, and a second-level node 2. Each node in the second-level node may have its own third-level node. As shown in FIG. 9, for the first-level node of the image, the level data of the third-level node corresponding to the corresponding second-level node 1 may also include a node name, a node list, and a plurality of nodes, such as a third-level node 1 and a third-level node 2. The level data of the third-level node corresponding to the corresponding second-level node 2 may also include a node name, a node list, and a plurality of nodes, such as a third-level node 1 and a third-level node 2.

The level data of each node may be configured by using an example shown in Table 2 below.

TABLE 2

| | Is it an | |
|---|---|---|
| | optional | |
| Level data | configuration | Description |
| levelData | Must be | Setting level data as default data |
| | configured | of the previous level of child node |
| levelInit | Optional | Being mainly configured for |
| | | initializing an underlying interface |
| | | invoked by the configuration data, |
| | | to accurately determine whether |
| | | setting options are available |

The levelData of each level may be configured according to an example shown in Table 3 below.

TABLE 3

| Setting | Is it an optional | |
|---|---|---|
| name | configuration | Description |
| levelList | Must be configured | Setting a level settable list |
| levelTitle | Must be configured | Setting a level name |

A format of each setting item in LevelTitle is shown in Table 4 below.

TABLE 4

| Name | Is it optional | Description |
|---|---|---|
| focusName | Must be | A current setting item name, with data consistent with a menu tree |
| | configured | |
| Children | Optional | Next level of data, configure if available, otherwise do not configure |
| childrenInit | Optional | Interface initialization required for initialization of the next level of data |
| childrenForbid | Optional | Forbidding direct access to a child node, such as a parent lock, forbidding |
| | | the direct access |
| itemTitle | Must be | A display title, usually a multilingual character ID |
| | configured | |
| settingItemValue | Optional | A current displayed value, generally configured for double-line text, a |
| | | switch, a selection list item, etc., |
| | | a value is true or false when selecting a list |
| itemType | Must be | A current setting type |
| | configured | doubleItem//double-line text display |
| | | radioItem//radio list display |
| | | singleItem//single-line text display |
| | | switchItem//switch display |
| visibility | Optional | A current display status |
| | | ‘Visible’, ‘disabled’, ‘invisible’, defaulted as ‘visible’ |
| enterHandler | Optional | An enter key processing logic |
| mapCode | Optional | A value corresponding to an underlying layer, generally used in a radio |
| | | item selection list |
| disableToast | Optional | A currently-forbidden pop-up notification |

In the embodiments of the disclosure, the option configuration data may be stored locally on the display apparatus. When acquiring the option configuration data, the processor may directly read it locally, or the option configuration data may also be stored on the server. Therefore, the electronic device may acquire the option configuration data by sending a data acquisition command to the server through the communicating device.

Step S820, a node path that matches the target setting option and the target value of the target setting option is searched for in the option configuration data.

The node path may include at least one node level, and the node level may include at least one data node.

Since the option configuration data is configured by using the tree data structure, the processor may query node data of each node in the option configuration data to find a data node that matches the target setting option and a data node that matches the target value of the target setting option. According to the node paths of these two data nodes, that is, a node path from the first-level node to these two data nodes is taken as the node path that matches the target setting option and the target value of the target setting option.

Step S830, the setting parameters are determined based on each node level in the node path and a data node in each node level.

The setting parameters may include an interface level of the target setting interface, a parent level setting option of the target setting option, and the target value of the target setting option.

The processor may determine the setting parameters according to each node level in the node path and the data node in each node level. For example, node information of the data node of each node level may be taken as one of the setting parameters, thereby obtaining a parameter sequence included as the setting parameters. Due to the fact that the target setting option needs to be set in its corresponding target setting interface, and the target setting option may have a plurality of parent level setting options, the setting parameters may include an interface level of the target setting interface and the parent level setting options, such as option values of the parent level setting options. At the same time, the setting parameters may further include the target value of the target setting option.

Through the above method, the setting parameters corresponding to the voice command may be determined according to the semantic information, achieving the conversion of the semantic information to control parameters, and facilitating the subsequent setting of the target setting option according to the setting parameters.

In order to determine whether a control operation indicated by the voice command is compliant, in some embodiments, the setting parameters may further include a setting identifier, and the setting identifier may be configured for indicating whether the target setting option is available for setting.

Step S740, a display is controlled to display a target setting interface according to the setting parameters, and set the target setting option in the target setting interface according to the setting parameters.

The target setting interface may be an interface where the target setting option is located, and may also be all interfaces that need to be opened for opening the target setting option. For example, for the target setting option of the voice volume in the setting menu, it needs to open a setting interface, a voice control interface, and a volume interface in sequence. Therefore, the target setting interface may be these three interfaces. It should be noted that for the setting interface and the voice control interface, the target setting option of the voice volume may not be displayed due to a deep nesting level of the voice volume.

After determining the setting parameters, the electronic device may determine the target setting interface according to the setting parameters and control the display to display the target setting interface, thereby setting the target setting option in the target setting interface. For example, if the setting parameters are {voice mode setting interface; voice volume; 20}, the processor may open the voice mode setting interface according to the setting parameters and set the target setting option, namely, the voice volume, as 20.

It should be noted that the above setting parameters are only exemplary illustration. According to the interface level of the target setting interface, in order to facilitate the display of the target setting interface, the setting parameters may further include a level identifier of the target setting interface. At the same time, each parameter value in the setting parameters may also be representations such as an identifier or a code that the display apparatus can recognize, which is not specifically limited by the embodiments of the disclosure.

Through the above steps S710-S740, the display apparatus may receive the voice command input from the user, and send the voice command to the server through the communicating device, to cause the server to parse the voice command and determine the semantic information corresponding to the voice command. Then, the display apparatus may receive the semantic information sent from the server, determine setting parameters corresponding to the voice command according to the semantic information, control the display to display the target setting interface according to the setting parameters, and set the target setting option in the target setting interface according to the setting parameters. The user may use the voice command to set the setting options of the display apparatus according to his/her own needs, without the need to manually open the corresponding setting interface for setting. Especially when the setting interface is at a high level, the user may directly enter the corresponding setting interface through the voice command without manually opening a plurality of interfaces to search for an opening entry of the setting interface, thereby greatly improving operation convenience for setting the display apparatus by the user and improving operation efficiency.

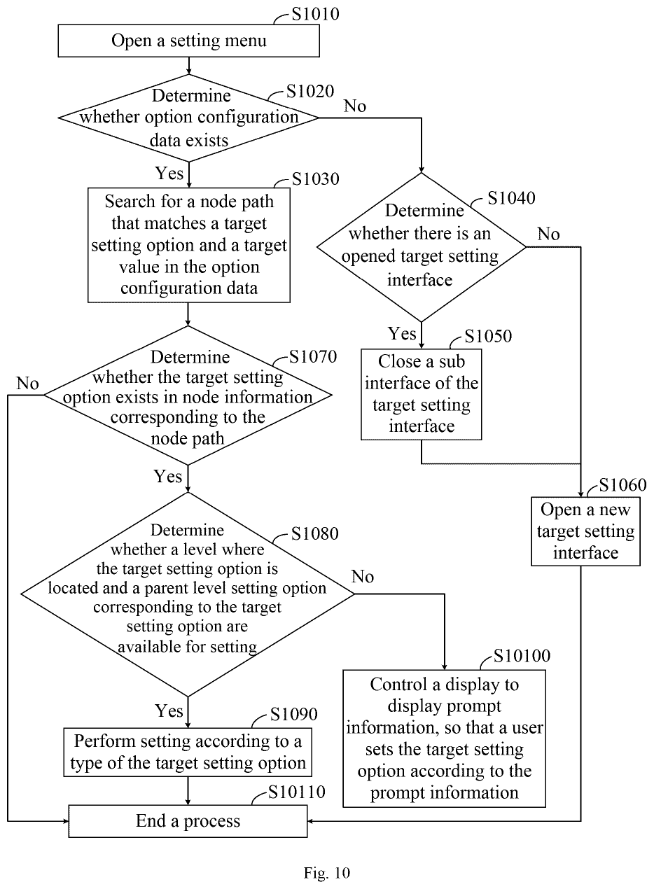

FIG. 10 is a flow diagram of a setting item setting method according to some embodiments of the disclosure. As shown in FIG. 10, the method may include the following steps.

Step S1010: a setting menu of a display apparatus is opened.

Specifically, the setting menu may be manually opened by a user or triggered to be opened through other manners, such as a voice manner.

Step S1020: whether option configuration data exists is determined. If yes, step S1030 is executed, and if not, step S1040 is executed.

Whether the option configuration data exists locally on the display apparatus may be detected. If yes, it is determined that setting a target setting option based on the option configuration data may be executed, so step S1030 may be executed. Otherwise, it is determined that setting the target setting option cannot be executed based on the option configuration data, so step S1040 may be executed.

Step S1030, a node path that matches the target setting option and a target value is searched for in the option configuration data.

The option configuration data may be configured by using a tree data structure, thus the processor may query node data of each node in the option configuration data to find a data node that matches the target setting option and a data node that matches the target value of the target setting option, and determine a node path that matches the target setting option and the target value of the target setting option according to the node paths of these two data nodes.

Step S1040: whether there is an opened target setting interface is determined. If yes, step S1050 is executed, and if not, step S1060 is executed.

When it is determined that there is the opened target setting interface currently, due to the lack of corresponding option configuration data, option settings cannot be executed, so step S1050 may be executed to close a sub interface of the target setting interface. Otherwise, if there is no opened target setting interface, step S1060 may be executed to open a new target setting interface.

Step S1050: a sub interface of the target setting interface is closed.

Step S1060: a new target setting interface is opened.

After opening the new target setting interface, the user may manually set the target setting option or re-record a speech command to try setting the target setting option again.

Step S1070, whether the target setting option exists in node information corresponding to the node path is determined. If yes, step S1080 is executed, and if not, step S10110 is executed to end the process.

When it is determined that the target setting option exists in the node information corresponding to the node path, the target setting option may be set according to the node information, so step S1080 may be executed, and otherwise, step S10110 may be executed to end the process.

Step S1080, whether a level where the target setting option is located and a parent level setting option corresponding to the target setting option are available for setting is determined. If yes, step S1090 is executed, and if not, step S10100 is executed.

Whether the level where the target setting option is located and the parent level setting option corresponding to the target setting option are available for setting, such as whether user setting is allowed, and whether setting to the target value is allowed, may be determined according to the node information corresponding to the node path. In this way, if setting is allowed, step S1090 is executed to set according to a type of the target setting option. If setting is not allowed, step S10100 is executed to control a display to display prompt information, so that the user sets the target setting option according to the prompt information.

Step S1090: setting is performed according to the type of the target setting option.

For example, when the type of the target setting option is a switch type, the target setting option may be controlled to be opened or closed. When the type of the target setting option is a mode setting type, the target setting option may be set as the corresponding target value, namely, a target mode.

Step S10100: the display is controlled to display the prompt information, so that the user sets the target setting option according to the prompt information.

Step S10110: the process ends.

Through the above method, the processor may detect the option configuration data, set the setting options based on the opened setting interface, and give a user prompt when it is determined that the target setting option is not available for setting, so that the user performs an operation according to the prompt information.

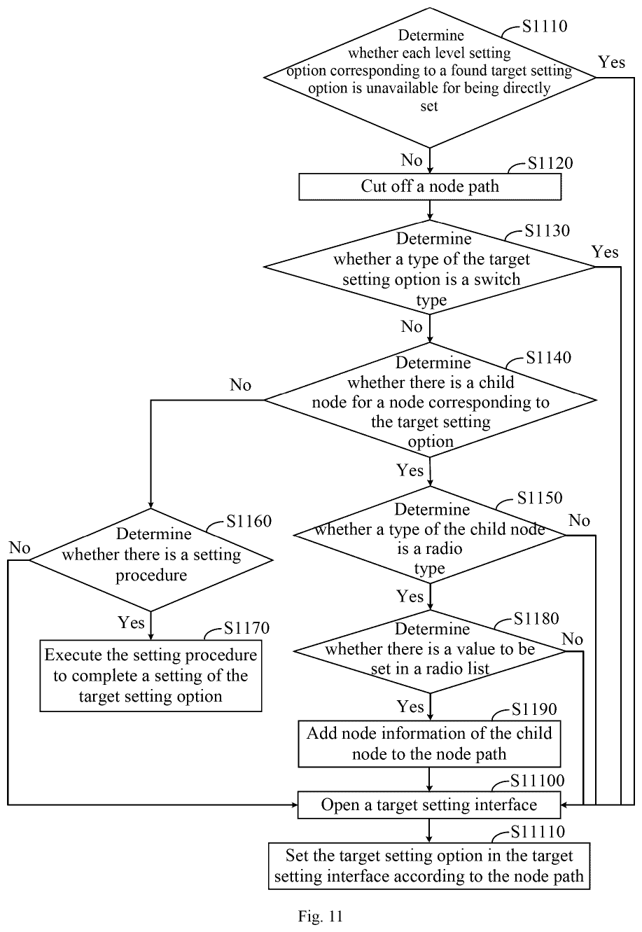

FIG. 11 is a sub flow diagram of a setting item setting method according to some embodiments of the disclosure. As shown in FIG. 11, the method may include the following steps.

Step S1110, whether each level setting option corresponding to a found target setting option is unavailable for being directly set is determined according to node information corresponding to a node path. If not, step S1120 is executed, and if yes, step S11100 is executed.

For example, if the setting option of the certain level corresponding to the found target setting option needs to be set after the parent level setting option of the setting option is set, the setting option cannot be set directly. If each level setting option corresponding to the found target setting option may be set directly, step S1120 may be executed to cut off the node path. If it cannot be set directly, step 11100 may be executed to open a target setting interface, so that a user may set the target setting option in a target setting interface. Step S1120: the node path is cut off.

The node path may be cut off according to the node of each level so as to determine the node of each level and its corresponding node information.

Step S1130: whether a type of the target setting option is a switch type is determined. If not, step S1140 is executed, and if yes, step S11100 is executed.

When it is determined that the target setting option is the switch type, step S11100 may be executed to open the target setting interface and control the target setting option to be opened or closed. When it is determined that the target setting option is not the switch type, step S1140 may be executed to further determine whether there is a child node for the node corresponding to the target setting option.

Step S1140, whether there is a child node for the node corresponding to the target setting option is determined. If yes, step S1150 is executed, and if not, step S1160 is executed.

If it is determined that there is a child node for the node corresponding to the target setting option, it indicates that the target setting option has a subordinate setting option, and step S1150 may be executed to determine whether a type of a child node is a radio type. Otherwise, if it is determined that there is no child node for the node corresponding to the target setting option, it indicates that the target setting option has no subordinate setting option, and step S1160 may be executed to determine whether there is a setting procedure.

Step S1150, whether the type of a child node is the radio type is determined. If yes, step S1180 is executed, and if not, step S11100 is executed.

If the type of a child node is the radio type, step S1180 may be executed to determine whether there is a value to be set in a radio list. If the type of a child node is not the radio type, step S11100 may be executed to open the target setting interface, and set the target setting option to the value corresponding to which child node by a user option.

Step S1160: whether there is a setting procedure is determined. If yes, step S1170 is executed, and if not, step S11100 is executed.

A developer may develop a setting procedure to complete setting of the setting options. If there is a setting procedure, step S1170 may be executed to execute a setting procedure so as to complete the setting of the target setting option. If there is no setting procedure, step S11100 may be executed to open the target setting interface, and the user may manually set the target setting option in the target setting interface.

Step S1170, a setting procedure is executed to complete the setting of the target setting option.

Step S1180: whether there is a value to be set in the radio list is determined. If yes, step S1190 is executed, and if not, step S11100 is executed.

If there is a value to be set in the radio list, it indicates that the target setting option may be set as the value in the radio list. In this case, step S1190 may be executed to add node information of a child node to the node path, making it convenient to search for the target setting option and its settable value subsequently. If there is no value to be set in the radio list, the target setting interface may be opened so as to facilitate user settings, so that the user may set the target setting option.

Step S1190, the node information of a child node is added to the node path.

Step S11100, the target setting interface is opened.

When opening the target setting interface, interface data may be acquired according to an interface level of the target setting interface, and rendering is performed to display the target setting interface on the display.

Step S11110: the target setting option is set in the target setting interface according to the node path.

For example, an interface location where the target setting option in the target setting interface is located and the settable value corresponding to the target setting option may be determined according to the node information in the node path, so as to set the target setting option as the corresponding value, such as the target value in the settable value.

Through the above method, settability check of the target setting option may be completed, and the setting of the target setting option may be completed.

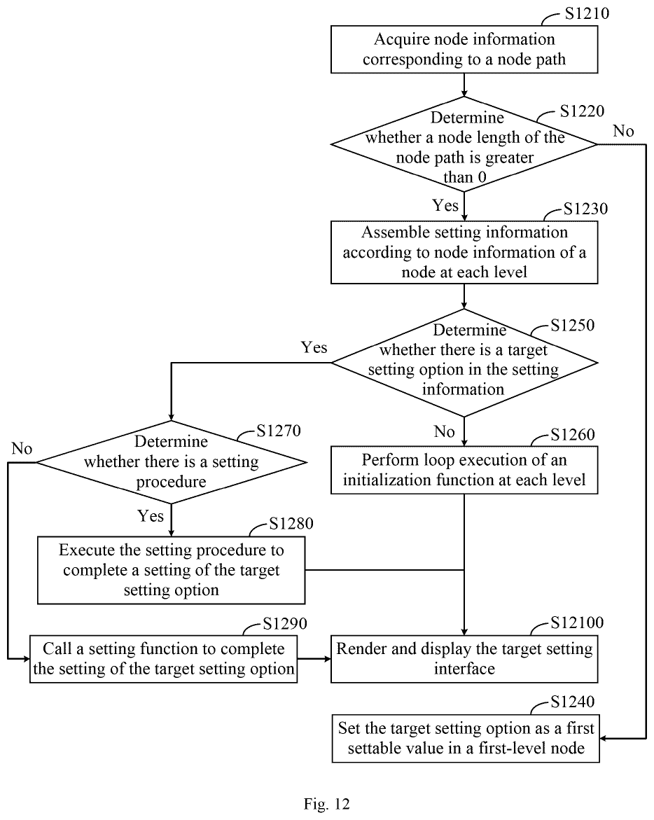

FIG. 12 is a flow diagram of another setting item setting method according to some embodiments of the disclosure. As shown in FIG. 12, the method may include the following steps.

Step S1210: node information corresponding to a node path is acquired.

The node information corresponding to the node path can refer to a node at each level associated with a target setting option and its corresponding node information.

Step S1220: whether a node length of the node path is greater than 0 is determined, if yes, step S1230 is executed, and if not, step S1240 is executed.

If the node length of the node path is greater than 0, it indicates that the target setting option has a plurality of levels, and at this time, step S1230 may be executed to assemble setting information according to the node information of the node at each level. If the node length of the node path is not greater than 0, it indicates that the target setting option does not have the plurality of levels, and at this time, step S1240 may be executed to set the target setting option as a first settable value in a first-level node.

Step S1230: the setting information is assembled according to the node information of the node at each level.

The setting information may include information such as the nodes and node rules directly related to setting the target setting option.

For example, based on the node information of the node at each level, each node and its corresponding node information may be assembled according to the level so as to form the setting information in a form of a node sequence.

Step S1240: the target setting option is set as the first settable value in the first-level node.

Exemplarily, the first-level node may be a first setting option on a home interface of a setting menu, and may be set as the first settable value corresponding to the setting option.

Step S1250: whether there is a target setting option in the setting information is determined, if not, step S1260 is executed, and if yes, step S1270 is executed.

If there is no target setting option in the setting information, the target setting option cannot be set according to the setting information. Therefore, step S1260 may be executed for loop execution of an initialization program at each level to restore data of the setting options at each level to a default value. If there is the target setting option in the setting information, the target setting option may be set according to the setting information. Therefore, step S1270 may be executed to determine whether there is a setting procedure.

Step S1260: an initialization function at each level is subjected to loop execution.

The initialization function is a function that restores the data of the setting options at the corresponding level to default data. Due to a nested relationship among different levels, loop execution is required when executing the function.

After executing step S1260, step S12100 may be executed to render a target setting interface and display it, so that a user may set the target setting option according to the displayed target setting interface.

Step S1270: whether there is a setting procedure is determined. If yes, step S1280 is executed, and if not, step S1290 is executed.

When it is determined that there is a setting procedure, step S1280 may be executed to execute a setting procedure to complete the setting of the target setting option. When it is determined that there is no setting procedure, step S1290 may be executed to call a setting function to complete the setting of the target setting option.

Step S1280, a setting procedure is executed to complete the setting of the target setting option.

The setting procedure is a process that is pre-set by a developer to complete the setting of setting options.

Step S1290, a setting function is called to complete the setting of the target setting option.

The setting function may be a Set function, which may be coded by the developer.

After executing step S1280 or step S1290, the target setting interface may be rendered and displayed, so that the user may view the target setting interface with the setting being completed.

Step S12100: the target setting interface is rendered and displayed.

Through the above method, the target setting option may be set according to the node length of the node path.

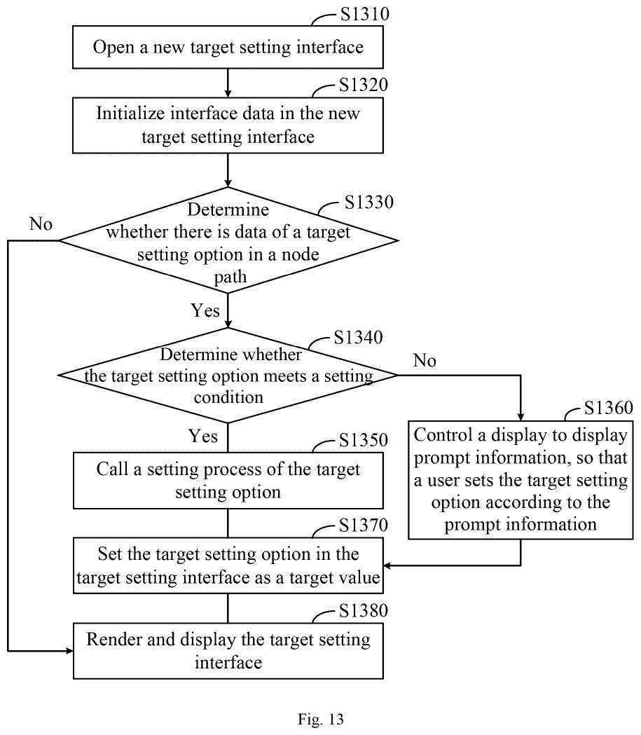

FIG. 13 is a flow diagram of yet another setting item setting method according to some embodiments of the disclosure. As shown in FIG. 13, the method may include the following steps.

Step S1310: a new target setting interface is opened.

Step S1320: interface data in the new target setting interface is initialized.

For example, all setting options in the new target setting interface may be set as default values.

Step S1330, whether there is data of a target setting option in node information corresponding to a node path is determined. If yes, step S1340 is executed, and if not, step S1380 is executed.

If it is determined that there is the data of the target setting option in the node information corresponding to the node path, the target setting option may be set according to the node information corresponding to the node path. Therefore, step S1340 may be executed to further determine whether the target setting option meets a setting condition. If there is no data of the target setting option in the node information corresponding to the node path, the target setting option cannot be set according to the node information corresponding to the node path. Therefore, step S1380 may be executed to render a target setting interface and display it, so that a user may set the target setting option by himself/herself.

Step S1340, whether the target setting option meets the setting condition is determined. If yes, step S1350 is executed, and if not, step S1360 is executed.

For example, a processor may determine whether the target setting option is available for setting, and whether it is available for setting as the target value, thus whether the target setting option meets the setting condition is determined. If yes, step S1350 may be executed to call a setting process of the target setting option so as to set the target setting option. If not, step S1360 may be executed to control a display to display prompt information, so that the user may set the target setting option according to the prompt information. Step S1350, a setting process of the target setting option is called.

The setting process may be executed through a setting program pre-set by a developer.

Step S1360, the display is controlled to display the prompt information, so that the user sets the target setting option according to the prompt information.

Step S1370: the target setting option in the target setting interface is set as a target value.

When setting the target setting option, the setting process may be executed to set the target setting option in the target setting interface as the target value.

Step S1380: the target setting interface is rendered and displayed.

After completing the setting of the target setting option, the processor may update the target setting interface and render the target setting interface for display, so that the user may understand that the target setting option has been set.

In some embodiments, setting parameters may further include a setting identifier of the target setting option, and the setting identifier may be configured for indicating whether the target setting option and the target value of the target setting option meet the setting condition. For example, the setting identifier may use 0 to indicate that the target setting option and the target value of the target setting option do not meet the setting condition, and use 1 to indicate that the target setting option and the target value of the target setting option meet the setting condition.

The setting condition may be that the target setting option is available for setting, or the target setting option is available for setting as the target value, etc., and may be configured by the developer in option configuration data according to device requirements of a display apparatus and types and contents of the setting options. When determining the setting parameters, whether the target setting option and its target value meet the setting condition may be determined according to judgment results of the target setting option in the semantic information and its target value and the node information of the matching data nodes in the option configuration data, and the corresponding setting identifier may be written in the setting parameters. From this, the following methods may further be executed:

if it is determined that the target setting option and/or the target value do/does not meet the setting condition according to the setting identifier in the setting parameters, the display is controlled to display the prompt information, so that the user sets the display apparatus according to the prompt information.

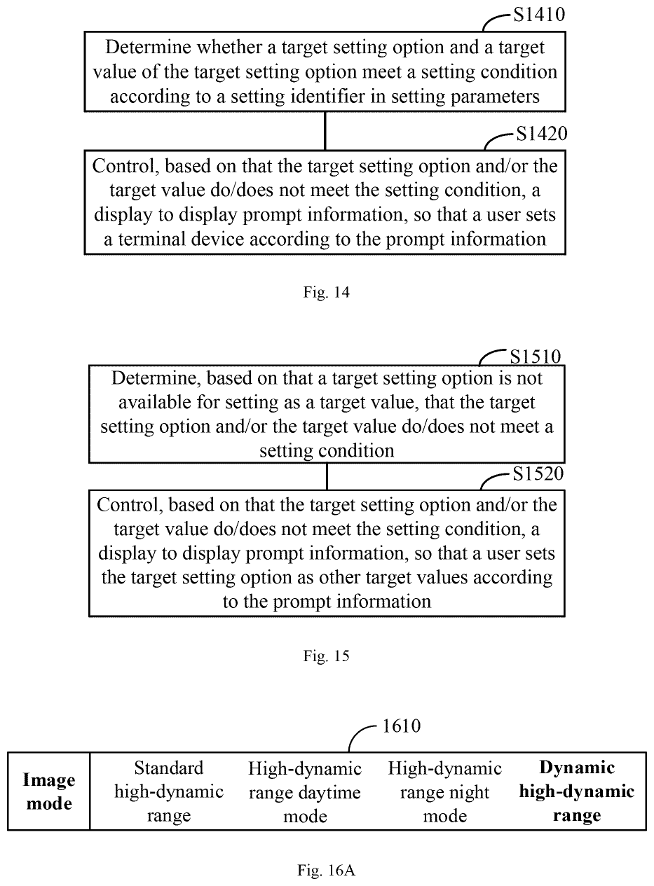

As shown in FIG. 14, the following method may be executed to control, when the target setting option and/or the target value do/does not meet the setting condition, the display to display the prompt information, so that the user sets the display apparatus according to the prompt information.

Step S1410, whether the target setting option and the target value of the target setting option meet the setting condition is determined according to the setting identifier in the setting parameters.

When setting the target setting option according to the setting parameters, the processor may determine whether the target setting option and the target value of the target setting option meet the setting condition according to the setting identifier in the setting parameters. For example, whether its value is 0 or 1 may be determined according to a location of the setting identifier in the setting parameters, so as to determine whether the target setting option and the target value of the target setting option meet the setting condition.

Step S1420, based on that the target setting option and/or the target value do/does not meet the setting condition, the display is controlled to display the prompt information, so that the user sets a terminal device according to the prompt information.

When the target setting option and/or the target value do/does not meet the setting condition, in order to facilitate a user operation, the processor may control the display to display the prompt information, so that the user may set the display apparatus according to the prompt information. For example, the prompt information may prompt the user that the target setting option cannot be set as the target value, and prompt the user of a value available for setting for the target setting option, so that the user may set the target setting option as the value available for setting according to the prompt information.

Through the above method, the processor may determine whether the target setting option and its target value meet the setting condition, and when the setting condition is not met, the processor may provide the user with a prompt, so that the user may set the display apparatus according to the prompt, which can improve the convenience of the user operation.

In some embodiments, a voice command may be configured for indicating to set the target setting option as the target value, for example, the voice command may indicate to set an image mode of the display apparatus as a dynamic high-dynamic range, set a sound mode as a theatre mode, etc. To complete the setting of the target setting option, as shown in FIG. 15, the following methods may further be executed.

Step S1510, based on that the target setting option is not available for setting as the target value, it is determined that the target setting option and/or the target value do/does not meet the setting condition.

Whether the target setting option is available for setting as the target value may be determined based on whether the setting parameters are a first numeric value (such as 0) or a second numeric value (such as 1). If it is 0, the target setting option is not available for setting as the target value, and the processor determines that the target setting option and/or the target value do/does not meet the setting condition and cannot be set according to a user command.

Step S1520, based on that the target setting option and/or the target value do/does not meet the setting condition, the display is controlled to display the prompt information, so that the user sets the target setting option as other target values according to the prompt information.

When the target setting option and/or the target value do/does not meet the setting condition, in order to facilitate the user operation, the display may be controlled to display the prompt information, and the prompt information may include information that the target setting option cannot be set as the target value, and may further include information of the value available for setting for the target setting option. Thus, the user may determine a method for setting the target setting option according to the prompt information, and then set the target setting option according to the prompt information.

Through the above method, whether the target setting option is available for setting as the target value may be determined, and in a case that the target setting option is not available for setting as the target value, prompt information is output to the user for the operation with reference to the prompt information, which can provide guidance and convenience for the user operation.

In some embodiments, if the target setting option is available for setting as the target value, the target setting option and/or the target value meet/meets the setting condition. At this time, the processor may control the display to display the target setting interface and set the target setting option in the target setting interface as the target value.

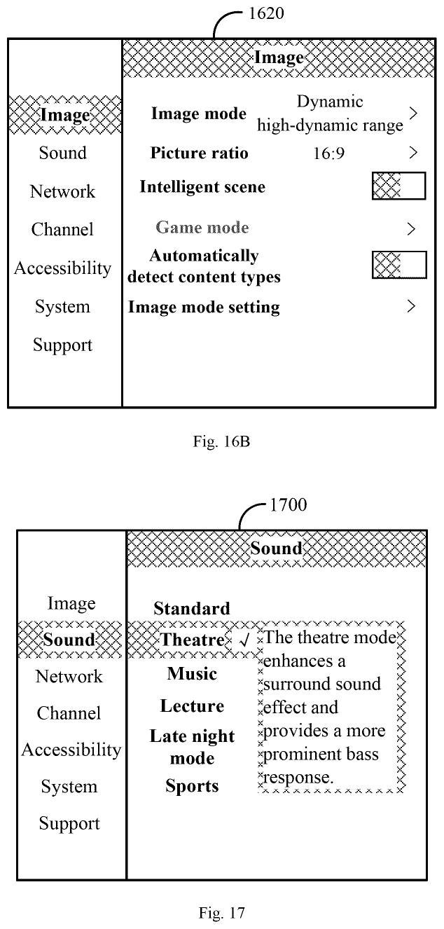

The image mode of the display apparatus will have different optional lists according to different currently-displayed resources or video playback types, etc. Assuming that the voice command is configured for indicating to set the target setting option, namely the image mode, as the “dynamic high-dynamic range”, when it is determined that the image mode is available for setting as the “dynamic high-dynamic range”, as shown in FIG. 16A, the display may be controlled to display the target setting interface 1610, and determine to select the “dynamic high-dynamic range”.

After completing the setting, an image control interface is shown in FIG. 16B. It can be seen that after completing the setting, the image mode in the image control interface 1620 is the “dynamic high-dynamic range”.

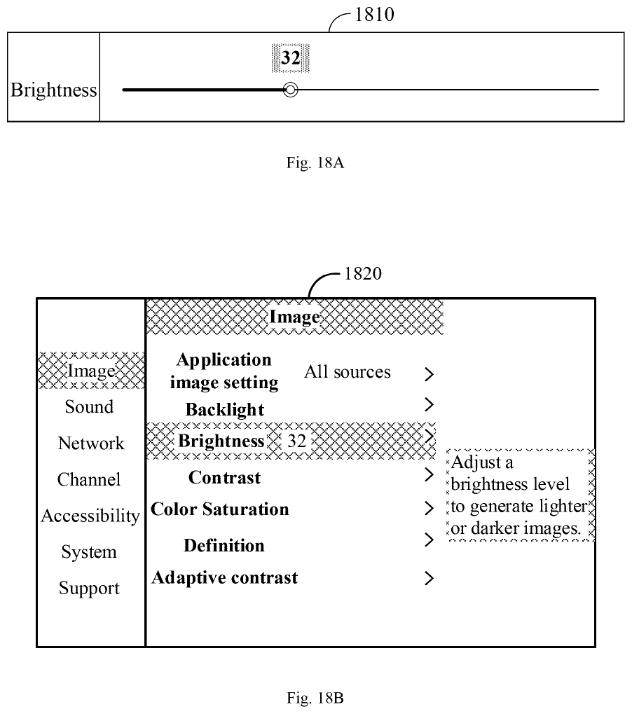

For another example, assuming that the target setting option is a sound mode and the target value is a “theatre mode”, that is, the voice command is configured for indicating to set the target setting option, namely the sound mode, as the “theatre mode”, as shown in FIG. 17, when it is determined that the sound mode is available for setting as the “theatre mode”, the processor may open a sound mode interface and select the theatre mode therein to obtain a voice control interface 1700 as shown in FIG. 17. From FIG. 17, it can be seen that after completing the setting, the sound mode in the voice control interface 1700 is displayed as the “theatre mode”.

In some embodiments, the target value may be a numeric value according to the type of the target setting option, etc. For example, for setting options such as a volume and a brightness of the display apparatus, a specific numeric value may be configured for fine setting. Based on this, the processor may also control the display to display the target setting interface, and set the target setting option in the target setting interface as the specific numeric value.

The display may be controlled to display a brightness setting interface 1810 as shown in FIG. 18A, and set a brightness value as a target value 32, thereby obtaining a voice setting interface 1820 as shown in FIG. 18B. As shown in FIG. 18B, the brightness value in the voice setting interface 1820 is displayed as the target value 32.

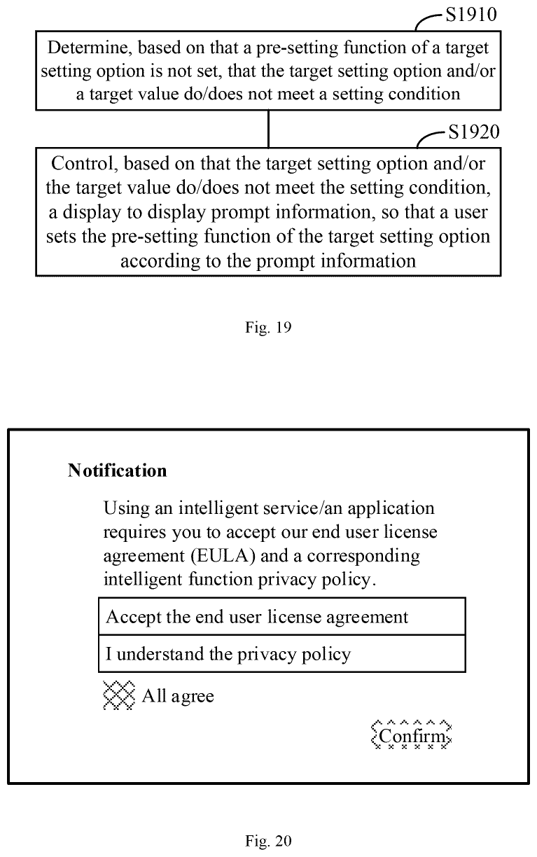

In some embodiments, the voice command may be configured for indicating to open the target setting option, for example, the voice command may be configured for indicating to open a function of waking up a wireless network. To complete the function activation, as shown in FIG. 19, the display apparatus may further execute the following methods.

Step S1910, based on that a pre-setting function of the target setting option is not set, it is determined that the target setting option and/or the target value do/does not meet the setting condition.

The pre-setting function of the target setting option can refer to a function setting option that needs to be enabled in advance to open the target setting option. That is, if the user wants to set the target setting option, the user needs to first complete the setting of the pre-setting function.

When it is determined that the user wants to open the target setting option according to the setting parameters, whether the pre-setting function corresponding to the target setting option in the display apparatus has been set may be checked. If not, it may be determined that the target setting option and/or the target value do/does not meet the setting condition.

Step S1920, based on that the target setting option and/or the target value do/does not meet the setting condition, the display is controlled to display the prompt information, so that the user sets the pre-setting function of the target setting option according to the prompt information.

When the target setting option and/or the target value do/does not meet the setting condition, the processor may control the display to display the prompt information. Exemplarily, for a voice command to turn on a function of “Wake up screen casting”, when turning on the function, the user needs to first agree to corresponding user agreement and privacy policy, as shown in FIG. 20, the prompt information may display an entry for the corresponding user agreement and privacy policy, and provide agreement and confirmation options. After the user selects “Agree to all” and confirms, the pre-setting function of the function of “Wake up screen casting” is completed.

When completing the setting of the pre-setting function of the target setting option, the processor may control the display to display new prompt information, and the new prompt information may prompt the user whether to continue opening the target setting option. If the user confirms to open it, the user may continue to execute the setting operation to open the target setting option.

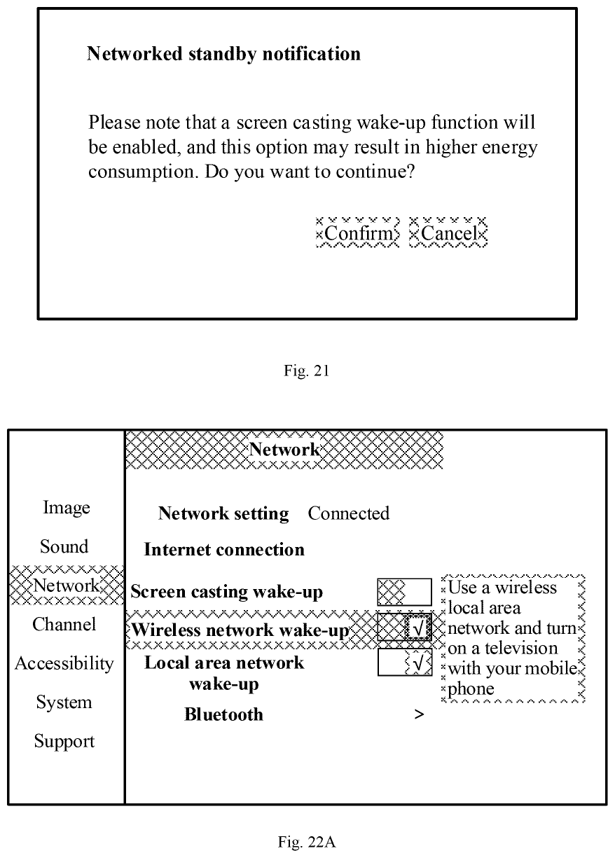

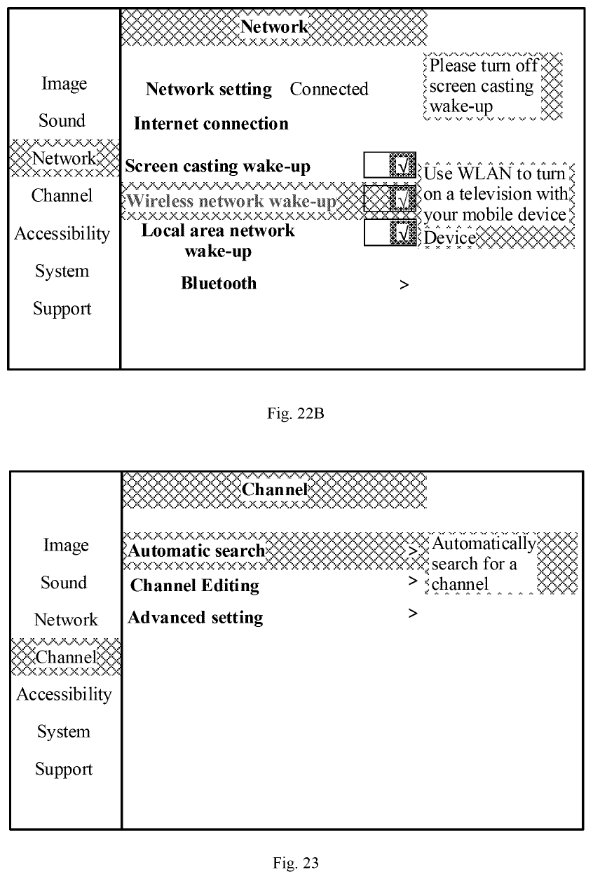

As shown in FIG. 21, after the user completes the confirmation of the user agreement and privacy policy, the display may be controlled to display a new prompt information window as shown in FIG. 21. This new prompt information will prompt the user that the display apparatus is about to turn on the function of “Wake up screen casting”, and will further prompt the user that this function will increase power consumption of the display apparatus. If the user selects to turn on the function of “Wake up screen casting” through a confirmation option in the window, the function of the “Wake up screen casting” may be controlled to be turned on. If the user selects to cancel the turn-on of the function of “Wake up screen casting” through a cancellation option in the window, the function setting operation will be cancelled.

For another example, as shown in FIG. 22A, in a case that the function of “Wake up screen casting” is turned off, according to a system configuration of the display apparatus, the user may control the display apparatus to turn on the function of “Wake up wireless network” by inputting the voice command. In a case that the function of “Wake up screen casting” is turned on, if the user wants to turn on the function of “Wake up wireless network”, the user may control the display to display the target setting interface as shown in FIG. 22B. In the target setting interface, the prompt information may be displayed. A “Wake up wireless network” option in the prompt information is grayed out and cannot be set. In addition, the prompt information may also use text to prompt the user that the function of “Wake up wireless network” cannot be turned on at this time and that the “Wake up screen casting” function needs to be turned off first.

In this way, the user may understand the operation method when setting the target setting option according to the prompt information, and may perform the operation according to the prompt information during the operation, which can help improve the accuracy of the user operation, and reduce an option search time and the possibility of incorrect operations.

In some embodiments, the voice command may be configured for indicating to switch a display page of the display to an automatic channel search page, the target setting option is a function setting option in a closed status when the automatic channel search page is opened, and/or a corresponding password inputting option when the automatic channel search page is opened.

The automatic channel search page can refer to a page in the display apparatus for automatically searching for television channels, and its opening entry is shown in FIG. 23.

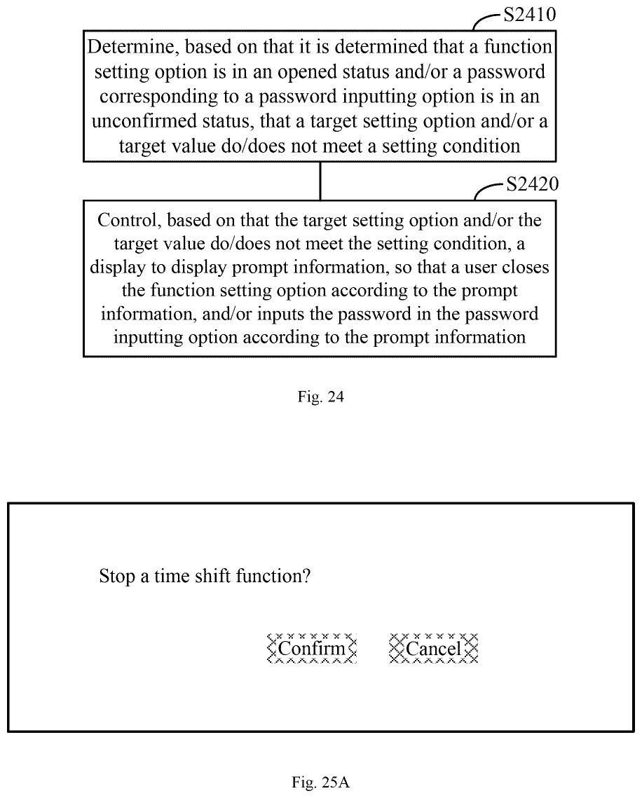

In order to smoothly switch to the automatic channel search page, as shown in FIG. 24, the display apparatus may further execute the following methods.

Step S2410, based on that it is determined that the function setting option is in an opened status and/or a password corresponding to the password inputting option is in an unconfirmed status, it is determined that the target setting option and/or the target value do/does not meet the setting condition.

When opening the automatic channel search page, the display apparatus needs to turn off a time shift function, a recording function, etc. At the same time, if there is a parent lock, the parent lock needs to be opened first. That is to say, when switching the display page to the automatic channel search page, the two function setting options of the time shift function and the recording function should be in a closed status, and when there is the parent lock, the corresponding password needs to be input to open the parent lock.

Therefore, when it is determined that the function setting option is in the opened status and/or the password corresponding to the password inputting option is in the unconfirmed status, it may be determined that the target setting option and/or the target value do/does not meet the setting condition.

Step S2420, based on that the target setting option and/or the target value do/does not meet the setting condition, the display is controlled to display the prompt information, so that the user closes the function setting option according to the prompt information, and/or inputs the password in the password inputting option according to the prompt information.

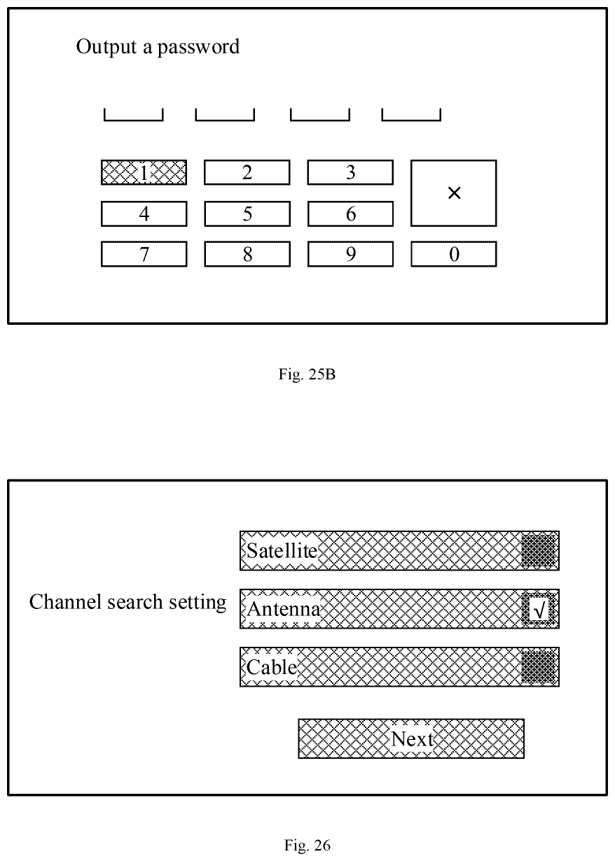

When the target setting option and/or the target value do/does not meet the setting condition, the prompt information may be displayed, as shown in FIG. 25A, the prompt information may prompt the user to turn off the time shift function. After the user confirms to turn off the time shift function through an option of “stop time shift” in the prompt information, as shown in FIG. 25B, the display may further be controlled to display another piece of prompt information. This prompt information may be configured for prompting the user to input the password. After the user inputs the password and confirms that the password is correct, if there is a program, a channel search result page is entered. If not, the display may be controlled to enter a channel search setting page as shown in FIG. 26. In this page, the user may set a signal source for an automatic channel search function, such as selecting any one of a satellite, an antenna or a cable.

After completing the automatic channel search setting, the display may be controlled to enter the channel search result page, as shown in FIG. 27, the channel search result page may display channel search results, and the user may choose whether to confirm the search or search again through options of “Modify settings” and “Re-search” on the channel search result page.

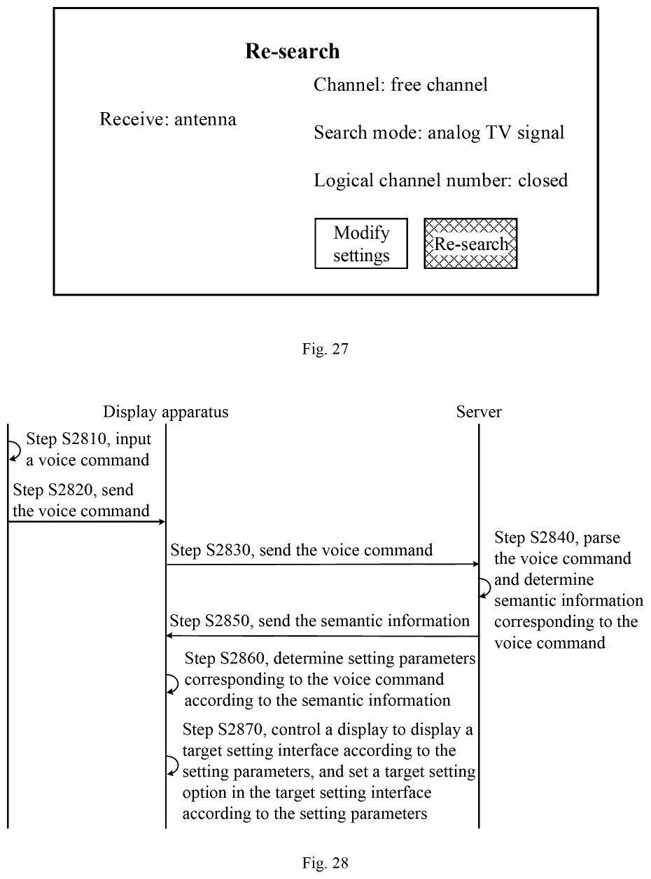

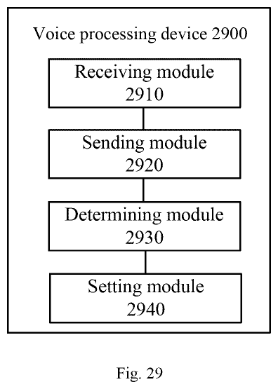

FIG. 28 is a schematic diagram of an interaction according to some embodiments of the disclosure. As shown in FIG. 28, the method may include the following steps.

Step S2810: a voice command is input through a remote control.

The voice command may also be recorded by a user through an external component communicatively connected with a display apparatus, such as a remote control, and a microphone.

Step S2820: the remote control sends the voice command to the display apparatus.

Step S2830: the display apparatus sends the voice command to a server.

Step S2840: the server parses the voice command and determines semantic information corresponding to the voice command.

For example, when receiving the voice command, the server may recognize the semantic information of the voice command through a voice recognition technology, a natural language processing technology, etc.

Step S2850: the display apparatus receives the semantic information sent from the server.

Step S2860: the display apparatus determines setting parameters corresponding to the voice command according to the semantic information.

After completing the parsing of the voice command, the server may send the semantic information of the voice command to the display apparatus. At the same time, in order to determine the control intention of the voice command, the semantic information sent from the server may be received, and the setting parameters corresponding to the voice command may be determined according to the semantic information.

Step S2870, a display is controlled to display a target setting interface according to the setting parameters, and set a target setting option in the target setting interface according to the setting parameters.

After determining the setting parameters, the target setting interface may be determined according to the setting parameters, and the display may be controlled to display the target setting interface, thereby setting the target setting option in the target setting interface.

Through the above method, the user may control the display apparatus to set the target setting option through the voice command, reducing the number of manual operations and improving the use experience of the user.

According to the voice processing method of the embodiments of the disclosure, the user may use the voice command to set the setting options of the display apparatus according to his/her own needs, without the need to manually open the corresponding setting interface for setting. Especially when the setting interface is at a high level, the user may directly enter the corresponding setting interface through the voice command without manually opening a plurality of interfaces to search for an opening entry of the setting interface, thereby greatly improving operation convenience for setting the display apparatus by the user and improving operation efficiency.

Embodiments of the disclosure further provide a voice processing device, as shown in FIG. 29, the voice processing device 2900 may be applied to a display apparatus, and may include: a receiving module 2910, configured to receive a voice command input from a user, the voice command being configured for setting a target setting option of the display apparatus, where, the display apparatus may include a plurality of setting options, and the target setting option is any one of the plurality of setting options; a sending module 2920, configured to send the voice command to a server, to cause the server to parse the voice command and determine semantic information corresponding to the voice command; a determining module 2930, configured to receive the semantic information sent from the server, and determine setting parameters corresponding to the voice command according to the semantic information; and a setting module 2940, configured to control a display to display a target setting interface according to the setting parameters, and set the target setting option in the target setting interface according to the setting parameters.

In some embodiments, the semantic information may include the target setting option and a target value of the target setting option, and the determining module 2930 is configured to acquire option configuration data of the display apparatus, the option configuration data being configured by using a tree data structure; search, in the option configuration data, for a node path that matches the target setting option and the target value of the target setting option, wherein the node path may include at least one node level, and the node level may include at least one data node; and determine the setting parameters based on each node level in the node path and the data node in each node level, wherein the setting parameters may include an interface level of the target setting interface, a parent level setting option of the target setting option, and the target value of the target setting option.

In some embodiments, the setting parameters further include a setting identifier of the target setting option, the setting identifier is configured for indicating whether the target setting option and the target value of the target setting option meet a setting condition, and the setting module 2940 is further configured to control, if it is determined that the target setting option and/or the target value do/does not meet the setting condition according to the setting identifier in the setting parameters, the display to display prompt information, so that the user sets the display apparatus according to the prompt information.

In some embodiments, the voice command is configured for indicating to set the target setting option as the target value, and the setting module 2940 is further configured to determine, if the target setting option is not available for setting as the target value, that the target setting option and/or the target value do/does not meet the setting condition; and control, if the target setting option and/or the target value do/does not meet the setting condition, the display to display the prompt information, so that the user sets the target setting option as other target values according to the prompt information.

In some embodiments, the voice command is configured for indicating to open the target setting option, and the setting module 2940 is further configured to determine, if a pre-setting function of the target setting option is not set, that the target setting option and/or the target value do/does not meet the setting condition; and control, if the target setting option and/or the target value do/does not meet the setting condition, the display to display the prompt information, so that the user sets the pre-setting function of the target setting option according to the prompt information.

In some embodiments, the voice command is configured for indicating to switch a display page of the display to an automatic channel search page, the target setting option is a function setting option in a closed status when the automatic channel search page is opened, and/or a corresponding password inputting option when the automatic channel search page is opened, and the setting module 2940 is further configured to determine, if it is determined that the function setting option is in an opened status and/or a password corresponding to the password inputting option is in an unconfirmed status, that the target setting option and/or the target value do/does not meet the setting condition; and control, if the target setting option and/or the target value do/does not meet the setting condition, the display to display the prompt information, so that the user closes the function setting option according to the prompt information, and/or inputs a password in the password inputting option according to the prompt information.

In some embodiments, the setting parameters may include at least one of a mode selection parameter, an on-off control parameter, a numeric value setting parameter, or a page control parameter.

In some embodiments, an application layer of the display apparatus 200 contains at least one application, such as: a live television application, a video on demand application, a media center application, and an application center. Different applications are configured for achieving different functions. By running different applications in the display apparatus 200, different programs may be executed to achieve the different functions. For example, a corresponding playback picture may be displayed in the display apparatus 200 through the live television application or the video on demand application above.

In some embodiments, the live television application may provide a live television and a broadcasting television through different signal sources. For example, the live television application may provide a television signal by using inputs from a cable television, wireless broadcasting, a satellite service, or other types of live television services. The live television application may display a media resource picture of the live television signal on the display apparatus 200.

In some embodiments, the video on demand application may provide videos from different storage sources. Unlike the live television application, video on demand provides media resource data from some storage sources. For example, the video on demand may come from a server of cloud storage or from a local hard disk memory containing saved video programs.

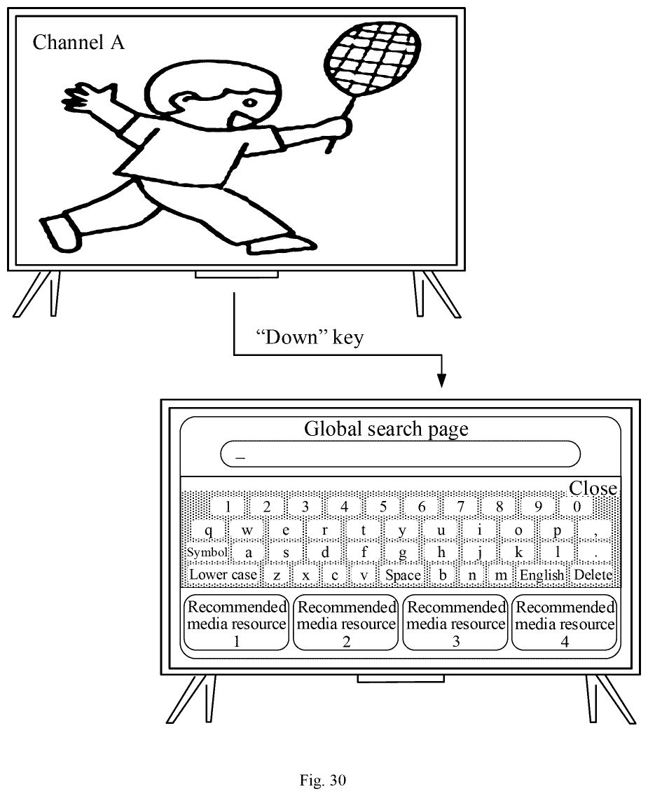

Based on the above application, the display apparatus 200 such as an intelligent television may achieve a bidirectional human-computer interaction function, which can meet the diverse and personalized needs of the user. For example, the display apparatus may play various media resources such as a video and audio. When wanting to watch more media resources, the user may switch different media resource channels through a channel list, or search for relevant media resources on the display apparatus 200. For example, FIG. 30 is a schematic diagram of an effect of searching for a media resource through a preset key according to an embodiment of the disclosure. As shown in FIG. 30, the display apparatus 200 is playing a channel A. When wanting to watch more media resources, the user may press the preset key, such as a “down” key, on the remote control, and after receiving a key command, the display apparatus 200 will directly jump to a global search page, thereby providing the user with a media resource search function or other media resource recommendation functions.

However, when executing the media resource search or media resource recommendation functions through the preset key, the pop-up global search page will interrupt the currently watched content of the user, as shown in FIG. 30, the global search page will obstruct the currently played channel A. The user may also touch the down key by mistake, and a user interface will still jump directly from the currently played channel A to the global search page, that is, accidental jumping is caused by misoperation, which affects the watching experience of the user. Moreover, the media resources searched for or recommended through the global search page are targeted at the global range, and include the media resource function of the entire television. For example, the recommended media resource may not be related to the media resource currently watched by the user. The channel A is currently played, and the four recommended media resources pushed by the display apparatus are not associated with the channel A and are obtained through global range search. That is to say, when searching for the media resources through the preset key, it is a global recommendation with a poor targeting property. Therefore, when using the preset key to execute the media resource search or media resource recommendation function, there are problems of interrupting the currently watched content of the user, affecting the watching experience of the user, and the poor targeting property of the recommended media resources.

In order to solve the problems of interrupting the currently watched content of the user, affecting the watching experience of the user, and the poor targeting property of the recommended media resources when using the preset key to execute the media resource search or media resource recommendation function, some embodiments of the disclosure provide a display apparatus 200. The display apparatus 200 may include at least one processor and a display, wherein the display may be configured to display images from a broadcasting system and/or a network and/or a user interface, and the display apparatus may execute a display method of a media resource recommendation page. The display apparatus 200 may display the media resource recommendation page in a floating form by selecting a preset key, without interrupting or obstructing a currently played media resource in the user interface. At the same time, the media resources recommended in the media resource recommendation page are media resources associated with a currently played target media resource, thereby solving the problems of interrupting the currently watched content of the user, affecting the watching experience of the user, and the poor targeting property of the recommended media resources when using the preset key to execute the media resource search or media resource recommendation function.

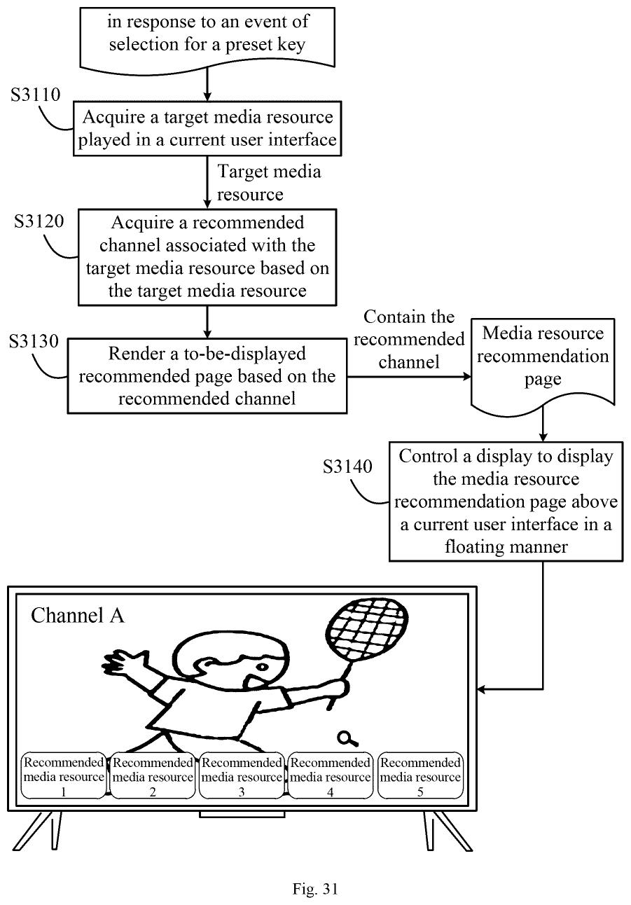

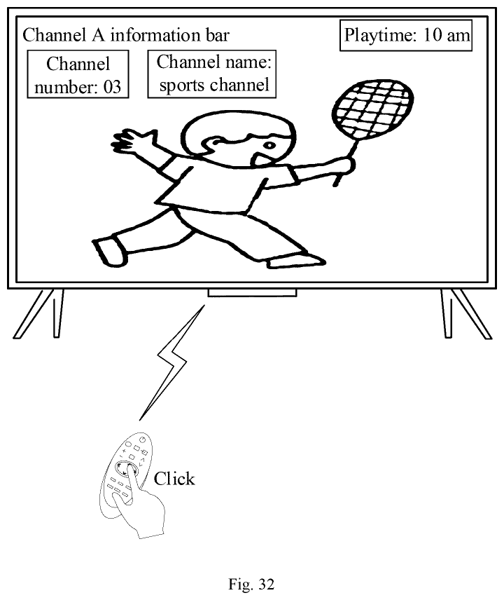

In order to facilitate the understanding of some embodiments of the disclosure, each step is illustrated in detail below in conjunction with some specific embodiments and accompanying drawings. FIG. 31 is a schematic flow diagram that a display apparatus executes a display method of a media resource recommendation page according to some embodiments of the disclosure. As shown in FIG. 31, in some embodiments, when the display apparatus executes the display method of the media resource recommendation page, the following steps S3110-S3140 may be included.

Step S3110: in response to an event of selection for a preset key, the display apparatus acquires a target media resource played in a current user interface.

In some embodiments, the display apparatus may acquire relevant information of a media resource and a channel list of the media resource when playing the media resource. When playing the media resource in the user interface, direction keys on a remote control and a rule for calling the media resource may be pre-set, so that the relevant information of the media resource may be called through the direction keys.

In some embodiments, the media resource may include channel information and a channel list, and the rule for calling the media resource may include that an “up” key on the remote control indicates the retrieval of the channel information currently played. FIG. 32 is a schematic diagram of an effect of displaying media resource information by the display apparatus according to some embodiments of the disclosure. As shown in FIG. 32, when playing a channel A in the user interface, in response to the up key on the remote control, the display apparatus 200 will display a channel information bar at a preset location of the channel A, such as a top location, and display the channel information on the channel information bar. Exemplarily, the channel information may include a channel number, a channel name, a playback time, etc.

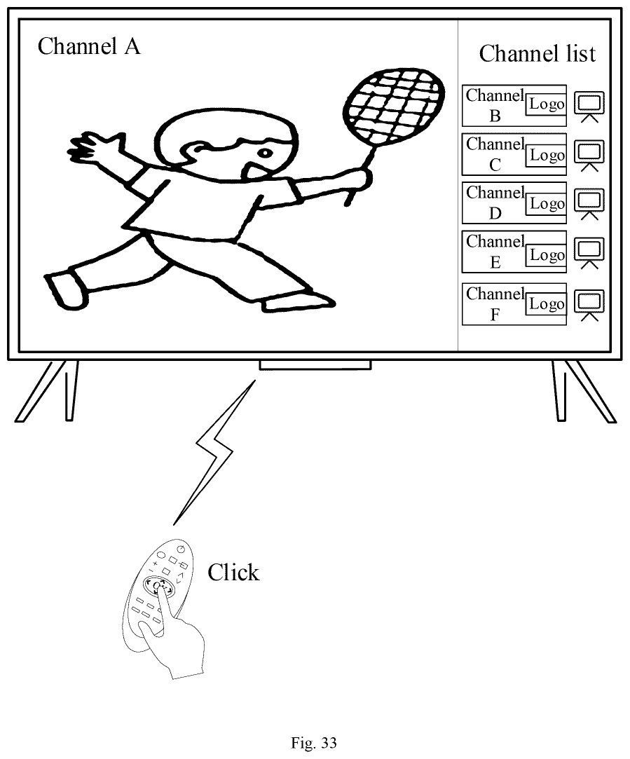

In some embodiments, the rule for calling the media resource may further include that an ok key on the remote control indicates the retrieval of the channel list composed of all channels. FIG. 33 is a schematic diagram of an effect of displaying the channel list of the media resource by the display apparatus according to some embodiments of the disclosure. As shown in FIG. 33, a location of displaying the channel list may be pre-set. Exemplarily, all channel classification names and icons supported by the display apparatus 200 may be displayed on a right side. After clicking on a certain classification, the channel list may display all channels contained in currently selected classification, such as a channel logo, a channel number, a channel name, and current channel information. In this way, when wanting to switch the channel, the user may click on the channel to switch directly.

It should be noted that the rule for calling the media resource is not limited to the above two situations, and other rules may further be customized according to actual needs, which is not specifically limited in the disclosure. In response to a selected event of a user for a preset key, the display apparatus 200 may acquire a target media resource played in a current user interface. Exemplarily, the target media resource may be acquired through the channel number played in the current user interface, or the target media resource may be parsed through a channel information bar. After executing step S3110, the following step S3120 may be executed.

Step S3120: the display apparatus 200 acquires a recommended channel associated with the target media resource based on the target media resource.

After acquiring the target media resource, the display apparatus 200 may acquire the recommended channel associated with the target media resource based on the target media resource. In this way, the media resource recommended by the display apparatus 200 will no longer be a global media resource, but the media resource associated with the currently played target media resource, with a strong targeting property.

In some embodiments, in order to support a function that the display apparatus 200 acquires the recommended channel and displays the recommended channel, a browser architecture with a lightweight application container may be set in the display apparatus 200. The entire UI may run on the browser, and the browser bears the entire UI upwards and serves as a basic bridge for communication between the UI and a system of the display apparatus downwards.

In order to acquire the recommended channel associated with the target media resource based on the target media resource, in some embodiments, the display apparatus 200 may acquire the channel number of the target media resource, and then initiate a network request to a cloud based on this channel number. The network request is configured for requesting the recommended channel associated with the target media resource from the cloud, and finally receiving the recommended channel returned by the cloud based on the network request through a data service interface.

The channel number of the target media resource is 6000, and the display apparatus 200 will use the channel number 6000 as a request parameter to initiate the network request to the cloud. After receiving the network request, the cloud may calculate the recommended channel associated with the target media resource based on a big data algorithm, and feed the recommended channel back to the display apparatus 200 through an interaction interface such as the data service interface. The display apparatus 200 may also receive the recommended channel returned from the cloud through the data service interface. In this way, the acquired recommended channel is the media resource associated with the target media resource, namely, the targeted media resource and not the media resource in the global range. After executing step S3120, the following step S3130 may be executed.

Step S3130: the display apparatus 200 renders a to-be-displayed recommendation page based on the recommended channel to generate a media resource recommendation page containing the recommended channel.

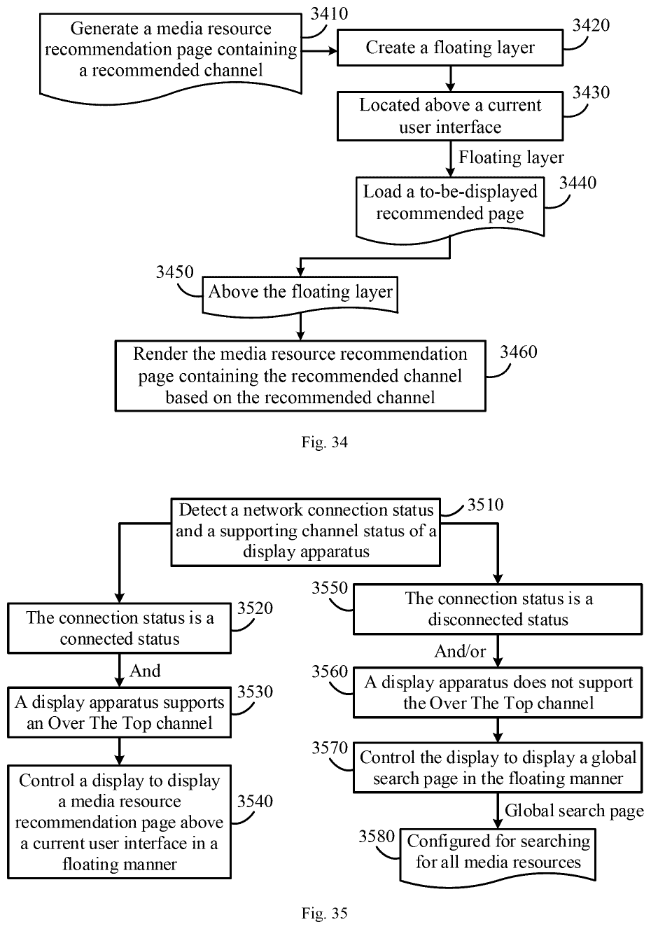

After receiving the recommended channel associated with the target media resource, the display apparatus 200 may render the to-be-displayed recommendation page based on the recommended channel to generate the media resource recommendation page containing the recommended channel. FIG. 34 is a schematic flow diagram of generating the media resource recommendation page containing the recommended channel by the display apparatus according to some embodiments of the disclosure. As shown in FIG. 34, when generating the media resource recommendation page (3410), the display apparatus 200 first creates a floating layer (3420), and the floating layer is located above the current user interface (3430), and is configured for loading the to-be-displayed recommendation page (3440); and then, the media resource recommendation page (3460) containing the recommended channel may be rendered on the floating layer (3450) based on the recommended channel. In this way, the media resource recommendation page will contain the recommended channel associated with the target media resource. When wanting to switch a certain channel, the user may click on the recommended channel to complete the channel switch. After executing step S3130, the following step S3140 may be executed.

Step S3140: the display apparatus 200 controls a display to display the media resource recommendation page above the current user interface in a floating manner.

After generating the media resource recommendation page, the display apparatus 200 may control the display 260 to display the media resource recommendation page above the current user interface in a floating manner. In this way, when receiving a down key of a remote control, the display apparatus 200 may acquire the recommended channel associated with the target media resource, that is, the media resource recommendation page contains the recommended channel, which can provide the user with the media resource that is highly targeted to and associated with the target media resource. At the same time, the media resource recommendation page is displayed in a floating form, which does not interrupt the target media resource being played in the user interface, that is, not affecting the watching experience of the user. That is to say, in the embodiments of the disclosure, when the user presses the down key of the remote control, the floating media resource recommendation page is displayed. Even if the user presses the down key by mistake, the target media resource played in the user interface will not be affected due to the displayed media resource recommendation page in the floating form, thereby solving the problems of interrupting the currently watched content of the user, affecting the watching experience of the user, and the poor targeting property of the recommended media resource when using the preset key to execute the media resource search or media resource recommendation function.

In some embodiments of the disclosure, when playing the target media resource, in response to the selected event of the preset key by the user, the following detection may be performed before opening the media resource recommendation page. FIG. 35 is a schematic flow diagram of detecting a network connection status and a supporting channel status in a display apparatus according to some embodiments of the disclosure. As shown in FIG. 35, before opening a media resource recommendation page, the display apparatus 200 may first detect the network connection status and the supporting channel status of the display apparatus (3510). If the network connection status is a connected status (3520) and the display apparatus 200 supports an Over The Top channel (3530), the display apparatus 200 controls a display 260 to display the media resource recommendation page above a current user interface in a floating manner (3540). If the network connection status is a disconnected status (3550), and/or the display apparatus 200 does not support the Over The Top channel (3560), the display apparatus 200 controls the display 260 to display a global search page in a floating manner (3570), wherein the global search page is configured for searching a media resource (3580).

The display apparatus 200 may first determine whether the network is in the connected status, and then determine whether the display apparatus 200 supports the Over The Top (OTT) channel. For example, whether the display apparatus 200 may support a network live streaming service, and is filled with more network channels, etc. Only when the network connection status and supporting of the Over The Top channel are both met, the media resource recommendation page will be opened by pressing the down key. In this way, when there are more channels, the media resource more matching with the target media resource may be recommended to the user, with a stronger targeting property.

In some embodiments, if the network connection status is the disconnected status and/or the display apparatus 200 does not support the over The Top channel, the display apparatus 200 may control the display 260 to display the global search page in the floating manner, wherein the global search page is configured for searching the media resource. In this way, the display apparatus 200 may respond to the press of the down key by the user in a case of no network or in a case that the display apparatus 200 does not support the over The Top channel, the display apparatus 200 will continue to provide the recommended channel to the user in a global search manner, and the global search page is displayed in the floating manner and will not affect the target media resource currently watched by the user or the watching experience of the user.

In some embodiments, the media resource recommendation page may be internally provided with a search control and a search bar, and the display apparatus 200 may acquire a search content inputted by the user in the search bar. Subsequently, in response to a confirmation event of the user for the search content based on the search control, the display apparatus 200 may control the display 260 to display the global search page, so that the user searches for the media resource in the global search page based on the search content.

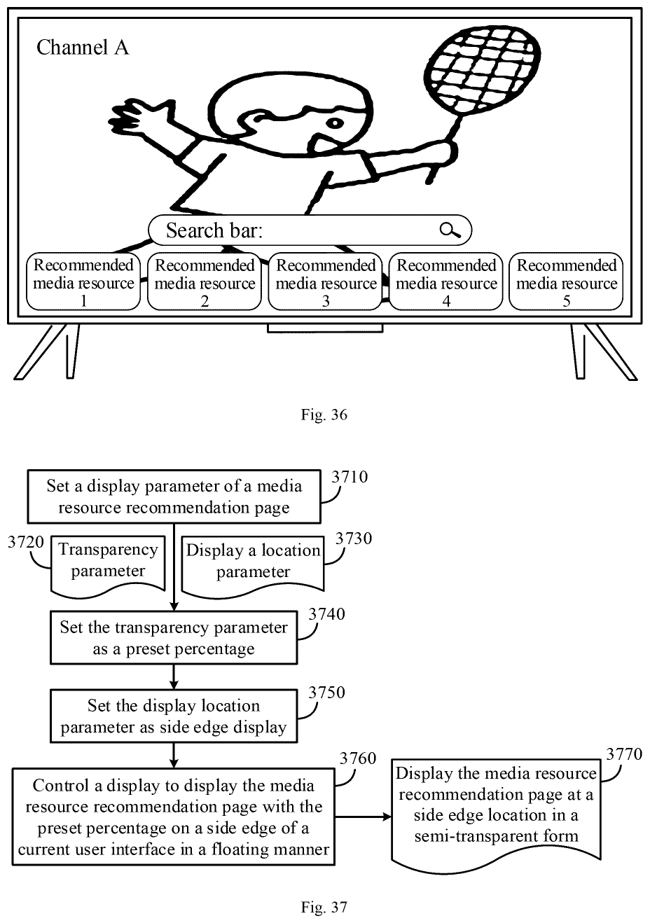

FIG. 36 is a schematic diagram of an effect of displaying a media resource recommendation page in a display apparatus in a floating form according to some embodiments of the disclosure. As shown in FIG. 36, when a user presses a down key, the display apparatus 200 will display the media resource recommendation page above a current user interface in the floating form, and a recommended channel associated with a played target media resource is displayed in the media resource recommendation page. The media resource recommendation page contains a search bar and a search control. Only when the user inputs a search content in the search bar and clicks on the search control, the media resource recommendation page will jump to a global search page. In this way, on the one hand, a situation that the target media resource currently played is interrupted due to directly jumping to the global search page due to misoperation of the user is avoided; and on the other hand, the target media resource played in a user interface will not be obstructed by displaying the media resource recommendation page and the global search page in the floating form.

After the display apparatus 200 receives the recommended channel fed back from a cloud, in addition to rendering a to-be-displayed recommendation page based on the recommended channel, the recommended channel may further be stored in a cache database, and an effective duration for storing the recommended channel in the cache database is set. In response to a reselected event of the user for a preset key based on the same target media resource, the display apparatus 200 may acquire a current time of the reselected event, and acquire a selection time of the last selected event for the preset key. Afterwards, a time interval between a current time and the selected time is calculated, and following comparison is made. If the time interval is less than or equal to the effective duration, no network request is initiated to the cloud; and if the time interval is greater than the effective duration, the display apparatus 200 initiates the network request to the cloud based on a channel number.

After receiving the recommended channel, the display apparatus 200 may cache the recommended channel. In some embodiments, the effective duration may be set as 5 minutes, a channel number of the target media resource may be 6000, the channel number corresponds to 25 recommended channels, and thus all 25 recommended channels with the channel number of 6000 will be cached within 5 minutes. If the user watches the channel 6000 again within 5 minutes, the display apparatus 200 will no longer initiates the network request to the cloud, but will directly use the cached recommended channels.

That is to say, in some embodiments, the display apparatus 200 will detect a storage status of the recommended channel in the cache database in response to the selected event of the user for the preset key. If there is the recommended channel in the cache database, the recommended channel in the cache database will serve as the recommended channel for the target media resource. If there is no recommended channel in the cache database, the network request is initiated to the cloud based on the channel number, and the recommended channel returned by the cloud based on the network request is used as the recommended channel for the target media resource.

When the user plays a certain target media resource for the first time, for example, if the channel number of the target media resource is 6000, the media resource recommendation page will be retrieved by pressing the down key, and the display apparatus 200 will request 25 recommended channels related to the channel number from the cloud according to the channel number 6000. After acquiring the 25 recommended channels, the display apparatus 200 will render the media resource recommendation page. During this process, it will occupy a bandwidth and consume time. Moreover, the media resource recommendation page belongs to a high-frequency usage page. If requesting the cloud every time, it will also increase the pressure on a cloud server and waste a bandwidth. In some embodiments, it is highly likely that the recommended channel associated with the target media resource and recommended within a period of time such as 5 minutes will not change. Therefore, the display apparatus 200 may increase a caching strategy and set an effective caching time, for example, the caching time may be 5 minutes. If the user frequently presses the down key while watching the channel 6000, within 5 minutes, the display apparatus 200 will use cache to display the recommended channel instead of requesting cloud data. When the user switches to another channel, such as a channel 7000, the display apparatus 200 then determines whether to initiate the network request to the cloud at this time. According to this logic, the display apparatus 200 may first determine whether a cache corresponding to the channel 7000 exists and is valid. If there is the cache and the cache is valid, the display apparatus 200 may directly call the recommended channel in the cache. If there is no cache, the display apparatus 200 then initiates the network request to the cloud. In this way, on the one hand, the use of a network bandwidth can be reduced, and computing resources in the cloud can be reduced. On the other hand, because the cached recommended channel is stored locally, a display speed of the recommended channel can be increased. Meanwhile, from the perspective of user experience, the media resource recommendation page does not interrupt the currently played target media resource, so the entire process is uninterrupted, and the media resource recommendation page may be retrieved only by one press, thereby improving the user experience.

FIG. 37 is a schematic flow diagram of setting a display parameter of a media resource recommendation page in a display apparatus according to some embodiments of the disclosure. As shown in FIG. 37, in some embodiments, the display apparatus 200 may set the display parameter of the media resource recommendation page (3710), wherein the display parameter may include at least a transparency parameter (3720) and a display location parameter (3730). The display apparatus 200 may set the transparency parameter as a preset percentage (3740), set the display location parameter as side edge display (3750), and control a display 260 to display the media resource recommendation page with the preset percentage on a side edge of a current user interface in a floating manner (3760), so that the media resource recommendation page is displayed at the side edge location in a semi-transparent form (3770).

The preset percentage may be 50%, and the display location parameter may be on the left or right side of the current user interface. After setting the media resource recommendation page according to the above parameters, the media resource recommendation page will be displayed on the left or right side of the user interface in the floating manner in the semi-transparent form. The specific location is not limited by the disclosure. That is to say, in the embodiments of the disclosure, a playback layer corresponding to a currently displayed target media resource and a display layer corresponding to the media resource recommendation page are designed separately. In this way, the two independent layers will not interfere with each other, and thus the media resource recommendation page will not affect an original playback process.

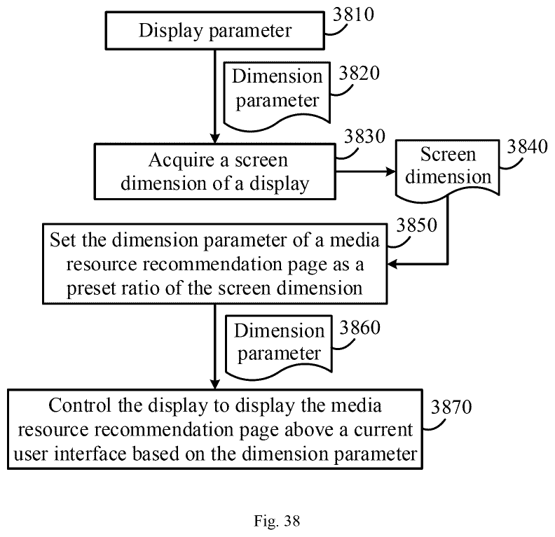

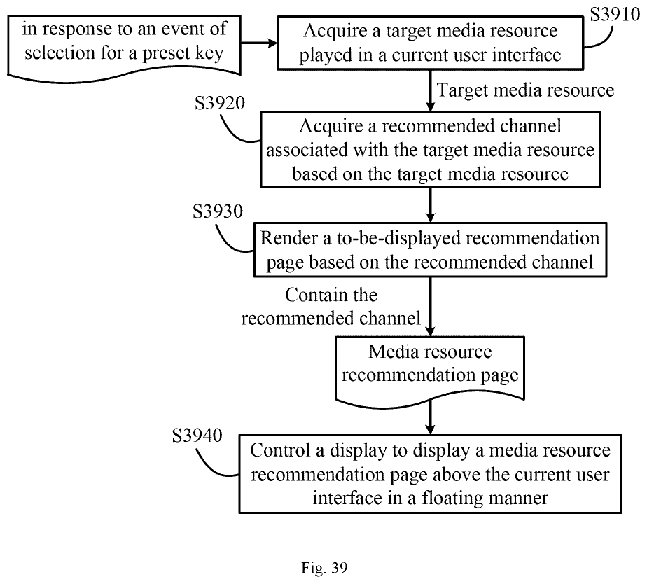

FIG. 38 is a schematic flow diagram of setting a dimension parameter in a display apparatus according to some embodiments of the disclosure. As shown in FIG. 38, a display parameter (3810) further includes a dimension parameter (3820). The display apparatus 200 may acquire a screen dimension (3830; 3840) of a display 260, set the dimension parameter of the media resource recommendation page as a preset ratio of the screen dimension (3850), and finally, control the display 260 to display the media resource recommendation page (3870) above a current user interface based on the dimension parameter (3860).

Exemplarily, the preset ratio may be 1/3 of the screen dimension, that is, a height of the media resource recommendation page is only 1/3 of the screen dimension. The media resource recommendation page is displayed above the user interface in a semi-transparent and floating form, with the height being only the preset ratio of the screen dimension, and displayed on a side location, which not only meets the need of a user to watch a recommended channel associated with a target media resource, but also does not interrupt the user's watching of the target media resource, thereby solving problems of interrupting a currently watched content of the user, affecting the watching experience of the user, and the poor targeting property of the recommended media resource when using a preset key to execute the media resource search or media resource recommendation function.

From the above implementations, it can be seen that some embodiments of the disclosure provide a display apparatus. The display apparatus acquires a target media resource played in a current user interface in response to a selected event of a user for a preset key, acquires a recommended channel associated with the target media resource based on the target media resource, then renders a to-be-displayed recommended page based on the recommended channel so as to generate a media resource recommendation page containing the recommended channel, and finally controls a display to display the media resource recommendation page above the current user interface in a floating manner. The display apparatus may display the media resource recommendation page in a floating form by selecting the preset key, without interrupting or obstructing a currently played target media resource in the user interface. At the same time, the media resources recommended in the media resource recommendation page are media resources associated with the currently played target media resource, thereby solving the problems of interrupting a currently watched content of the user, affecting the watching experience of the user, and the poor targeting property of the recommended media resources when using the preset key to execute the media resource search or media resource recommendation function.

Based on the above display apparatus, some embodiments of the disclosure further provide a display method of a media resource recommendation page, and the method may be applied to the display apparatus in the above embodiments. The display apparatus may include at least one processor and a display 260 for displaying a user interface. FIG. 39 is a schematic flow diagram of a display method of a media resource recommendation page according to some embodiments of the disclosure. As shown in FIG. 39, in some embodiments, the display method of the media resource recommendation page may include the following steps S3910-S3940.

Step S3910: in response to an event of selection for a preset key, the display apparatus acquires a target media resource played in a current user interface.

In some embodiments, the display apparatus may acquire relevant information of a media resource and a channel list of the media resource when playing the media resource. When playing the media resource in the user interface, direction keys on a remote control and a rule for calling the media resource may be pre-set, so that the relevant information of the media resource may be called through the direction keys.

In some embodiments, the media resource may include channel information and a channel list, and the rule for calling the media resource may include that an “up” key on the remote control indicates the retrieval of the currently played channel information. When playing a channel A in the user interface, in response to the up key on the remote control, the display apparatus will display a channel information bar at a preset location of the channel A, such as a top location, and display the channel information on the channel information bar. Exemplarily, the channel information may include a channel number, a channel name, a playback time, etc.

In some embodiments, the rule for calling the media resource may further include that an ok key on the remote control indicates the retrieval of the channel list composed of all channels. A location of displaying the channel list may be pre-set. Exemplarily, all channel classification names and icons supported by the display apparatus may be displayed on a right side. After clicking on a certain classification, the channel list may display all channels contained in currently selected classification, such as a channel logo, a channel number, a channel name, and current channel information. In this way, when wanting to switch the channel, the user may click on the channel to switch directly.

It should be noted that the rule for calling the media resource is not limited to the above two situations, and other rules may further be customized according to actual needs, which is not specifically limited in the disclosure. In response to the selected event of the user for the preset key, the display apparatus may acquire the target media resource played in the current user interface. The target media resource may be acquired through the channel number played in the current user interface, or the target media resource may be parsed through the channel information bar.

Step S3920: the display apparatus acquires a recommended channel associated with the target media resource based on the target media resource.

After acquiring the target media resource, the display apparatus may acquire the recommended channel associated with the target media resource based on the target media resource. In this way, the media resource recommended by the display apparatus will no longer be a global media resource, but the media resource associated with the currently played target media resource, with a strong targeting property.

In order to acquire the recommended channel associated with the target media resource based on the target media resource, in some embodiments, the display apparatus may acquire the channel number of the target media resource, and then initiate a network request to a cloud based on this channel number. The network request is configured for requesting the recommended channel associated with the target media resource from the cloud, and finally receiving the recommended channel returned by the cloud based on the network request through a data service interface.

The channel number of the target media resource is 6000, and the display apparatus will use the channel number 6000 as a request parameter to initiate the network request to the cloud. After receiving the network request, the cloud may calculate the recommended channel associated with the target media resource based on a big data algorithm, and feed the recommended channel back to the display apparatus through an interaction interface such as the data service interface. The display apparatus may also receive the recommended channel returned from the cloud through the data service interface. In this way, the acquired recommended channel is the media resource associated with the target media resource, namely, the targeted media resource and not the media resource in the global range.

Step S3930: the display apparatus renders a to-be-displayed recommendation page based on the recommended channel to generate a media resource recommendation page containing the recommended channel.

After receiving the recommended channel associated with the target media resource, the display apparatus may render the to-be-displayed recommendation page based on the recommended channel to generate the media resource recommendation page containing the recommended channel. When generating the media resource recommendation page, the display apparatus may first create a floating layer, and the floating layer is located above the current user interface, and is configured for loading the to-be-displayed recommendation page; and then, the media resource recommendation page containing the recommended channel may be rendered on the floating layer based on the recommended channel. In this way, the media resource recommendation page will contain the recommended channel associated with the target media resource. When wanting to switch a certain channel, the user may click on the recommended channel to complete the channel switch.

Step S3940: the display apparatus controls a display to display the media resource recommendation page above the current user interface in a floating manner.

After generating the media resource recommendation page, the display apparatus may control the display to display the media resource recommendation page above the current user interface in a floating manner. In this way, when receiving a down key of a remote control, the display apparatus may acquire the recommended channel associated with the target media resource, that is, the media resource recommendation page contains the recommended channel, which can provide the user with the media resource that is highly targeted to and associated with the target media resource. At the same time, the media resource recommendation page is displayed in a floating form, which does not interrupt the target media resource being played in the user interface, that is, not affecting the watching experience of the user. That is to say, in the embodiment of the disclosure, when the user presses the down key of the remote control, the floating media resource recommendation page is displayed. Even if the user presses the down key by mistake, the target media resource played in the user interface will not be affected due to the displayed media resource recommendation page in the floating form, thereby solving the problems of interrupting the currently watched content of the user, affecting the watching experience of the user, and the poor targeting property of the recommended media resource when using the preset key to execute the media resource search or media resource recommendation function.

After the display apparatus receives the recommended channel fed back from the cloud, in addition to rendering a to-be-displayed recommendation based on the recommended channel, the recommended channel may further be stored in a cache database, and an effective duration for storing the recommended channel in the cache database is set. In response to a reselected event of the user for a preset key based on the same target media resource, the display apparatus may acquire a current time of the reselected event, and acquire a selection time of the last selected event for the preset key. Afterwards, a time interval between a current time and the selected time is calculated, and following comparison is made. If the time interval is less than or equal to the effective duration, no network request is initiated to the cloud; and if the time interval is greater than the effective duration, the display apparatus initiates the network request to the cloud based on the channel number.

That is to say, in some embodiments, the display apparatus will detect a storage status of the recommended channel in the cache database in response to the selected event of the user for the preset key. If there is the recommended channel in the cache database, the recommended channel in the cache database serves as the recommended channel for the target media resource. If there is no recommended channel in the cache database, the network request is initiated to the cloud based on the channel number, and the recommended channel returned by the cloud based on the network request is used as the recommended channel for the target media resource.

From the above implementations, it can be seen that the above embodiment provides the display method of the media resource recommendation page. The method may display the media resource recommendation page in the floating form by selecting the preset key, without interrupting or obstructing the currently played media resource in the user interface. At the same time, the media resources recommended in the media resource recommendation page are media resources associated with the currently played target media resource, thereby solving the problem of interrupting the currently watched content of the user, affecting the watching experience of the user, and the poor targeting property of the recommended media resources when using the preset key to execute the media resource search or media resource recommendation function.

The display apparatus may be configured with a channel list function, and all channels in the channel list may be displayed through the channel list, and a channel played may be switched through the channel list. The user may manage the channels in the channel list through the channel list, such as modifying the channel list to which the channels belong and a display manner. The channel list to which the channels belong may include a non-favorite list and a favorite list, and the display manner of the channels may include displaying in the channel list, displaying a shortcut on a home interface, etc.

The display apparatus is configured with an editing page for the user to modify the channel list to which the channels belong and the display manner. However, operations of entering the editing page and making modifications on the editing page are quite cumbersome, and after entering the editing page, the user cannot watch a currently played picture, resulting in a poor user experience.

In order to solve the above problems, embodiments of the disclosure provide a channel management method based on a channel list, which is configured for simplifying user's modification of the channel list to which channels belong and a display manner, and reducing the impact on user's watching of a program video when modifying the channel list to which the channels belong and the display manner.

When the user performs an interactive operation on a user interface through a control device 100, the UI may call a corresponding middleware interface through a VIDAA Plus Module and Live TV Module encapsulating method to operate a DTV database or an OTT database so as to modify corresponding data. For example, the channel list to which the channels belong, and the display manner are modified. In response to the operations of the user on the UI page, the UI page will pass channel data (such as a channel number, a channel name, and a channel ID) to a corresponding interface according to a channel type (such as DTV or OTT) so as to modify the DTV database or the OTT database, and synchronously update a public Store of a UI to update the display of the UI page.

When the display apparatus displays a program video from a first channel in a first channel list, the user may modify the channel list to which the channel belongs. The first channel list may be a favorite list, and the channels in the favorite list are favorite channels. The first channel list may be a non-favorite list, such as a list of all channels, a DTV list, and a custom list. The channels in the non-favorite list are all non-favorite channels, partly non-favorite channels, or all favorite channels.

When the display apparatus displays the program video from the first channel in the first channel list, if the user inputs a command to switch the channel through the control device 100 and the like, the display apparatus switch the channel in response to the command according to an order of all the channels in the first channel list.

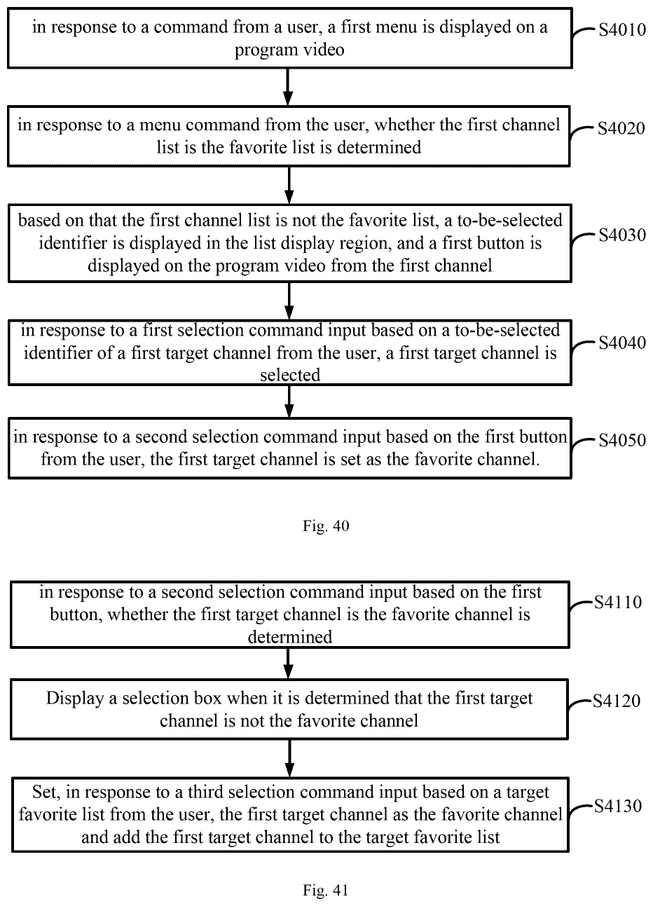

Based on the system architecture shown in FIG. 6, the display apparatus may modify the channel list to which the channel belongs according to a process shown in FIG. 40, which may include the following steps.

S4010, in response to a command from a user, a first menu is displayed on a program video.

The user may input the command through a specified key on the control device 100, such as an OK key and a CH.List key, and the command is configured for indicating to display the channel list.

The display apparatus displays the channel list in a form of the first menu. The first menu may include a list display region, and the list display region is configured for displaying the selected channel list. When displaying the program video from the first channel in the first channel list, the display apparatus displays the first menu in response to the command. The list display region of the first menu may include the first channel list, that is, the channel list to which the currently played channel belongs is first displayed in the list display region.

In some embodiments, the first menu may further include an entry of each channel list. An icon of the entry of the channel list corresponds to the corresponding channel list. For example, an icon of an entry of the favorite list is a heart shape, and an icon of an entry of the DTV list may include a text of the DTV. In this way, the user may quickly determine the channel list corresponding to the corresponding entry based on the icon. When the entry of the channel list is selected, the channel list is selected, and the list display region displays the selected channel list. When the entry of the channel list is selected, its corresponding icon may be highlighted to prompt the user of the channel list to which the channel displayed in the list display region belongs.

In some embodiments, the first channel list may be a default channel list, such as a list of all the channels. After the display apparatus is booted, the program video from the channel may be played according to the default channel list.

In some embodiments, the first channel list may be a channel list selected by the user, such as the favorite list. After the display apparatus is booted, the program video from the channel may be played according to the default channel list. The user may adjust the default channel list to the favorite list, and the display apparatus will play the program video from the channel according to the favorite list.

When the display apparatus displays the first menu, the channels in the first channel list displayed in the list display region first may include a first channel, and a focus is displayed on the first channel to prompt the user of the currently played channel through the focus. The first channel may be a first channel located in the list display region, and the first channel may also be a corresponding bit order located in the list display region. The corresponding bit order is determined based on a bit order of the first channel in the first channel list and the number of channels that may be displayed in the list display region.

S4020, in response to a menu command from the user, whether the first channel list is the favorite list is determined.

The user may input the menu command based on a menu key on the control device.

When displaying a first menu, the display apparatus recognizes whether the first channel list is the favorite list in response to the menu command from the user.

S4030, based on that the first channel list is not the favorite list, a to-be-selected identifier is displayed in the list display region, and a first button is displayed on the program video from the first channel.

If the first channel list is not the favorite list, the channels in the first channel list may be set as the favorite channels, that is, the channels in the first channel list may be added to the favorite list.

The display apparatus displays the to-be-selected identifier in the list display region, and the to-be-selected identifier is displayed corresponding to each channel in the first channel list. The to-be-selected identifier is a control, such as a check box, and the corresponding channels may be selected or released based on the to-be-selected identifier.

The display apparatus further displays the first button on the program video from the first channel, and the first button is configured for setting a selected channel as a favorite channel.

At this time, the display apparatus simultaneously displays the program video from the first channel, the first menu, and the first button. Although the first menu and the first button obstruct the program video from the first channel, the user may still watch the program video from the first channel, which can effectively reduce the impact on the user's watching of the program video from the first channel.

S4040, in response to a first selection command input based on a to-be-selected identifier of a first target channel from the user, a first target channel is selected.

The first target channel is a channel that the user wants to set as the favorite channel in the first channel list. The user may input the first selection command based on an OK key or an enter key on the control device 100. The user may input the first selection command for the to-be-selected identifiers of the plurality of first target channels. Correspondingly, the display apparatus may select the plurality of first target channels.

S4050, in response to a second selection command input based on the first button from the user, the first target channel is set as the favorite channel.

The display apparatus determines the selected first target channel in response to the second selection command, and sets the first target channel as the favorite channel. If there are the plurality of first target channels, the display apparatus may set these first target channels as the favorite channels once.

When setting the first target channel as the favorite channel, the display apparatus modifies channel data of the first target channel in a corresponding database. The display apparatus determines a channel type of the first target channel, such as a DTV channel and an OTT channel. If it is determined that the first target channel is the DTV channel, the display apparatus calls a middleware interface to modify a DTV channel database, such as modifying the channel data of the first target channel in the DTV channel database to the favorite channel. If it is determined that the first target channel is the OTT channel, the display apparatus calls a middleware interface to modify an OTT channel database, such as modifying the channel data of the first target channel in the OTT channel database to the favorite channel. The display apparatus updates the display of the UI page according to fusion data updated from the public Store (which may include fusion data where the first target channel is the favorite channel), such as the first channel list, and a target favorite list.

The display apparatus may set the first target channel as the favorite channel according to a process shown in FIG. 41, which may include the following steps.

S4110, in response to a second selection command input based on the first button, whether the first target channel is the favorite channel is determined.

The user moves the focus from the first menu to the first button through the control device 100, and inputs the second selection command based on the OK key or the enter key on the control device 100. The display apparatus recognizes whether the first target channel is the favorite channel in response to the second selection command. The display apparatus may determine whether the first target channel is the favorite channel according to the fusion data in the public Store. For example, the display apparatus acquires channel information of the first target channel from the fusion data in the public Store according to the channel number, the channel name, or the channel ID, etc. of the first target channel. This channel information may include the channel list to which the first target channel belongs. If the channel information of the first target channel may include that the first target channel belongs to the favorite list, then the first target channel is the favorite channel; and if the channel information of the first target channel may include that the first target channel belongs to the non-favorite list, then the first target channel is not the favorite channel.

S4120, a selection box is displayed when it is determined that the first target channel is not the favorite channel.

If the first target channel is not the favorite channel, it indicates that the first target channel may be set as the favorite channel. The display apparatus displays the selection box, and the selection box may include each favorite list. The display apparatus pre-configures at least one favorite list. For example, if four favorite lists are pre-configured, the selection box may include these four favorite lists.

S4130, in response to a third selection command input based on the target favorite list from the user, the first target channel is set as the favorite channel and the first target channel is added to the target favorite list. The target favorite list is the favorite list to which the first target channel is added. The user may move the focus to an option of the target favorite list through the control device 100, and input the third selection command based on the OK key or the enter key on the control device.

The display apparatus sets the first target channel as the favorite channel in response to the third selection command. Correspondingly, the display apparatus displays a first identifier on the first channel in the first channel list, and the first identifier is configured for indicating the favorite channel, such as a hearted-shaped identifier.

The display apparatus further adds the first target channel in the target favorite list in response to the third selection command. The first target channel is simultaneously located on the first channel list and the target favorite list. The first target channel may be located at a beginning or end of the target favorite list.

The display apparatus sets the first target channel as the favorite channel, closes the selection box after adding the first target channel to the target favorite list, and continues to display the program video from the first channel and the first menu. At this time, the user may confirm the successful setting of the favorite channel through the first identifier on the first menu.

If the first target channel is the favorite channel, it indicates that there is no need to set the first target channel as the favorite channel again. The display apparatus may display prompt information, and the prompt information is configured for prompting the user that the first target channel is already the favorite channel and does not need to be added again.

In some other embodiments, if the first target channel is the favorite channel, the display apparatus still displays the selection box. The display apparatus recognizes whether the target favorite list may include the first target channel in response to the third selection command from the user. If the target favorite list does not include the first target channel, the display apparatus adds the first target channel to the target favorite list. If the target favorite list may include the first target channel, the display apparatus displays the prompt information, and the prompt information is configured for prompting the user that the target favorite list already contains the first target channel.

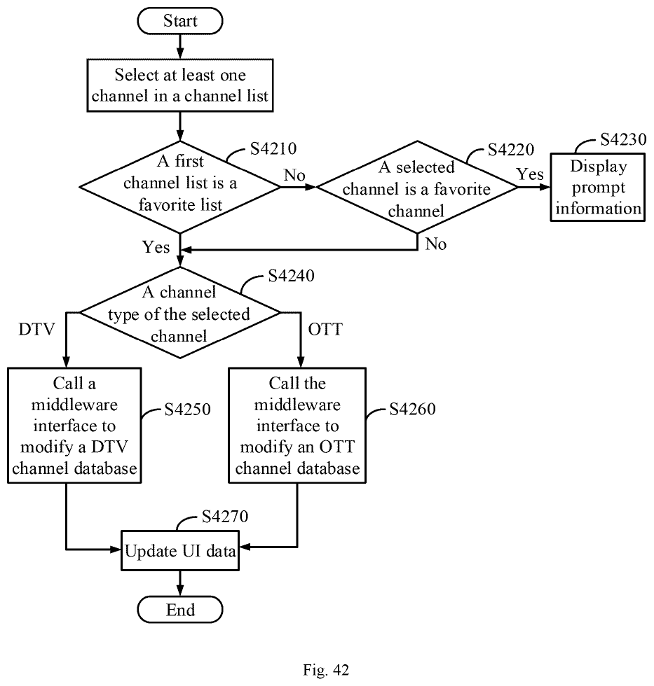

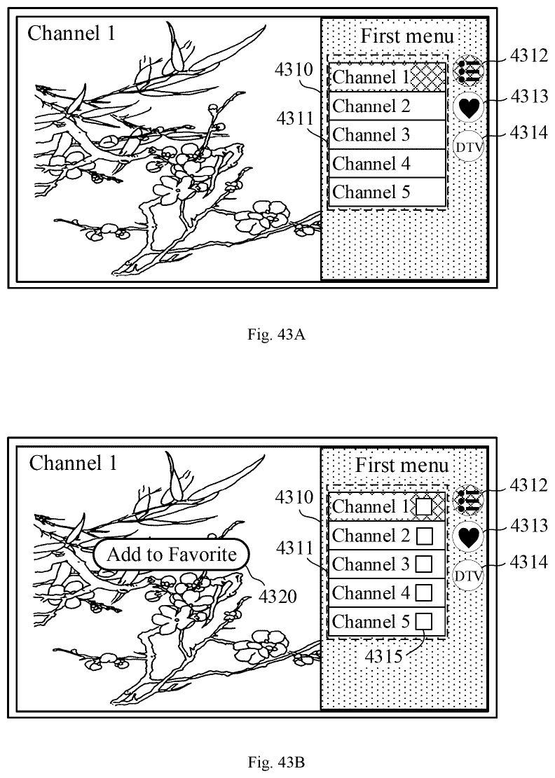

Steps S4010-S4050 are discussed in conjunction with a process shown in FIG. 42.

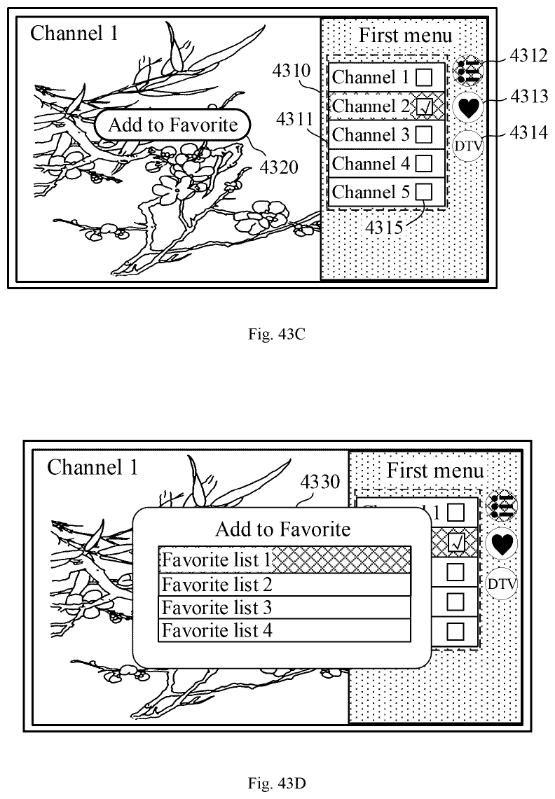

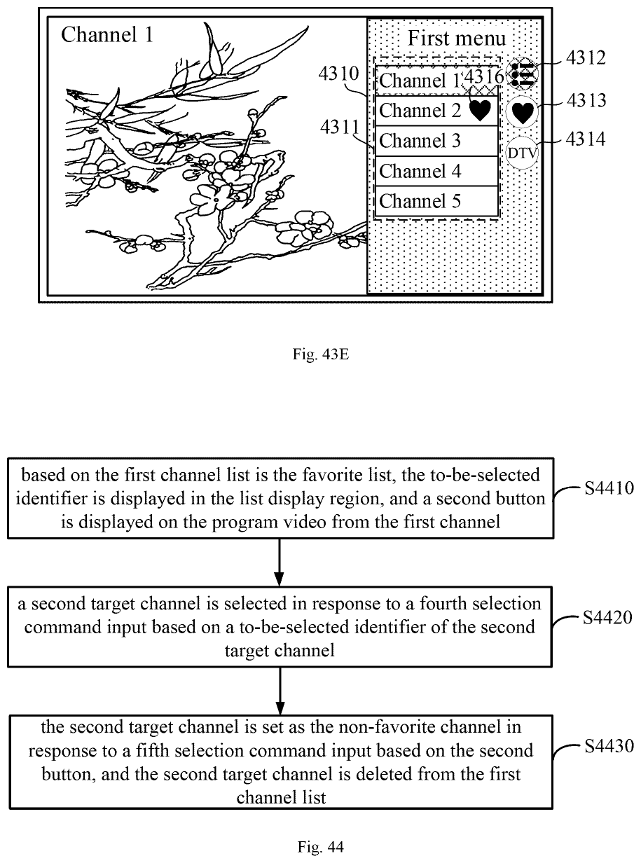

FIG. 43A, FIG. 43B, FIG. 43C, FIG. 43D and FIG. 43E are schematic diagrams of interaction of setting a first target channel as a favorite channel in a television according to some embodiments of the disclosure. Steps S4010-S4050 are discussed by taking an example that the display apparatus is a television and a control device 100 is a remote control. The television displays a program video from a first channel in a first channel list. A user may input a command based on an OK button on the remote control, and the television displays a first menu 4310 on the program video in response to this command, as shown in FIG. 43A. The first menu 4310 may include a list display region 4311, and the list display region 4311 may include the first channel list. Taking an example that the first channel list may include channels 1-10 and the first channel is a channel 1, if the list display region 4311 may display 5 channels, the list display region 4311 may include channels 1-5, wherein a focus (shown in gray) is displayed on the channel 1. The first menu 4310 may further include an entry for each channel list, such as an entry 4312 of a list of all the channels, an entry 4313 of a favorite list, and an entry 4314 of a DTV list. If the first channel list is the list of all the channels, the entry 4312 of the list of all the channels may be highlighted (shown in gray). The user may input a menu command based on a menu key on the remote control, and the television, in response to the menu command, executes step S4210 to determine whether the first channel list is the favorite list. If it is not the favorite list, as shown in FIG. 43B, the television displays a to-be-selected identifier 4315 on the list display region 4311, and displays a first button 4320 on the program video, such as Add to Favorite. The user may move the focus to a first target channel based on direction keys on the remote control, and input a first selection command based on the OK key on the remote control, as shown in FIG. 43C, the television selects a channel 2, and a to-be-selected identifier corresponding to the channel 2 is displayed as a selected status, which may include v for example. The user may move the focus to the first button 4320 based on the direction keys on the remote control, and input a second selection command based on the OK key on the remote control. The television, in response to the second selection command, executes step S4220 to determine whether the channel 2 is a favorite channel. If the channel 2 is the favorite channel, step S4230 is executed to display prompt information. If the channel 2 is not the favorite channel, as shown in FIG. 43D, the television displays a selection box 4330. Taking an example that the favorite list may include favorite lists 1-4, then the selection box 4330 may include the favorite lists 1-4. When displaying the selection box 4330, the television may still display the program video from the first channel for the user to watch. The user may move the focus to the target favorite list based on the direction keys on the remote control, as shown in FIG. 43D, move the focus (shown in gray) to a favorite list 1 and input a third selection command based on the OK key on the remote control. In response to the third selection command, the television sets the channel 2 as the favorite channel and adds the channel 2 to the favorite list 1. The television executes step S4240 to determine a channel type of the channel 2. If the channel 2 is a DTV channel, the television executes step S4250 to call a middleware interface to modify a DTV channel database. If the channel 2 is an OTT channel, the television executes step S4260 to call a middleware interface to modify an OTT channel database. The television further executes step S4270 to update UI data. As shown in FIG. 43E, the television displays a first identifier 4316 on the channel 2 of the list display region 4311, such as a hearted-shaped identifier. If the user selects the favorite List 1, the television displays the favorite list 1 on the list display region 4311, and the favorite list 1 may include the channel 2.

In some embodiments, when the display apparatus displays the first channel list in the first menu, the user may select other non-favorite lists based on the entry of each channel list, and set the channels in other non-favorite lists as favorite channels. The process and steps S4020-S4050, as well as steps S4110-S4130, of setting channels in other non-favorite lists as the favorite channels will not be repeated here.

Based on the above process, the user may quickly set the channel as the favorite channel and add this channel to the target favorite list. Moreover, when the user sets the favorite channel, the impact on the user's watching of the program video is relatively small.

Based on step S4020, if it is determined that the first channel list is the favorite list, the favorite channel in the first channel list may be quickly deleted. The display apparatus may delete the favorite channel according to a process shown in FIG. 44, which may include the following steps.

S4410, based on the first channel list is the favorite list, the to-be-selected identifier is displayed in the list display region, and a second button is displayed on the program video from the first channel.

The display of the to-be-selected identifier can refer to S4030, which will not be repeated here.

The second button is configured for setting the selected channel as the non-favorite channel.

At this time, the display apparatus simultaneously displays the program video from the first channel, the first menu, and the second button. Although the first menu and the second button obstruct the program video from the first channel, the user may still watch the program video from the first channel, which can effectively reduce the impact on the user's watching of the program video from the first channel.

S4420, a second target channel is selected in response to a fourth selection command input based on a to-be-selected identifier of the second target channel.

The second target channel is a channel that the user wants to set as the non-favorite channel in the first channel list, and there may be the plurality of second target channels. Step S4420 can refer to step S4040, which will not be repeated here.

S4430, the second target channel is set as the non-favorite channel in response to a fifth selection command input based on the second button, and the second target channel is deleted from the first channel list.

The display apparatus determines the selected second target channel in response to the fifth selection command, and sets the second target channel as the non-favorite channel. If there are the plurality of second target channels, the display apparatus may set these second target channels as the non-favorite channels once.

When setting the second target channel as the non-favorite channel, the display apparatus modifies channel data of the second target channel in a corresponding database. The display apparatus determines a channel type of the second target channel, such as a DTV channel and an OTT channel. If it is determined that the second target channel is the DTV channel, the display apparatus calls a middleware interface to modify a DTV channel database, such as modifying the channel data of the second target channel in the DTV channel database to the non-favorite channel. If it is determined that the second target channel is the OTT channel, the display apparatus calls a middleware interface to modify an OTT channel database, such as modifying the channel data of the second target channel in the OTT channel database to the non-favorite channel. The display apparatus updates the display of the UI page according to fusion data updated from the public Store (which may include fusion data where the second target channel is the non-favorite channel), such as the first channel list, and the non-favorite list to which the second target channel belongs.

The display apparatus further deletes the second target channel from the first channel list in response to the fifth selection command. Correspondingly, the display apparatus deletes a first identifier on the second target channel from the non-favorite list to which the second target channel belongs.

Steps S4010-S4020 and steps S4410-S4430 are discussed in conjunction with a process shown in FIG. 42.

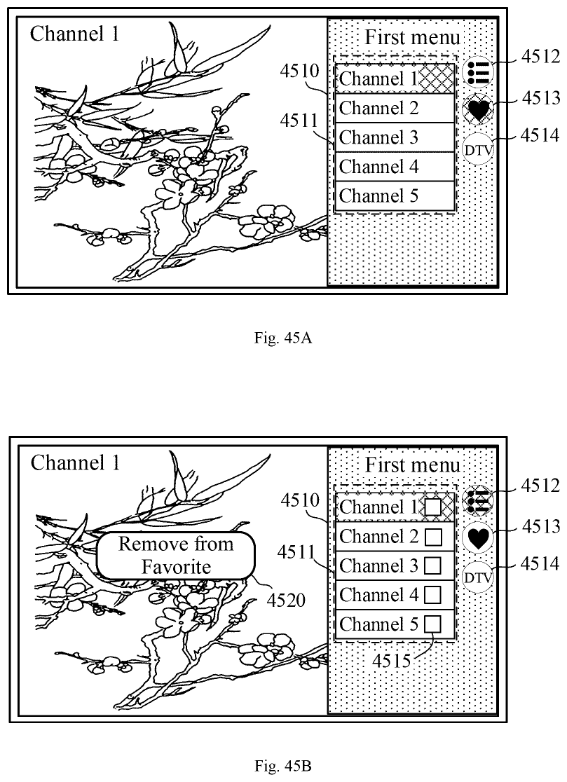

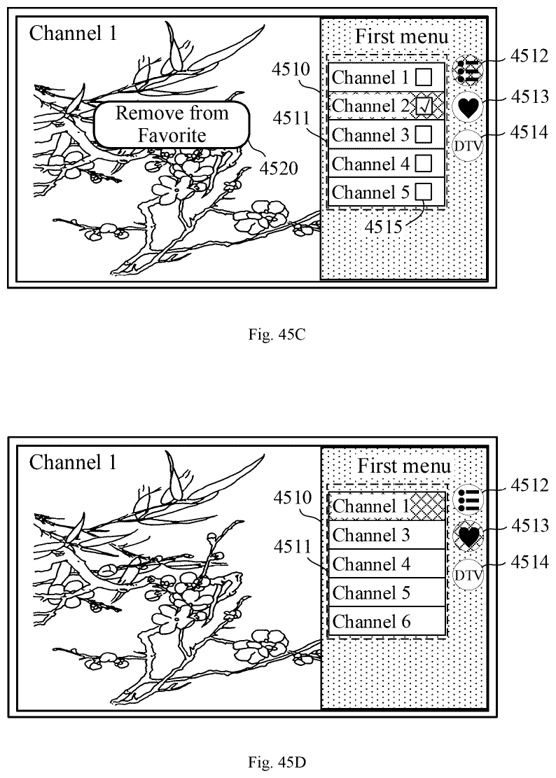

FIG. 45A, FIG. 45B, FIG. 45C and FIG. 45D are schematic diagrams of interaction of setting a second target channel as a non-favorite channel in a television according to some embodiments of the disclosure. Steps S4010-S4020 and steps S4410-S4430 are discussed by taking an example that the display apparatus is a television and a control device 100 is a remote control. The television displays a program video from a first channel in a first channel list. A user may input a command based on an OK button on the remote control, and the television displays a first menu 4510 on the program video in response to this command, as shown in FIG. 45A. The first menu 4510 may include a list display region 4511, and the list display region 4511 may include the first channel list. Taking an example that the first channel list may include channels 1-10 and the first channel is a channel 1, if the list display region 4511 may display 5 channels, the list display region 4511 may include channels 1-5, wherein a focus (shown in gray) is displayed on the channel 1. The first menu 4510 may further include an entry for each channel list, such as an entry 4512 of a list of all the channels, an entry 4513 of a favorite list, and an entry 4514 of a DTV list. If the first channel list is the favorite channel, the entry 4513 of the favorite channel may be highlighted (shown in gray). A first identifier, such as a hearted-shaped identifier, is further displayed on each channel in the list display region 4511. The user may input a menu command based on a menu key on the remote control, and the television, in response to the menu command, executes step S4210 to determine whether the first channel list is the favorite list. If it is the favorite list, as shown in FIG. 45B, the television displays a to-be-selected identifier 4515 on the list display region 4511, and displays a second button 4520 on the program video, such as Remove from Favorite. The user may move the focus to a second target channel based on direction keys on the remote control, and input a fourth selection command based on the OK key on the remote control, as shown in FIG. 45C, the television selects a channel 2, and a to-be-selected identifier corresponding to the channel 2 is displayed as a selected status, which may include V for example. The user may move the focus to the second button 4520 based on the direction keys on the remote control, and input a fifth selection command based on the OK key on the remote control. The television, in response to the fifth selection command, executes step S4240 to determine a channel type of the channel 2. If the channel 2 is a DTV channel, the television executes step S4250 to call a middleware interface to modify a DTV channel database. If the channel 2 is an OTT channel, the television executes step S4260 to call a middleware interface to modify an OTT channel database. The television further executes step S4270 to update UI data. As shown in FIG. 45D, the channels displayed by the television in the list display region 4511 are the channel 1 and the channel 3 to the channel 6, and the channel 2 is no longer displayed.

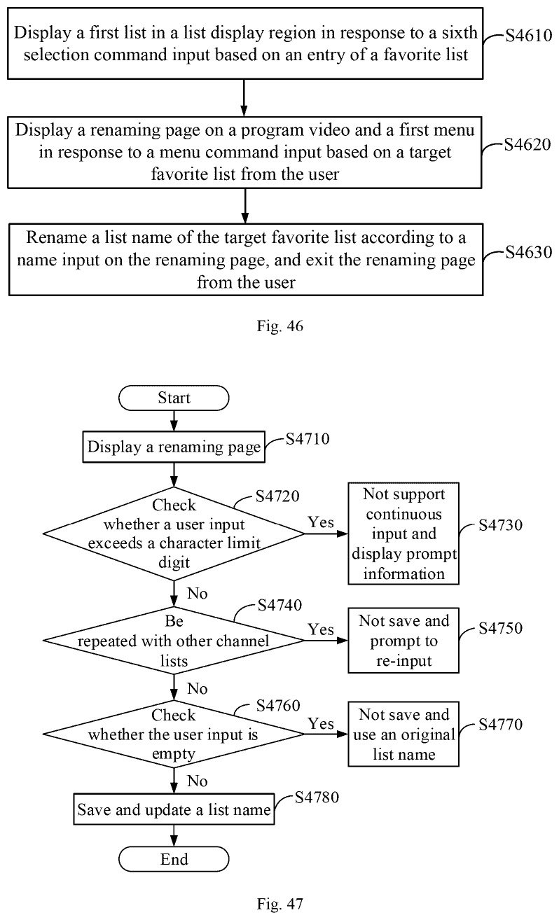

The display apparatus may modify a list name of the favorite list according to a process shown in FIG. 46, which may include the following steps.

S4610, a first list is displayed in the list display region in response to a sixth selection command input based on the entry of the favorite list.

The first list may include all favorite lists. For example, the display apparatus is pre-configured with four favorite lists, such as favorite lists 1-4, and the first list may include the favorite lists 1-4. If the user selects the favorite list, the selected favorite list is displayed in the list display region.

In some embodiments, the display apparatus further displays guidance information on the program video from the first channel in response to the sixth selection command. The guidance information is configured for indicating a manner of renaming the favorite list by the user, such as pressing a menu key on the remote control to rename the favorite list.

In some embodiments, the display apparatus displays the guidance information when displaying the first list for the first time in response to the sixth selection command. The displaying the first list for the first time is displaying the first list for the first time after the display apparatus leaves the factory, or displaying the first list for the first time after the display apparatus is restored to its factory settings. This can avoid frequent display of the guidance information and interference with the user.

S4620, a renaming page is displayed on the program video and the first menu in response to a menu command input based on the target favorite list from the user.

The target favorite list is a favorite list that the user wants to rename. The user may position the target favorite list by moving the focus to the target favorite list through the control device 100. The user may input the menu command through the menu key on the control device 100. When displaying the first menu, the display apparatus determines that the menu command indicates renaming the list name of the favorite list in response to the menu command. The display apparatus displays the renaming page on the program video and the first menu, and the renaming page is configured for inputting the list name of the target favorite list.

The renaming page may be in a semi-transparent status, and in this way, the user may watch the program video from the first channel through the renaming page.

The renaming page may include a text input box and a soft keyboard, and the user inputs the list name of the target favorite list in the text input box based on the soft keyboard through the control device 100.

In some embodiments, the display apparatus sets a character limit digit for the text input box. If it is detected that the quantity of characters input from the user exceeds the character limit digit, inputting of characters that exceed the limit is stopped, and a pop-up window is displayed to prompt the user of exceeding the character limit digit.

S4630, the list name of the target favorite list is renamed according to the name input on the renaming page from the user, and the renaming page is exited.

After completing the input of the list name, the user may input a confirmation command by selecting a return key on the soft keyboard. In response to the confirmation command, the display apparatus renames the list name of the target favorite list according to the list name in the text input box.

In some embodiments, the display apparatus detects whether the list name in the text input box is repeated with list names of other channel lists in response to the confirmation command. If the list name in the text input box is repeated with the list names of other channel lists, the list name of the target favorite list is not modified, and a pop-up window is displayed to prompt the user to re-input the list name. If the list name in the text input box is not repeated with the list names of other channel lists, the list name of the target favorite list is renamed according to the list name in the text input box.

In some embodiments, the display apparatus detects whether the text input box is empty in response to the confirmation command. If the text input box is empty, the display apparatus keeps an original list name of the target favorite list. If the text input box is not empty, the display apparatus renames the list name of the target favorite list according to the list name in the text input box.

Steps S4610-S4630 are discussed in conjunction with a process shown in FIG. 47.

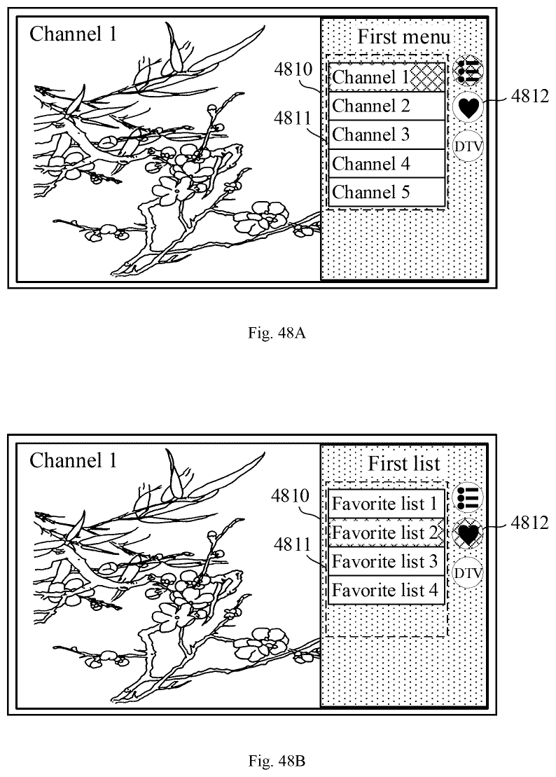

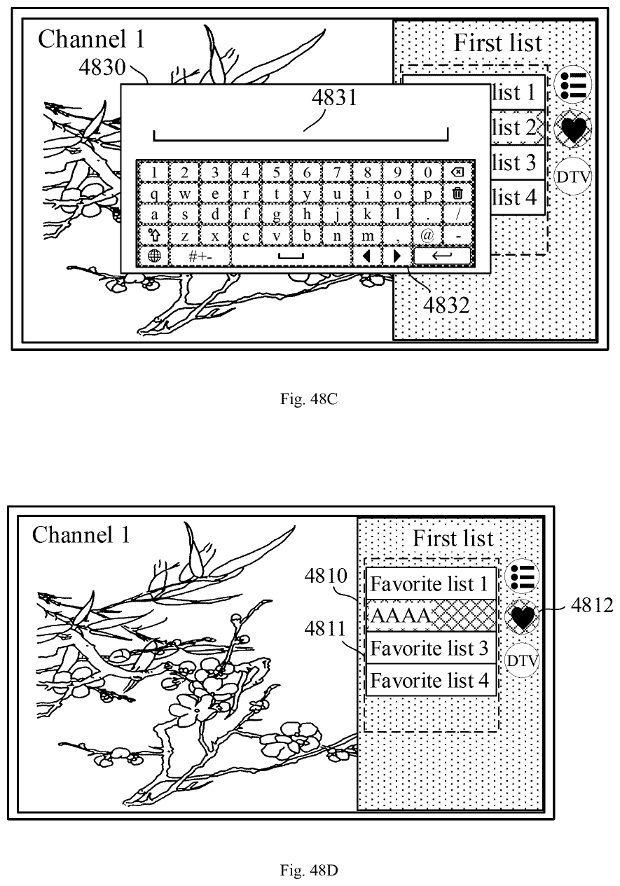

FIG. 48A, FIG. 48B, FIG. 48C and FIG. 48D are schematic diagrams of interaction of renaming a list name of a target favorite list in a television according to some embodiments of the disclosure. Steps S4610-S4630 are discussed by taking an example that the display apparatus is a television and a control device 100 is a remote control. As shown in FIG. 48A, the television displays a first menu 4810 on a program video, and the first menu 4810 may include a list display region 4811 and an entry 4812 of a favorite list. A user may input a sixth selection command based on the entry 4812 of the favorite list, and the television displays a first list in the list display region 4811 in response to the sixth selection command, as shown in FIG. 48B. Taking an example that the first list may include favorite lists 1-4, the favorite lists 1-4 are displayed in the list display region 4811. The user may move the focus to a target favorite list through the remote control, as shown in FIG. 48B, and move the focus (shown in gray) to a favorite list 2. The user may input a menu command based on a menu key on the remote control, and the television, in response to the menu command, executes step S4710, as shown in FIG. 48C, to display a renaming page 4830 on a program video from the first channel and the first menu 4810. The renaming page 4830 is in a semi-transparent status and may include a text input box 4831 and a soft keyboard 4832. The user may select keys on the soft keyboard 4832 through the remote control and input the list name in the text input box 4831, such as “AAAA”. The television executes step S4720 to check whether the user input exceeds the character limit digit, such as 18 digits. If yes, step S4730 is executed to not support continuous input, and prompt the user that the list name is up to 18 digits. The user inputs the confirmation command by selecting the enter key on the soft keyboard 4832 through the remote control. In response to the confirmation command, the television executes step S4740 to check whether the name input from the user is repeated with other channel lists. If yes, step S4750 is executed to not save the name and prompt the user to re-input a name. If not, step S4760 is executed to check whether the user input is empty. If it is empty, step S4770 is executed to not save the name, and the favorite list 2 remains an original list name. If it is not empty, step S4780 is executed to save “AAAA”, rename the list name of the favorite list 2 by using “AAAA”, and exit the renaming page 4830. As shown in FIG. 48D, the name of the favorite list 2 in the list display region 4811 is modified into “AAAA”.

The display apparatus may further modify a display manner of channels in the list display region, such as adding shortcuts on the home interface.

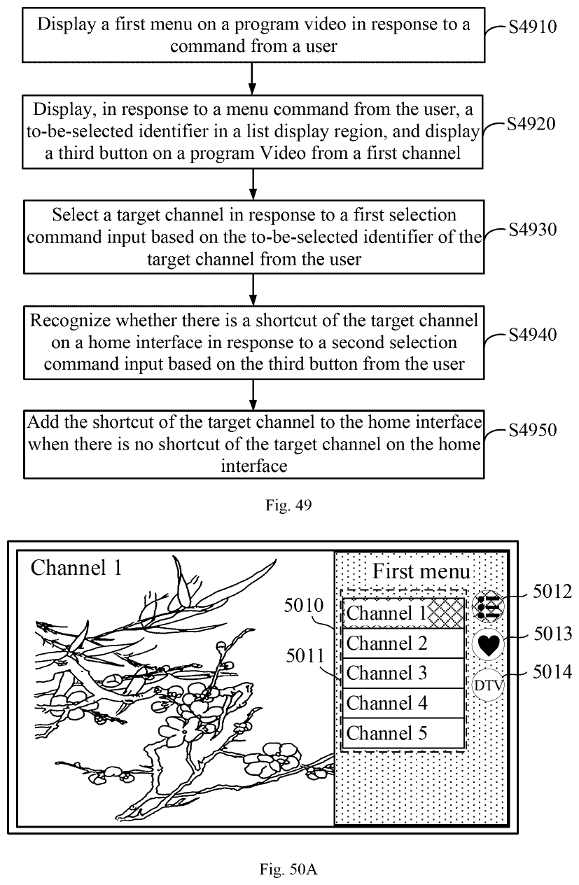

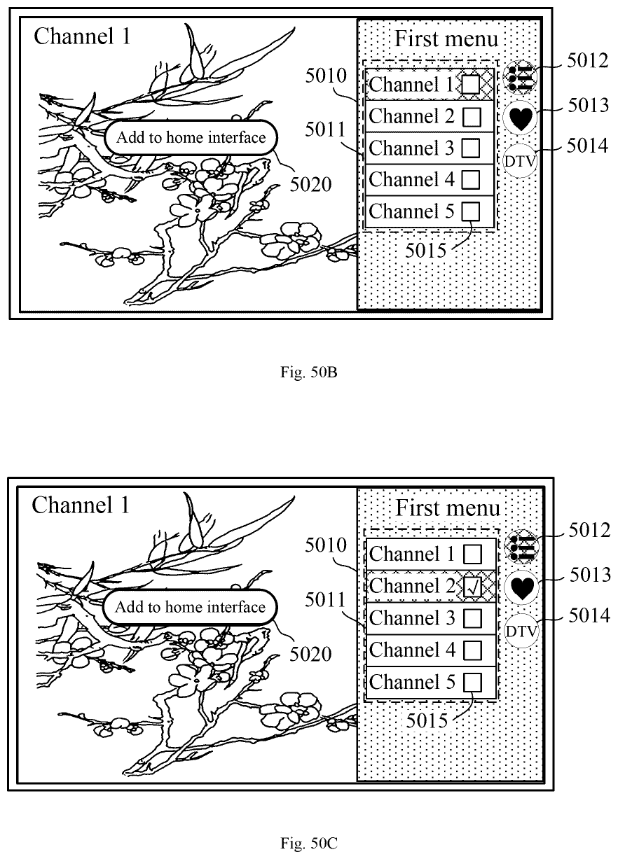

The display apparatus may add the shortcuts of channels on the home interface according to a process shown in FIG. 49, which may include the following steps.

S4910, the first menu is displayed on the program video in response to a command from the user.

The first menu may include the list display region, and the list display region may include the first channel list. Step S4910 can refer to step S4010, which will not be repeated here.

S4920, in response to a menu command from the user, the to-be-selected identifier is displayed in the list display region, and a third button is displayed on the program video from the first channel.

The to-be-selected identifier is displayed corresponding to each channel in the first channel list. The display of the to-be-selected identifier may can refer to S4030, which will not be repeated here.

The third button is configured for adding a shortcut of the selected channel to the home interface.

At this time, the display apparatus simultaneously displays the program video from the first channel, the first menu, and the third button. Although the first menu and the third button obstruct the program video from the first channel, the user may still watch the program video from the first channel, which can effectively reduce the impact on the user's watching of the program video from the first channel.

S4930, a target channel is selected in response to a first selection command input based on a to-be-selected identifier of the target channel from the user.

The target channel is a channel for which the user wants to add the shortcut to the home interface in the first channel list, and there may be the plurality of third target channels. Step S4930 can refer to step S4040, which will not be repeated here.

S4940, whether there is a shortcut of the target channel on the home interface is determined in response to a second selection command input based on the third button from the user.

The display apparatus determines whether there is the shortcut of the target channel on the home interface in response to the second selection command. The display apparatus may determine whether there is the shortcut of the target channel according to the fusion data in the public Store. For example, the display apparatus acquires channel information of the target channel from the fusion data in the public Store according to a channel number, a channel name, or a channel ID of the target channel. This channel information may include whether there is the shortcut of the target channel. If the channel information of the target channel may include that there is the shortcut, then the home interface has the shortcut of the target channel. If the channel information of the target channel may include that there is no shortcut, then the home interface does not have the shortcut of the target channel.

S4950, the shortcut of the target channel is added to the home interface when there is no shortcut of the target channel on the home interface.

If there is no shortcut of the target channel on the home interface, it indicates that the shortcut of the target channel may be added to the home interface.

Steps S4910-S4950 are discussed in conjunction with examples below.

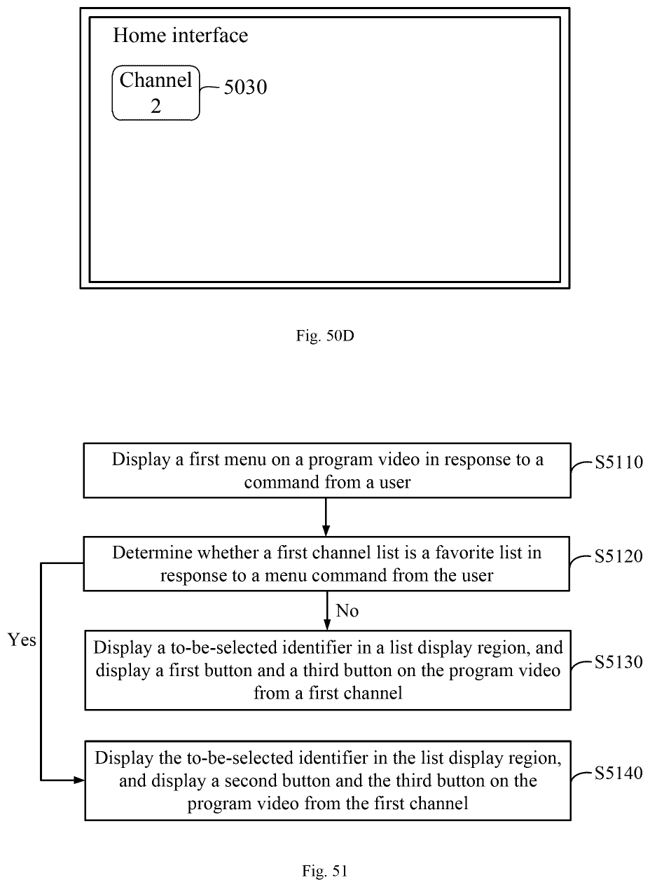

FIG. 50A, FIG. 50B, FIG. 50C and FIG. 50D are schematic diagrams of interaction of renaming a list name of a target favorite list in a television according to some embodiments of the disclosure. Steps S4910-S4950 are discussed by taking an example that the display apparatus is a television and a control device 100 is a remote control. The television displays a program video from a first channel in a first channel list. A user may input a command based on an OK button on the remote control, and the television displays a first menu 5010 on the program video in response to this command, as shown in FIG. 50A. The first menu 5010 may include a list display region 5011, and the list display region 5011 may include the first channel list. Taking an example that the first channel list may include channels 1-10 and the first channel is a channel 1, if the list display region 5011 may display 5 channels, the list display region 5011 may include channels 1-5, wherein a focus (shown in gray) is displayed on the channel 1. The first menu 5010 may further include an entry for each channel list, such as an entry 5012 of a list of all the channels, an entry 5013 of a favorite list, and an entry 5014 of a DTV list. The user may input a menu command based on a menu key on the remote control, and in response to the menu command, as shown in FIG. 50B, the television displays a to-be-selected identifier 5015 on the list display region 5011, and displays a third button 5020 on the program video, such as Add to home interface. The user may move the focus to a target channel based on direction keys on the remote control, and input a first selection command based on the OK key on the remote control, as shown in FIG. 50C, the television selects a channel 2, and a to-be-selected identifier corresponding to the channel 2 is displayed as a selected status, which may include V for example. The user may move the focus to the third button 5020 based on the direction keys on the remote control, and input a second selection command based on the OK key on the remote control. The television recognizes whether there is a shortcut of a channel 2 on the home interface in response to the second selection command. If there is no shortcut of the channel 2 on the home interface, the shortcut of the channel 2 is added to the home interface, and the channel 2 still exists in the first channel list. If the user indicates to display the home interface, as shown in FIG. 50D, the home interface may include the shortcut 5030 of the channel 2. When the user selects the shortcut 5030, the television may quickly play programs of the channel 2.

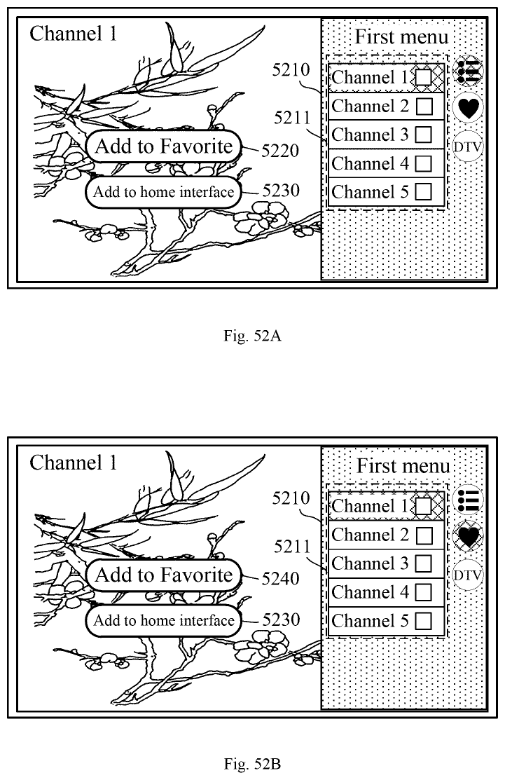

In some embodiments, the display apparatus may simultaneously provide an entry for modifying a channel list to which a channel in a list display region belongs and modifying a display manner of the channel. The display apparatus may display the entry for modifying the channel list to which the channel in the list display region belongs and modifying the display manner of the channel according to a process shown in FIG. 51, which may include the following steps.

S5110, the first menu is displayed on the program video in response to a command from the user.

The first menu may include the list display region, and the list display region may include the first channel list.

S5120, whether the first channel list is the favorite list is determined in response to a menu command from the user.

S5130, if the first channel list is not the favorite list, the to-be-selected identifier is displayed in the list display region, and a first button and a third button are displayed on the program video from the first channel.

The to-be-selected identifier is displayed corresponding to each channel in the first channel list. The first button is configured for setting the selected channel as the favorite channel, and the third button is configured for adding the shortcut of the selected channel to the home interface.

FIGS. 52A and 52B are schematic diagrams of interaction of simultaneously providing an entry for modifying a channel list to which a channel in a list display region belongs and modifying a display manner of the channel in a display apparatus according to some embodiments of the disclosure.

As shown in FIG. 52A, a first menu 5210 is displayed when playing a program video from a first channel. The first menu 5210 may include a list display region 5211, and the list display region 5211 may include channels 1-5 in a first channel list, and the first channel list is a non-favorite list. The display apparatus displays the first button 5220 (such as Add to Favorite) and the third button 5230 (such as Add to home interface) in response to a command.

S5140, if the first channel list is a favorite list, a to-be-selected identifier is displayed in the list display region, and a second button and the third button are displayed on the program video from the first channel.

The second button is configured for setting the selected channel as the non-favorite channel.

As shown in FIG. 52B, a first menu 5210 is displayed when playing the program video from the first channel. The first menu 5210 may include the list display region 5211, and the list display region 5211 may include channels 1-5 in the first channel list, and the first channel list is the favorite list. The display apparatus displays the second button 5240 (such as remove from Favorite) and the third button 5230 in response to the command.

The process that the display apparatus displays the first button in response to the menu command may can refer to steps S4010-S4030, the process that the display apparatus displays the second button in response to the menu command may can refer to step S4410, and the process that the display apparatus displays the third button in response to the menu command may can refer to step S4920, which will not be repeated here.

The process that the display apparatus displays the first button, the second button, and the third button in response to selection commands input from the user based on the different buttons may can refer to steps S4040-S4050, S4110-S4130, S4420-S4430, and S4930-S4950, which will not be repeated here.

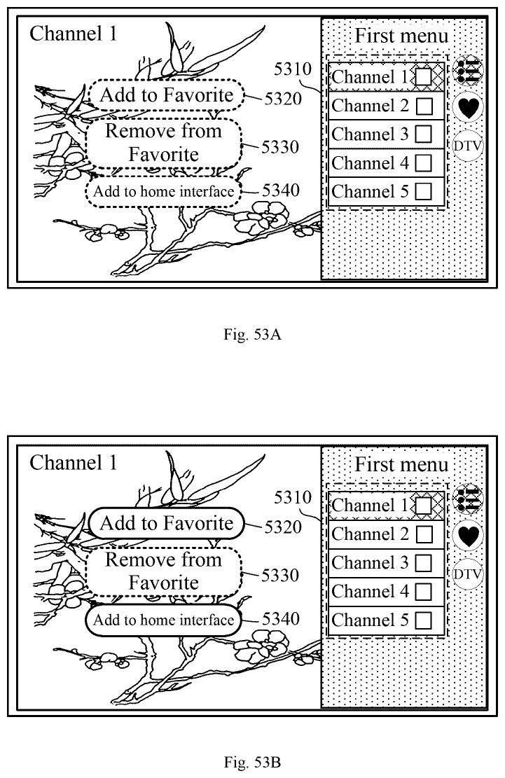

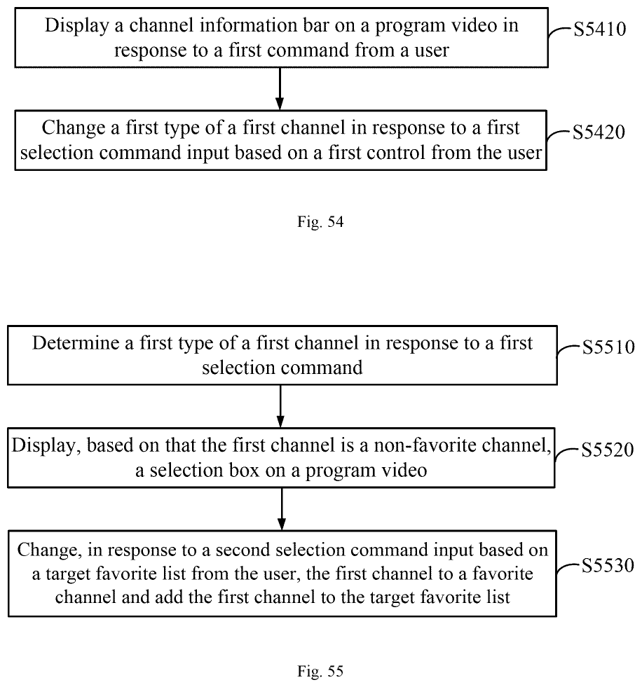

In some embodiments, the display apparatus further displays the first button, the second button, and/or the third button when displaying the first menu. The first button, the second button, and the third button are each in a hidden status. After the display apparatus determines a button required for subsequent operations in response to the menu command, the button is adjusted from the hidden status to a displayed status. FIGS. 53A and 53B are schematic diagrams of interaction of adjusting a status of a button in a display apparatus according to some embodiments of the disclosure. As shown in FIG. 53A, when displaying a first menu 5310, the display apparatus displays a first button 5320, a second button 5330, and a third button 5340. The first button 5320, the second button 5330, and the third button 5340 are each in a hidden status (shown by a dashed box). As shown in FIG. 53B, if the display apparatus determines that buttons required for subsequent operations are the first button 5320 and the third button 5340 in response to the menu command, the first button 5320 and the third button 5340 are adjusted to a displayed status (shown by a solid box).

Based on a system architecture shown in FIG. 6, the display apparatus may modify a first type of a channel according to a process shown in FIG. 54, which may include the following steps.

S5410, a channel information bar is displayed on the program video in response to a first command from a user.

The display of the channel information bar only blocks fewer program videos, so the user can still watch the program video when displaying the channel information bar.

The channel information bar may include a first display region, a second display region, and a first control.

The first display region is configured for displaying channel information of a channel in the channel list, and the second display region is configured for displaying program information corresponding to the channel information in the first display region.

When the display apparatus displays the channel information bar in response to the first command, the first display region first displays channel information of a currently played channel, namely, the channel information of the first channel, and the second display region first displays program information corresponding to the currently played channel, namely, program information corresponding to a first channel.

The first control is configured for changing a first type of the channel corresponding to the channel information in the first display region. When the first display region of the channel information bar may include the channel information of the first channel, the first control is configured for changing the first type of the first channel.

In some embodiments, the first control has different display statuses, which may include a highlighted status and a non-highlighted status (a normal status). A display status of the first control corresponds to the first type of the channel corresponding to the channel information in the first display region. If the channel is a favorite channel, the display status of the first control is the highlighted status. If the channel is a non-favorite channel, the display status of the first control is not the highlighted status. In this way, the user may quickly determine the first type of the channel corresponding to the channel information in the first display region through the display status of the first control.

S5420, the first type of the first channel is changed in response to a first selection command input based on the first control from the user.

If the first channel is the favorite channel, the first channel is changed into the non-favorite channel. If the first channel is the non-favorite channel, the first channel is changed into the favorite channel.

When changing the first type of the first channel, the display apparatus modifies channel data of the first channel in a corresponding database. The display apparatus determines a channel type of the first channel, such as a DTV channel and an OTT channel. If it is determined that the first channel is the DTV channel, the display apparatus calls a middleware interface to modify a DTV channel database, such as modifying the channel data of the first channel in the DTV channel database to the changed first type. If it is determined that the first channel is the OTT channel, the display apparatus calls a middleware interface to modify an OTT channel database, such as modifying the channel data of the first channel in the OTT channel database to the changed first type. The display apparatus updates the display of a UI page according to fusion data updated from a public Store (which may include fusion data of the first type after the first channel is changed), such as a channel information bar.

In some embodiments, after changing the first channel to the non-favorite channel, the display status of the first control is changed from the highlighted status to the non-highlighted status. After changing the first channel to the favorite channel, the display status of the first control is changed from the non-highlighted status to the highlighted status.

In this way, the user may easily and quickly change the first type of the first channel based on the first control in the channel information bar, and the impact on watching the program video during a changing operation is relatively small.

The display apparatus may change the first channel to the favorite channel according to a process shown in FIG. 55, which may include the following steps.

S5510, the first type of the first channel is determined in response to a first selection command.

The user moves a focus to the first control through the control device 100, and inputs the first selection command based on an OK key or an enter key on the control device 100. The display apparatus recognizes the first type of the first channel in response to the first selection command. The display apparatus may determine the first type of the first channel according to the fusion data in the public Store. For example, the display apparatus acquires channel information of the first channel from the fusion data in the public Store according to a channel number, a channel name, or a channel ID of the first channel. This channel information may include a channel list to which the first channel belongs. If the channel information of the first channel may include that the first channel belongs to the favorite list, then the first channel is a favorite channel; and if the channel information of the first channel may include that the first channel belongs to the non-favorite list, then the first channel is a non-favorite channel.

S5520, based on that the first channel is a non-favorite channel, a selection box is displayed on the program video.

If the first channel is the non-favorite channel, it indicates that the first channel may be set as the favorite channel. The display apparatus displays the selection box, and the selection box may include each favorite list. The display apparatus pre-configures the at least one favorite list. If four favorite lists are pre-configured, the selection box may include these four favorite lists.

S5530, in response to a second selection command input based on a target favorite list from the user, the first channel is changed to the favorite channel and the first channel is added to the target favorite list.

The target favorite list is the favorite list to which the first channel is added. The user may move the focus to an option of the target favorite list through the control device 100, and input the second selection command based on the OK key or the enter key on the control device 100.

The display apparatus changes the first type of the first channel to the favorite channel in response to the second selection command. Correspondingly, the display apparatus changes the first control to the highlighted status. In this way, the user may determine whether to successfully change the first type of the first channel to the favorite channel according to changes in the display status of the first control.

The display apparatus further adds the first channel in the target favorite channel in response to the second selection command. The first channel is simultaneously located on a first channel list and the target favorite list. The first channel may be located at a beginning or end of the target favorite list.

The display apparatus sets the first channel as the favorite channel, closes the selection box after adding the first channel to the target favorite list, and continues to display the program video from the first channel and the first menu.

If the first channel is the favorite channel, the display apparatus sets the first channel as the non-favorite channel and removes the first channel from the favorite list to which the first channel belongs. The display apparatus changes the first control to the non-highlighted status. In this way, the user may determine whether to successfully change the first type of the first channel to the non-favorite channel according to the changes in the display status of the first control.

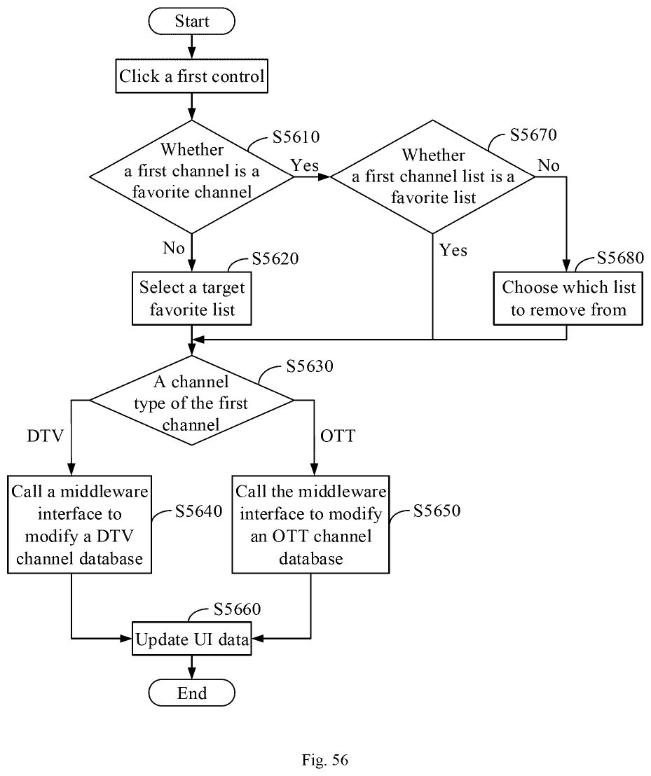

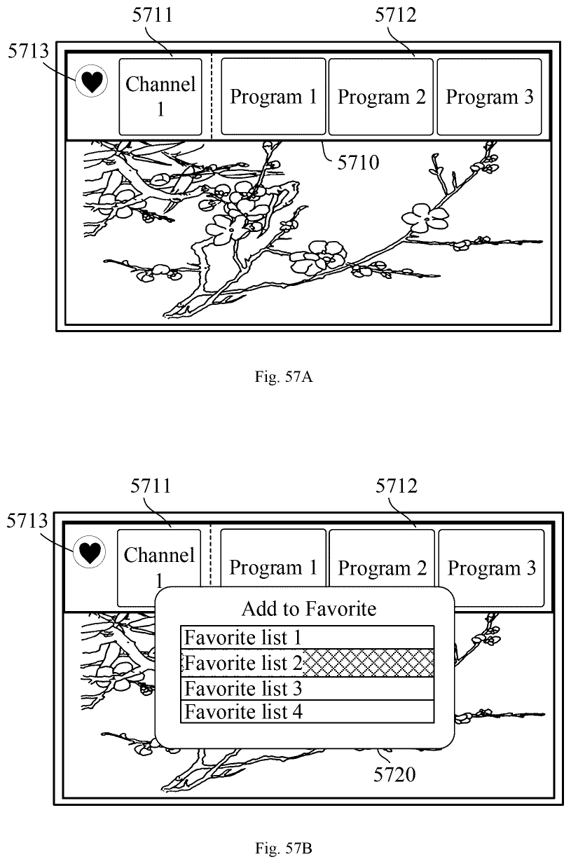

Steps S5410-S5420 are discussed in conjunction with a process shown in FIG. 56.

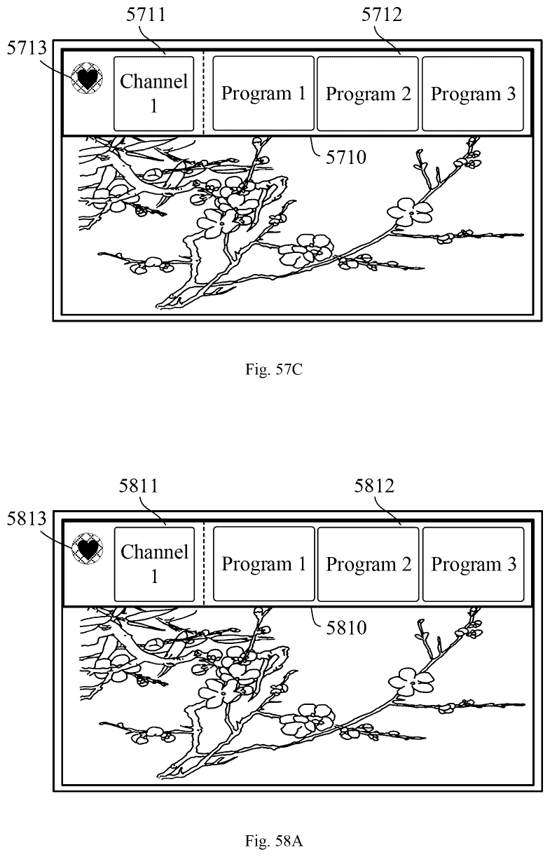

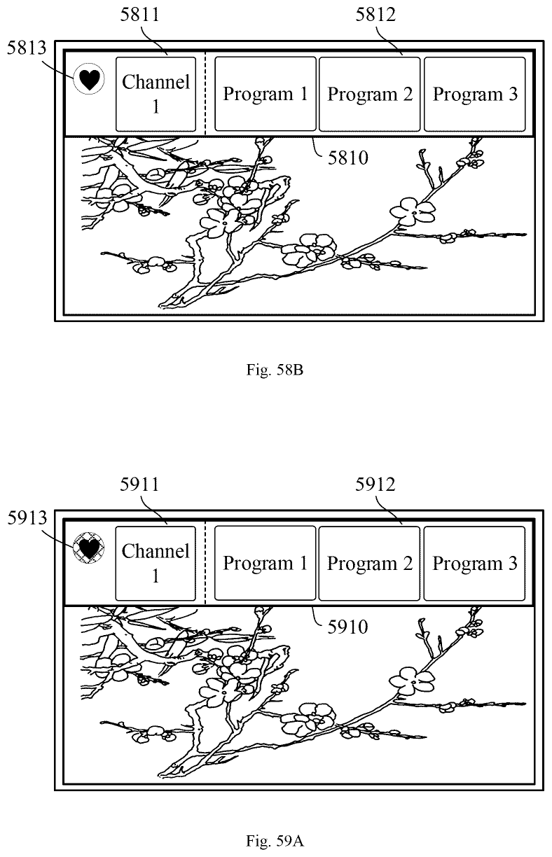

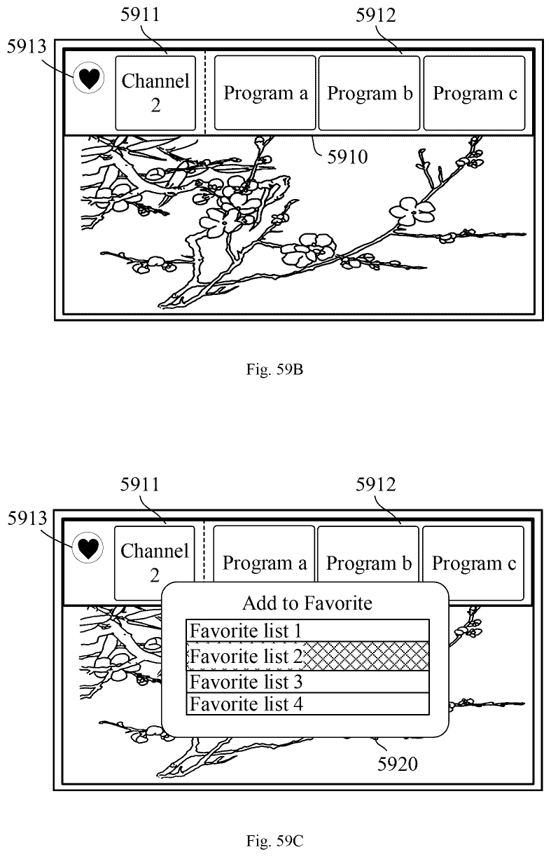

FIG. 57A, FIG. 57B and FIG. 57C are first schematic diagrams of interaction of modifying a first type of a first channel in a television according to some embodiments of the disclosure. Steps S5410-S5420 are discussed by taking an example that the display apparatus is a television and a control device 100 is a remote control. The television displays a program video from the first channel in a first channel list. A user may input a first command based on an up key on the remote control, and the television displays a channel information bar 5710 on the program video in response to this command, as shown in FIG. 57A. The channel information bar 5710 may include a first display region 5711 and a second display region 5712, and the first display region 5711 may include channel information of the first channel, such as a channel 1. The second display region 5712 may include program information of the first channel, such as program information of a program 1, a program 2, and a program 3. The channel information bar 5710 may further include a first control 5713. Taking an example that the first channel is a non-favorite channel, the first control 5713 is not in a highlighted status. The user may move a focus to the first control 5713 based on direction keys on the remote control, and input a first selection command based on an OK key on the remote control. The television, in response to the first selection command, executes step S5610 to determine whether the first channel is a favorite channel, that is, to recognize a first type of the first channel. In this example, if the television may determine that the first channel is not the favorite channel, the television executes step S5620 to display a selection box 5720, as shown in FIG. 57B. Taking an example that the television pre-configures favorite lists 1-4, the selection box 5720 may include the favorite lists 1-4. The user may move the focus to a target favorite list, such as a favorite list 2, based on the direction keys on the remote control, and input a second selection command based on the OK key on the remote control. The television, in response to the second selection command, executes step S5630 to determine a channel type of the first channel. If the first channel is a DTV channel, the television executes step S5640 to call a middleware interface to modify a DTV channel database. If the first channel is an OTT channel, the television executes step S5650 to call a middleware interface to modify an OTT channel database. The modified data is to change the first channel to the favorite channel and add it to a favorite channel 2. The television further executes step S5660 to update UI data. As shown in FIG. 57C, the television changes the first control 5713 to highlighted display (shown in gray).

FIGS. 58A and 58B are second schematic diagrams of interaction of modifying a first type of a first channel in a television according to some embodiments of the disclosure. Steps S5410-S5420 are discussed by taking an example that the display apparatus is a television and a control device 100 is a remote control. The television displays a program video from the first channel in a first channel list. A user may input a first command based on an up key on the remote control, and the television displays a channel information bar 5810 on the program video in response to this command, as shown in FIG. 58A. The channel information bar 5810 may include a first display region 5811 and a second display region 5812, and the first display region 5811 may include channel information of the first channel, such as a channel 1. The second display region 5812 may include program information of the first channel, such as program information of a program 1, a program 2, and a program 3. The channel information bar 5810 may further include a first control 5813. Taking an example that the first channel is a favorite channel, the first control 5813 is in a highlighted status (shown in gray). The user may move a focus to the first control 5813 based on direction keys on the remote control, and input a first selection command based on an OK key on the remote control. The television, in response to the first selection command, executes step S5610 to determine whether the first channel is a favorite channel, that is, to recognize the first type of the first channel. In this example, if the television may determine that the first channel is the favorite channel, the television executes step S5670 to determine whether the first channel list is a favorite list. If it is the favorite list, it is determined to remove the first channel from the first channel list. If it is not the favorite list, step S5680 is executed to select to remove the first channel from the favorite list to which the first channel belongs. After determining to remove the channel list of the first channel, the television executes steps S5630-S5660, and as shown in FIG. 58B, changes the first control 5813 to be not highlighted.

If the user wants to change first types of other channels, the display apparatus needs to first switch the channel information in the channel information bar, and then change the first type of the corresponding channel based on the channel information in the channel information bar.

In some embodiments, taking an example that the user wants to change a first type of a second channel, if the first channel list may include the second channel, the user may directly input a switching command through up and down keys on the control device 100, and the display apparatus switches channel information displayed in the first display region in response to the switching command. The display apparatus switches channel information displayed in the first display region according to the first channel list. For example, in the first channel list, the second channel is a channel following the first channel, the user inputs the switching command through the down key on the control device 100, and the display apparatus displays channel information of the second channel in the first display region in response to the switching command. However, the display apparatus does not switch to playing a program video from the second channel, but still plays the program video from the first channel. After switching the channel information in the first display region, correspondingly, program information corresponding to the switched channel information is displayed in a second display region. The first control is also changed to a display status corresponding to the first type of the second channel. In this way, the user may browse the program information of each channel in the current channel list through the channel information bar, and quickly determine the first type of the corresponding channel through the display status of the first control.

After switching to display the channel information of the second channel in the first display region, the user may change the first type of the second channel based on the first control. This process is similar to step S5420 and will not be repeated here.

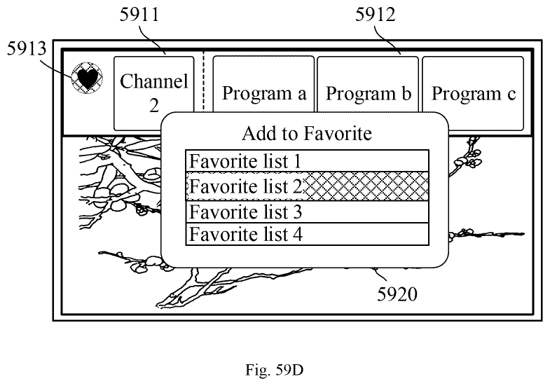

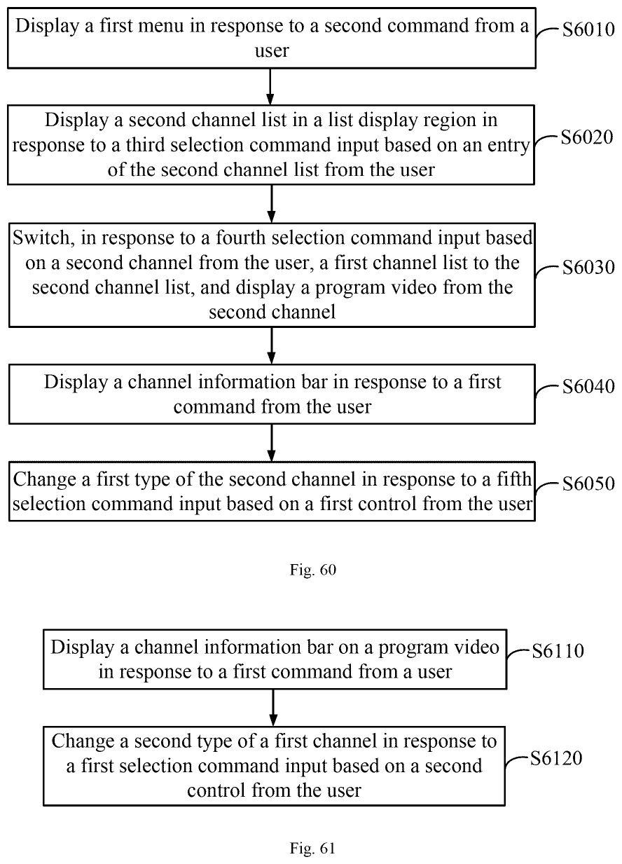

FIG. 59A, FIG. 59B, FIG. 59C and FIG. 59D are schematic diagrams of interaction of modifying a first type of a second channel in a television according to some embodiments of the disclosure. Taking an example that a display apparatus is a television and a control device 100 is a remote control, as shown in FIG. 59A, when the television plays a program video from the first channel, a channel information bar 5910 is displayed. The channel information bar 5910 may include a first display region 5911 and a second display region 5912, the first display region 5911 may include channel information of the first channel, such as a channel 1, and the second display region 5912 may include program information of the first channel, such as a program 1, a program 2, and a program 3. If the first channel is a favorite channel, a first control 5913 is highlighted (shown in gray). If the second channel is a channel following the first channel in a first channel list, the television, in response to a switching command input from a user based on a down key on the remote control, as shown in FIG. 59B, displays channel information of the second channel in the first display region 5911, such as a channel 2, and displays program information of the second channel in the second display region 5912, such as a program a, a program b, and a program c. If the second channel is a non-favorite channel, the first control 5913 is not highlighted. At this time, the television still displays the program video from the first channel. The user may move a focus to the first control 5913 through the remote control and select the first control 5913. As shown in FIG. 59C, the television displays a selection box 5920 on the program video from the first channel. Taking an example that the television pre-configures favorite channels 1-4, the selection box 5920 may include the favorite channels 1-4. The user may move the focus to a target favorite list, such as a favorite list 2, through the remote control, and select the favorite list 2 through the remote control. The television changes the second channel to the favorite channel, exits the selection box 5920, changes the first control 5913 to be highlighted (shown in gray), and adds the second channel to the favorite list 2.

In other embodiments, taking an example that the user wants to change the first type of the second channel, the user may first switch the first channel list to a channel list to which the second channel belongs, and then switch to playing the second channel. The display apparatus may change the first type of the switched second channel according to a process shown in FIG. 60, which may include the following steps. S6010, a first menu is displayed in response to a second command from the user.

When the display apparatus plays the program video from the first channel, the user may input the second command through an OK key or an enter key on the control device 100, and the display apparatus displays the first menu in response to the second command.

The first menu may include a list display region and an entry of each channel list, wherein the list display region is configured for displaying the selected channel list, and the entry of each channel list is configured for switching the channel lists. Each channel list may include a favorite list, a user-defined channel list, and a non-favorite list pre-configured by the display apparatus, such as a DTV list.

S6020, a second channel list is displayed in the list display region in response to a third selection command input based on an entry of the second channel list from the user.

The second channel list may include the second channel, and the second channel is a channel that the user wants to watch or modify its first type. The user may move a focus to the entry of the second channel list through direction keys on the control device 100, and input the third selection command based on an OK key or an enter key on the control device 100. The display apparatus selects the second channel list in response to the third selection command, and displays the second channel list in the list display region.

S6030, in response to a fourth selection command input based on the second channel from the user, the first channel list is switched to the second channel list, and a program video from the second channel is displayed.

The user may adjust channels displayed in the list display region in the second channel list based on up and down keys on the control device 100, so that the second channel is displayed in the list display region. The user may move the focus to the second channel through the direction keys on the control device 100, and input the fourth selection command based on the OK key or the enter key on the control device 100. The display apparatus, in response to the fourth selection command, determines to switch the first channel list to the second channel list, and starts playing the program video from the second channel, that is, the first channel is switched to the second channel.

S6040, a channel information bar is displayed in response to a first command from the user.

Step S6040 is similar to step S5410 and will not be repeated here. At this time, the first display region may include channel information of the second channel, and the second display region may include program information corresponding to the second channel.

S6050, the first type of the second channel is changed in response to a fifth selection command input based on the first control from the user.

Step S6050 is similar to step S5420 and will not be repeated here.

In some embodiments, the display apparatus may change a second type of the channel, and the second type of the channel may include that a shortcut is set on the home interface and that no shortcut is set on the home interface. The display apparatus may change a second type of the first channel according to a process shown in FIG. 61, which may include the following steps.

S6110, the channel information bar is displayed on the program video in response to a first command from the user.

The channel information bar may include the first display region, the second display region, and a second control. The first display region may include channel information of the first channel, the second display region may include program information corresponding to the first channel, and the second control is configured for changing the second type of the channel corresponding to the channel information in the first display region.

Step S6110 is similar to step S5410 and will not be repeated here.

In some embodiments, the second control has different display statuses, which may include a highlighted status and a non-highlighted status (a normal status). A display status of the second control corresponds to the second type of the channel corresponding to the channel information in the first display region. If the channel has the shortcut on the home interface, the display status of the second control is the highlighted status. If the channel has no shortcut on the home interface, the display status of the second control is not the highlighted status. In this way, the user may quickly determine the second type of the channel corresponding to the channel information in the first display region through the display status of the second control.

S6120, the second type of the first channel is changed in response to a first selection command input based on the second control from the user.

If the first channel has the shortcut set on the home interface, the shortcut of the first channel is deleted from the home interface; and if the first channel does not have the shortcut on the home interface, the shortcut of the first channel is added on the home interface.

When changing the second type of the first channel, the display apparatus modifies channel data in a home interface file, and the channel data in the home interface file may include a UID of the channel. The home interface file may be independent of a channel database or belongs to the channel database. The display apparatus may determine the second type of the first channel according to a UID of the first channel and the UID stored in the home interface file. If the home interface file has the UID of the first channel, it is determined that the first channel has the shortcut on the home interface; and if the home interface file does not have the UID of the first channel, it is determined that the first channel has no shortcut on the home interface. When the display apparatus adds the shortcut of the first channel to the home interface, the UID of the first channel is written in the home interface file. When the display apparatus deletes the shortcut of the first channel from the home interface, the UID of the first channel is deleted from the home interface file. The display apparatus updates the display of a UI page, such as the channel information bar, according to the updated home interface file.

In some embodiments, after changing the first channel to the delete the shortcut on the home interface, the display status of the second control is changed from the highlighted status to the non-highlighted status. After changing the first channel to add the shortcut on the home interface, the display status of the second control is changed from the non-highlighted status to the highlighted status.

In this way, the user may easily and quickly change the second type of the first channel based on the second control in the channel information bar, and the impact on watching the program video during a changing operation is relatively small.

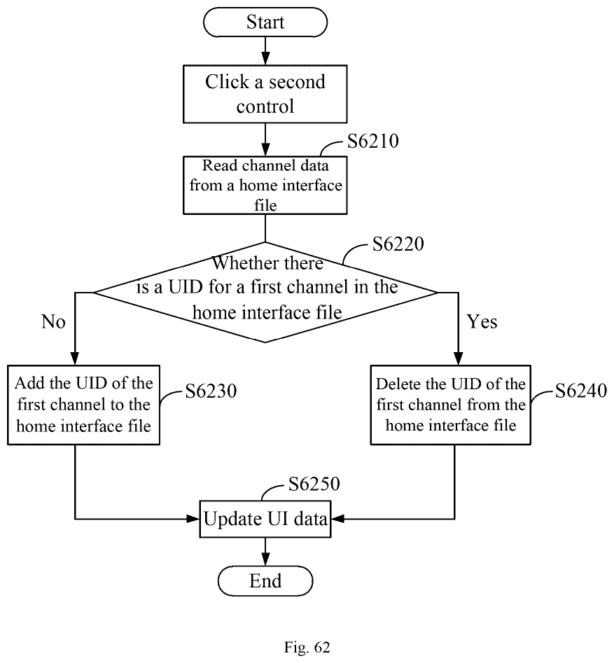

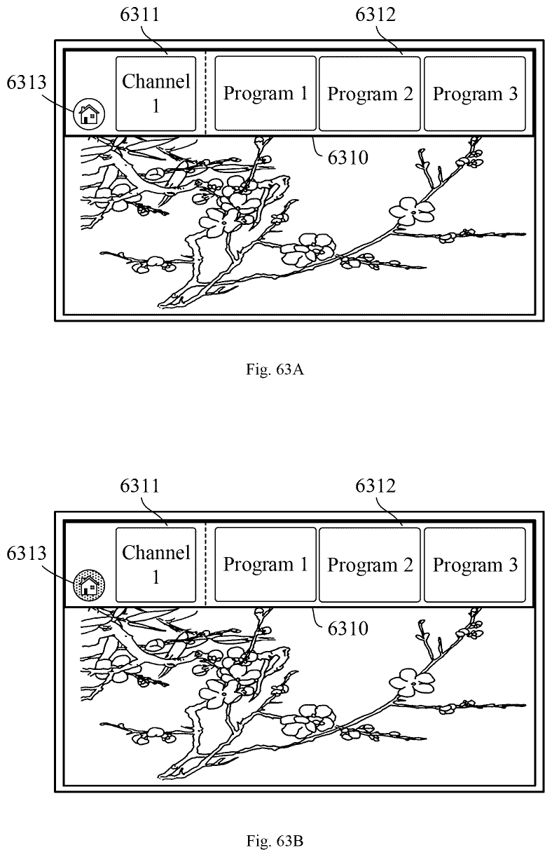

Steps S6110-S6120 are discussed in conjunction with a process shown in FIG. 62.

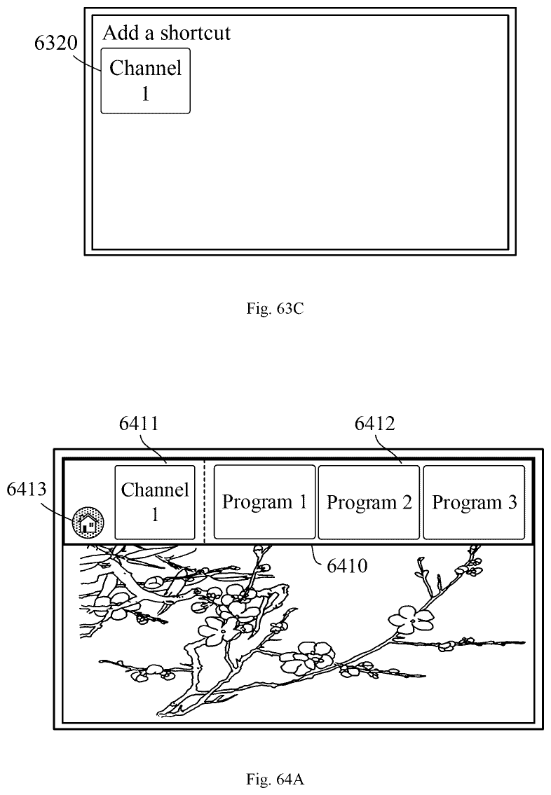

FIG. 63A, FIG. 63B and FIG. 63C are first schematic diagrams of interaction of modifying a second type of a first channel in a television according to some embodiments of the disclosure. Taking an example that a display apparatus is a television and a control device 100 is a remote control, the television plays a program video from the first channel in a first channel list, a user may input a first command based on an up key on the remote control, and the television displays a channel information bar 6310 on the program video in response to this command, as shown in FIG. 63A. The channel information bar 6310 may include a first display region 6311 and a second display region 6312, and the first display region 6311 may include channel information of the first channel, such as a channel 1. The second display region 6312 may include program information of the first channel, such as program information of a program 1, a program 2, and a program 3. The channel information bar 6310 may further include a second control 6313. Taking an example that the first channel has no shortcut on the home interface, the second control 6313 is not in a highlighted status. The user may move a focus to the second control 6313 based on direction keys on the remote control, and input a first selection command based on an OK key on the remote control. The television, in response to the first selection command, executes step S6210 to read channel data in a home interface file. After acquiring the channel data, the television further executes step S6220 to determine whether the home interface file has a UID of the first channel. In this example, the television may determine that the home interface file has no UID of the first channel, and then the television executes step S6230 to add the UID of the first channel to the home interface file. The television further executes step S6240 to update the UID data according to the updated home interface file. As shown in FIG. 63B, the second control 6313 is changed to highlighted display (shown in gray). If the user indicates the television to display the home interface, as shown in FIG. 63C, the television displays the home interface, and the home interface may include a shortcut 6320 of the first channel.

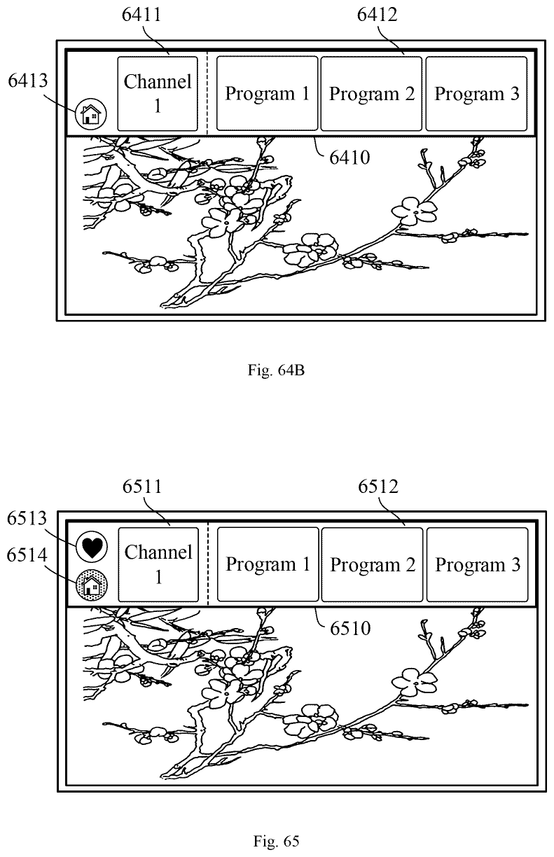

FIGS. 64A and 64B are second schematic diagrams of interaction of modifying a second type of a first channel in a television according to some embodiments of the disclosure. Taking an example that a display apparatus is a television and a control device 100 is a remote control, the television plays a program video from the first channel in a first channel list, a user may input a first command based on an up key on the remote control, and the television displays a channel information bar 6410 on the program video in response to this command, as shown in FIG. 64A. The channel information bar 6410 may include a first display region 6411 and a second display region 6412, and the first display region 6411 may include channel information of the first channel, such as a channel 1. The second display region 6412 may include program information of the first channel, such as program information of a program 1, a program 2, and a program 3. The channel information bar 6410 may further include a second control 6413. Taking an example that the first channel has a shortcut on the home interface, the second control 6413 is in a highlighted status. The user may move a focus to the second control 6413 based on direction keys on the remote control, and input a first selection command based on an OK key on the remote control. The television, in response to the first selection command, executes step S6210 to read channel data in a home interface file. After acquiring the channel data, the television further executes step S6220 to determine whether the home interface file has a UID of the first channel. In this example, the television may determine that the home interface file has the UID of the first channel, and then the television executes step S6250 to delete the UID of the first channel from the home interface file. The television further executes step S6240 to update the UID data according to the updated home interface file. As shown in FIG. 64B, the second control 6413 is changed to be not highlighted. If the user indicates the television to display the home interface, the home interface does not include a shortcut of the first channel.

If the user wants to change second types of other channels, the display apparatus needs to first switch the channel information in the channel information bar, and then change the second type of the corresponding channel based on the channel information in the channel information bar.

In some embodiments, taking an example that the user wants to change a second type of a second channel, if the first channel list may include the second channel, the user may directly input a switching command through up and down keys on the control device 100, and the display apparatus, in response to the switching command, switches the channel information displayed in the first display region, and correspondingly switches the program information in the second display region and the display status of the second control. At this time, the display apparatus still plays the program video from the first channel. The user may input a selection command based on the second control, so as to control the display apparatus to change the second type of the second channel. This embodiment can refer to the process that the user changes the first type of the second channel, which will not be repeated here.

In some other embodiments, taking an example that the user wants to change the second type of the second channel, the user may first switch the first channel list to a channel list to which the second channel belongs, such as a second channel list, through a first menu, and then switch to play the second channel in the second channel list. At this time, the display apparatus switches to play a program video from the second channel. When the display apparatus displays the program video from the second channel, the user may control the display apparatus to display the channel information bar. At this time, the first display region of the channel information bar may include channel information of the second channel, the second display region may include program information of the second channel, and a third control, and a display status of the third control corresponds to the second type of the second channel. The user may change the second type of the second channel through the third control. The above process is similar to steps S6010-S6050 and will not be repeated here.

In some embodiments, the display apparatus may simultaneously provide the first control and the second controls in the channel information bar, so that the user can modify the first type and/or the second type of the same channel based on the channel information bar. For example, when the display apparatus displays the program video from the first channel, in response to the first command from the user, as shown in FIG. 65, the channel information bar 6510 is displayed on the program video, and the channel information bar 6510 may include the first display region 6511 and the second display region 6512. The first display region 6511 may include channel information of the first channel, such as a channel 1. The second display region 6512 may include program information of the first channel, such as program information of a program 1, a program 2, and a program 3. The channel information bar 6510 may further include the first control 6513 and the second control 6514. Taking an example that the first channel is not a favorite channel, the first control 6513 is not in the highlighted status. Taking an example that the first channel has the shortcut on the home interface, the second control 6514 is in the highlighted status. The user may change the first type and the second type of the first channel respectively based on the first control 6513 and the second control 6514, which is not repeated here.

In some other embodiments, the user may also change first types and second types of other channels based on the first control and the second control on the channel information bar, which is not repeated here.

In some embodiments, the second display region may further include a progress bar, the progress bar is displayed on a first display location in the second display region, and program information in the first display location corresponds to a program currently played on the first channel. A length of the progress bar is the same as a length of the first display location, and is configured for representing a total duration of the program. The progress bar may further include a highlight portion, and the highlight portion is configured for representing a duration of the program that has been played.

There is a proportional relationship among the total length of the progress bar, the total duration of the program, the length of the highlight portion, and the duration of the program that has been played. For example, a ratio of the total length of the progress bar to the length of the highlight portion is equal to a ratio of the total duration of the program to the duration of the program that has been played. The display apparatus may update the display of the highlight portion according to this proportional relationship.

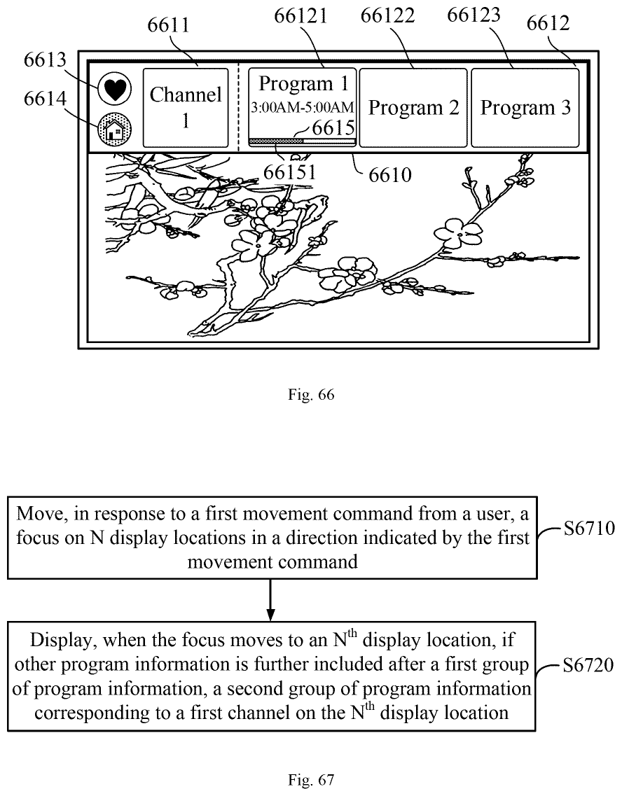

Exemplarily, as shown in FIG. 66, the display apparatus displays the channel information bar 6610 on the program video from the first channel. The channel information bar 6610 may include the first display region 6611 and the second display region 6612, the first display region 6611 may include the channel information of the first channel, such as the channel 1, and the second display region 6612 may include the program information corresponding to the first channel, such as program information of a program A, a program B, and a program C. The channel information bar 6610 may further include the first control 6613 and the second control 6614. A region configured for displaying each piece of program information in the second display region 6612 is the display location, such as a display location 66121, a display location 66122, and a display location 66123. If the program A is the program currently played on first channel, the display location 66121 displays the progress bar 6615, and the total length of the progress bar 6615 is equal to the length of the display location 66121. If the playback time of the program A is 3:00 AM-5:00 AM, the total duration of the program A is 2 hours. If the current system time is 4:00 AM, the duration that the program A has been played is 1 hour. The progress bar 6615 may include the highlight portion 66151, and the ratio of the total length of the progress bar 6615 to the length of the highlight portion 66151 is equal to a ratio of 2 hours to 1 hour. In this way, a style of the progress bar 6615 is more obvious, and the dynamic changes of the highlight portion 66151 on the progress bar are more obvious. The user may more quickly and accurately determine the playback progress of the program A based on the progress bar 6615 and the highlight portion 66151.

In some embodiments, the display apparatus may browse all program information of the first channel, and the display apparatus may display the program information according to a process shown in FIG. 67, which may include the following steps.

S6710, in response to a first movement command from the user, the focus is moved on N display locations in a direction indicated by the first movement command.

The second display region may include N display locations, and each display location displays program information for one program. The display apparatus, in response to the first command from the user, displays a first group of program information corresponding to the first channel on the N display locations. The first group of program information may include the program information of the currently played program. For example, the program information of the currently played program is displayed on the first display location. According to a playback order of the programs, program information of N−1 programs located after the currently played program on a (2-N)^{th} display location in sequence. The program information of N programs of the first program which is the currently played program is taken as the first group of program information.

The user may input the first movement command through a left key and a right key on the control device 100. The display apparatus moves the focus on the N display locations in response to the first movement command. For example, the user inputs the first movement command based on the right key, and the display apparatus moves the focus to the right on the N display locations in response to the first movement command.

If the quantity of the first group of program information is less than N, the focus may be moved to the display location corresponding to the last program information in the first group of program information according to a manner indicated by the first movement command, and stay at the display location.

S6720, when the focus moves to the N^{th} display location, if other program information may further be included after the first group of program information, a second group of program information corresponding to the first channel is displayed on the N^{th} display location.

If other program information is not included after the first group of program information, when the focus is moved to the N^{th} display location, the focus stays on the N^{th} display location.

If other program information may further be included after the first group of program information, it indicates that the first channel still has program information that is not displayed in the second display region according to the manner indicated by the first movement command. In order to timely remind the user of any undisplayed program information, when the focus is moved to the N^{th} display location, if other program information may further be included after the first group of program information, the second group of program information is updated and displayed on the N^{th} display location. The first program information in the second group of program information is the N^{th} program information in the first group of program information. That is to say, the program information following the first group of N pieces of program information is automatically displayed.

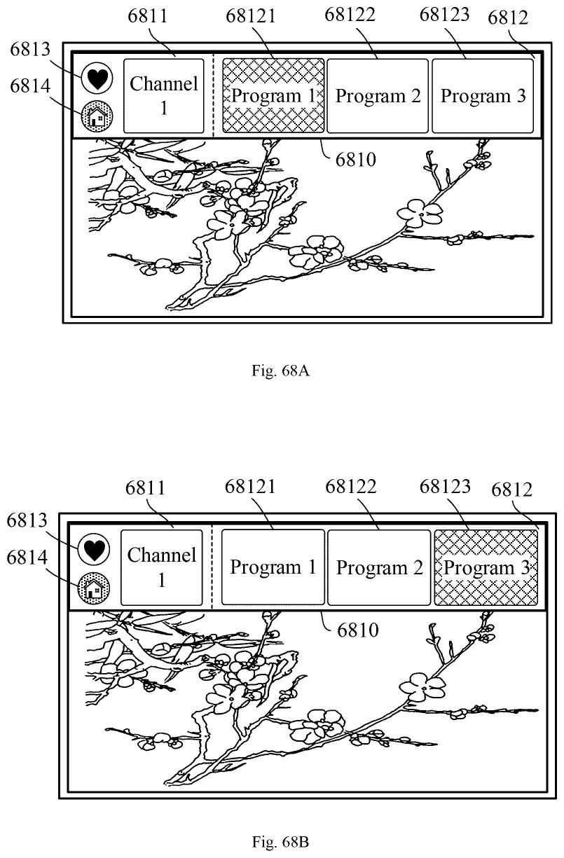

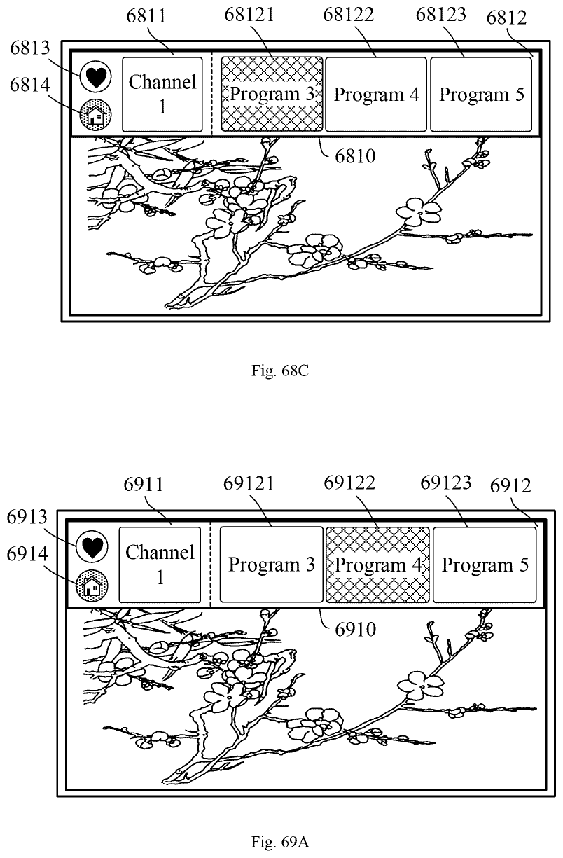

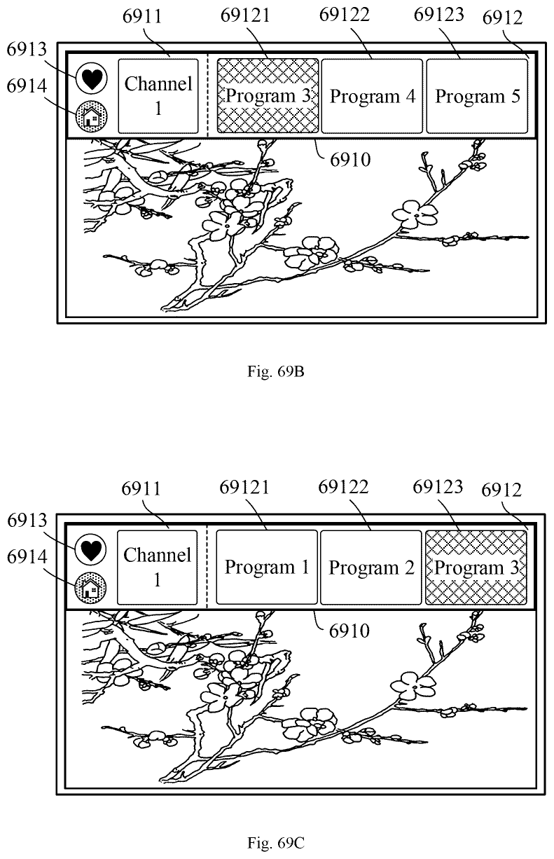

Steps S6710-S6720 are exemplarily illustrated in conjunction with FIG. 68A, FIG. 68B, and FIG. 68C. FIG. 68A, FIG. 68B and FIG. 68C are schematic diagrams of interaction of displaying program information in a television according to some embodiments of the disclosure. Taking an example that a display apparatus is a television and a control device 100 is a remote control, as shown in FIG. 68A, the television displays a channel information bar 6810 on a program video from a first channel. The channel information bar 6810 may include a first display region 6811 and a second display region 6812, the first display region 6811 may include channel information of the first channel, such as a channel 1, and the second display region 6812 may include N display locations. Taking N=3 as an example, that is, the second display region 6812 may include 3 display locations, such as a display location 68121, a display location 68122, and a display location 68123, wherein each display location is configured for displaying program information of a program corresponding to the first channel. The television displays a first group of program information on the 3 display locations, such as program information of a program 1, a program 2, and a program 3. The channel information bar 6810 may further include a first control 6813 and a second control 6814. Taking an example that a program A is a currently played program, a focus (shown in gray) is first displayed on the display location 68121. The user may input a first movement command through a right key on the remote control, and the television moves the focus to the right on the 3 display locations in response to the first movement command. Taking an example that the first channel may include the program 1, the program 2, the program 3, a program 4, and a program 5 in sequence in a program broadcast order, as shown in FIG. 68B, when the focus is moved to the display location 68123, the television may further include other program information after determining the program 3. As shown in FIG. 68C, the television displays a second group of program information on the 3 display locations. The first program information of the second group of program information is the N^{th} program information in the first group of program information, namely, the program information of the program 3. The focus is displayed on a display location where the first program information in the second group of program information is located, that is, the focus is displayed on the display location 68121. In this way, the user can quickly understand program information that is not displayed on the display location.

In some other embodiments, a direction indicated by the first movement command is opposite to the broadcast order of the program. For example, when the user inputs the first movement command based on the left key of the control device 100, the display apparatus moves the focus to the left on the N display locations. When the focus is moved to a first display location, if other program information is not included before the first group of program information, when the focus is moved to the first display location, the focus stays on the first display location.

If other program information may further be included before the first group of program information, it indicates that the first channel still has program information that is not displayed in the second display region according to a manner indicated by the first movement command. In order to timely remind the user of any undisplayed program information, when the focus is moved to the first display location, if other program information may further be included before the first group of program information, the second group of program information is updated and displayed on the N^{th} display location. The N^{th} program information in the second group of program information is the first program information in the first group of program information. That is to say, the program information before the first group of N program information is automatically displayed.

Exemplary illustration is made in conjunction with FIG. 69A, FIG. 69B, and FIG. 69C. Taking an example that a display apparatus is a television and a control device 100 is a remote control, as shown in FIG. 69A, the television displays a channel information bar 6910 on a program video from a first channel. The channel information bar 6910 may include a first display region 6911 and a second display region 6912, the first display region 6911 may include channel information of the first channel, such as a channel 1, and the second display region 6912 may include N display locations. Taking N=3 as an example, the second display region 6912 may include 3 display locations, such as a display location 69121, a display location 69122, and a display location 69123, wherein each display location is configured for displaying program information of a program corresponding to the first channel. The television displays a first group of program information on the 3 display locations, such as program information of a program 3, a program 4, and a program 5. The channel information bar 6910 may further include a first control 6913 and a second control 6914. The focus is currently displayed on the display location 69122. The user may input a first movement command based on a left key on the remote control, and the television moves the focus to the left on the 3 display locations in response to the first movement command. Taking an example that the first channel may include the program 1, the program 2, the program 3, a program 4, and a program 5 in sequence in a program broadcast order, as shown in FIG. 69B, when the focus is moved to the display location 69121, the television may further include other program information before determining the program 3. As shown in FIG. 69C, the television displays a second group of program information on the 3 display locations. The N^{th} program information of the second group of program information is the first program information in the first group of program information, namely, the program information of the program 3. In this way, the user can quickly understand program information that is not displayed on the display location.

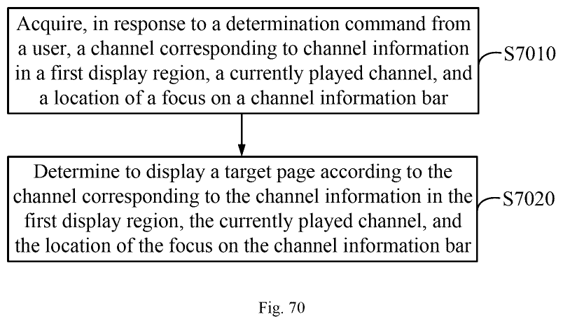

In some embodiments, the display apparatus may switch the channel and display a program detail page. The display apparatus may switch the channel and display the program detail page according to a process shown in FIG. 70, which may include:

S7010, in response to a determination command from the user, a channel corresponding to the channel information in the first display region, a currently played channel, and a location of the focus on the channel information bar are acquired.

The display apparatus, in response to the determination command, executes different operations according to the channel corresponding to the channel information in the first display region, the currently played channel, and the location of the focus on the channel information bar.

The location of the focus on the channel information bar may include the first display region, a display location corresponding to program information of a designated program in the second display region, and a display location corresponding to program information of a non-designated program in the second display region. The designated program is a program currently played on the channel corresponding to the channel information in the first display region.

S7020, it is determined to display the target page according to the channel corresponding to the channel information in the first display region, the currently played channel, and the location of the focus on the channel information bar.

The target page is a program video or a program detail page.

If the channel corresponding to the channel information in the first display region is the same as the currently played channel, when the focus is on the first display region, the display apparatus will not respond, that is, the current program video is still be displayed.

If the channel corresponding to the channel information in the first display region is the same as the currently played channel, when the focus is on the display location in the second display region, the display apparatus displays the program detail page corresponding to the program information in that display location.

If the channel corresponding to the channel information in the first display region is different from the currently played channel, when the focus is on the first display region or the display location corresponding to the program information of the designated program in the second display region, the program video from the designated program is displayed, that is, other channels are switched to be played.

If the channel corresponding to the channel information in the first display region is different from the currently played channel, when the focus is on the display location corresponding to the program information of the non-designated program in the second display region, the program detail page of the non-designated program is displayed.

The program detail page may include a first button and/or a second button. The first button is configured for initiating a scheduled recording of the corresponding program, and providing a personal video recorder (PVR) service. The second button is configured for initiating a reminder for scheduled recording of the corresponding program. In this way, the user may input a selection command based on the first button, and the display apparatus initiates the scheduled recording of the corresponding program in response to the selection command, so that the corresponding program is automatically recorded when a broadcast time of the corresponding program is reached. The user may input a selection command based on the second button, and the display apparatus initiates the reminder of the scheduled recording of the corresponding program in response to the selection command, so that the reminder is played to prompt the user to initiate the recording of the corresponding program a reminder time set by the user is reached.

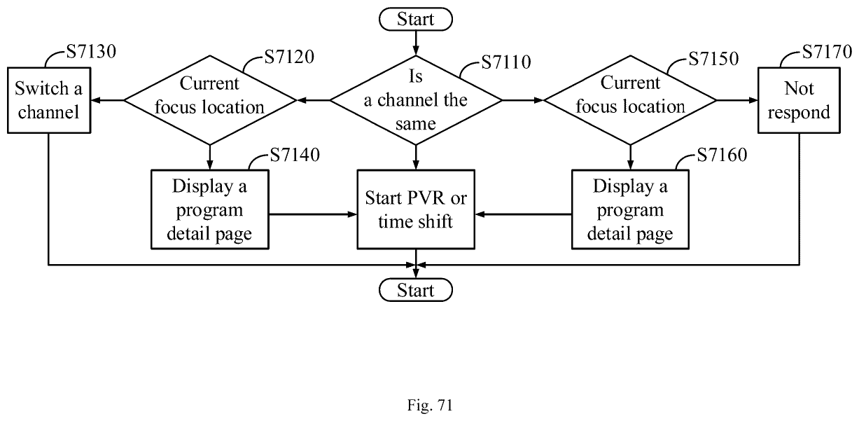

Steps S7010-S7020 are discussed in conjunction with a process shown in FIG. 71.

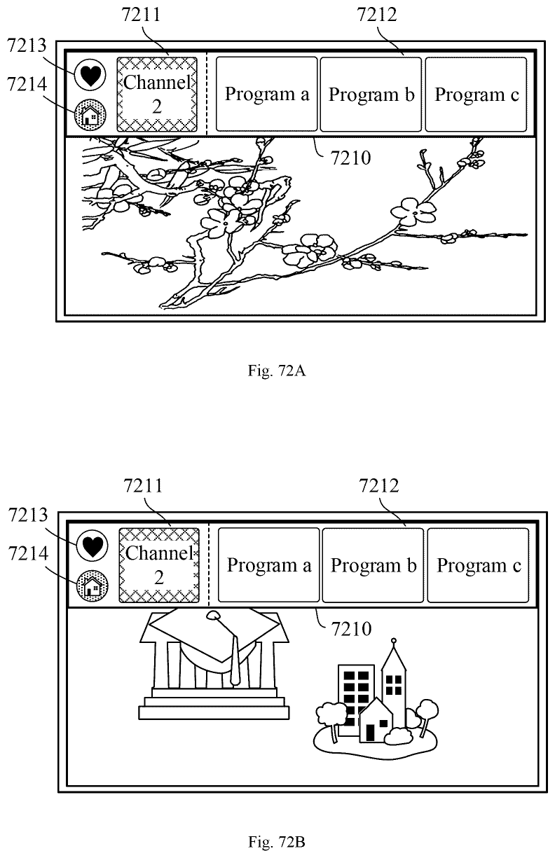

FIG. 72A and FIG. 72B are schematic diagrams of interaction of switching a channel in a television according to some embodiments of the disclosure. Taking an example that a display apparatus is a television and a control device 100 is a remote control, as shown in FIG. 72A, the television displays a channel information bar 7210 on a program video from a first channel. The channel information bar 7210 may include a first display region 7211 and a second display region 7212, the first display region 7211 may include channel information of a second channel, such as a channel 2, and the second display region 7212 may include program information corresponding to the second channel, such as program information of a program a, a program b, and a program c. The channel information bar 7210 may further include a first control 7213 and a second control 7214. When moving a focus (shown in gray) to the first display region 7211 through direction keys on the remote control, a user inputs a determination command based on an OK or an enter key on the remote control. The television, in response to the determination command, executes step S7110 to compare whether a channel in the first display region is the same as a currently played channel. In this example, the television may determine that the channel in the first display region is different from the currently played channel. The television executes step S7120 to acquire a current location of the focus. In this example, if the television may determine that the focus is located in the first display region, step S7130 is executed to display a picture of the program a if the program a is a program currently played on the second channel, as shown in FIG. 72B.

If the focus is moved to a display location corresponding to program information of the program a, the television executes step S7120 and then executes step S7130 to display the picture of the program a.

If the focus is moved to a display location corresponding to program information of the program b or the program c, the television executes step S7129 and then executes step S7140 to display a program detail page of the corresponding program.

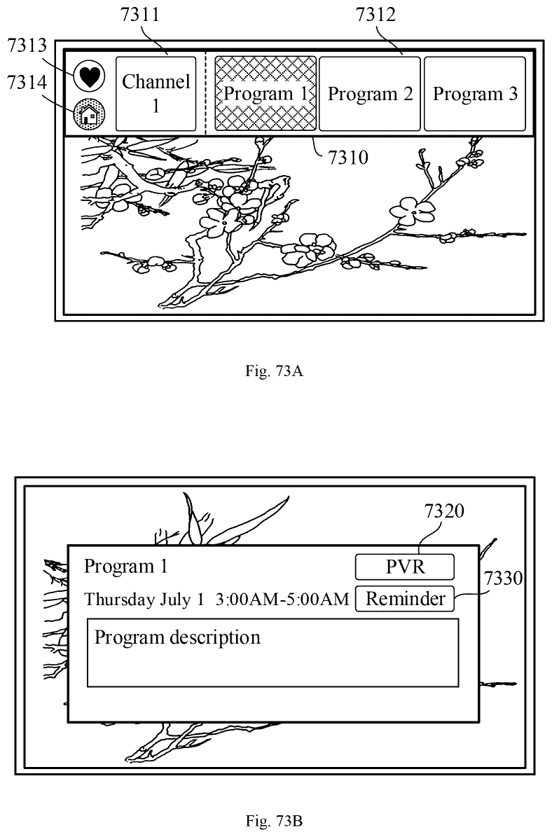

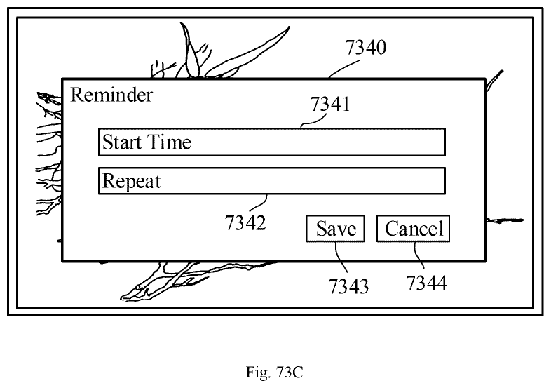

FIG. 73A, FIG. 73B and FIG. 73C are schematic diagrams of interaction of displaying a program detail page in a television according to some embodiments of the disclosure. Taking an example that a display apparatus is a television and a control device 100 is a remote control, as shown in FIG. 73A, the television displays a channel information bar 7310 on a program video from a first channel. The channel information bar 7310 may include a first display region 7311 and a second display region 7312, the first display region 7311 may include channel information of the first channel, such as a channel 1, and the second display region 7312 may include program information corresponding to the first channel, such as program information of a program 1, a program 2, and a program 3. The channel information bar 2501 may further include a first control 7313 and a second control 7314. When moving a focus (shown in gray) to a display location corresponding to the program 1 through direction keys on the remote control, a user inputs a determination command based on an OK or an enter key on the remote control. The television, in response to the determination command, executes step S7110 to compare whether a channel in the first display region is the same as a currently played channel. In this example, the television may determine that the channel in the first display region is the same as the currently played channel. The television executes step S7150 to acquire a current location of the focus. In this example, if the television may determine that the focus is located in the display location corresponding to the program 1, step S7160 is executed to display a program detail page of the program 1, as shown in FIG. 73B.

If the focus is moved to a display location corresponding to program information of the program 2 or the program 3, the television executes step S7150 and then executes step S7160 to display a program detail page of the corresponding program.

When the focus is moved to the first display region 7311, the television executes step S7150 and then executes step S7170 without continuing to respond.

Taking the program detail page of the program 1 as an example, as shown in FIG. 73B, the program detail page may be in a form of a pop-up window. The program detail page may include more information of the program 1, such as a program title, a subtitle, a program start time, audio and video format information, program rating, a program attribute label, and program description information. If the program 1 is an OTT program, the program detail page may include a poster of the program 1, information about a content provider, etc. If the program 1 is a DTV program, the program detail page may include a first button 7320, such as a PVR button, and a second button 7330, such as a Reminder button. If the user selects the second button 7330, as shown in FIG. 73C, the display apparatus displays a reminder setting box 7340 on the program video. The reminder setting box 7340 may include a start time setting region 7341 for playing a reminder and a repeat setting region 7342. The reminder setting box 7340 may further include a save button 7343 and a cancel button 7344. After setting a start time and a repeat, the user may select the save button 7343, so that the display apparatus plays the reminder.

In order to facilitate explanation, the above description has been performed with reference to the specific implementations. However, the above discussion in some embodiments does not intent to exhaust or limit the implementations to the specific form disclosed above. Various modifications and variations may be obtained according to the above instruction. The selection and description of the above implementations are for better explaining the content of the disclosure, so that those skilled in the art better use the implementations.

What is claimed is:

1. A display apparatus, comprising:
a display, configured to display an image or a user interface, the user interface comprising a setting interface;
a communicating device, configured to receive a voice command input from a user, the voice command being configured for setting a target setting option of the display apparatus, wherein, the display apparatus comprises a plurality of setting options, and the target setting option is any one of the plurality of setting options; and
at least one processor, in connection with the display and the communicating device respectively, and configured to execute computer instructions to cause the display apparatus to execute:
sending a voice command to a server through the communicating device, to cause the server to parse the voice command and determine semantic information corresponding to the voice command;
receiving the semantic information sent from the server, and determining setting parameters corresponding to the voice command according to the semantic information; and
controlling the display to display a target setting interface according to the setting parameters, and setting the target setting option in the target setting interface according to the setting parameters;
wherein the voice command is configured for indicating to switch a display page of the display to an automatic channel search page, the target setting option is a function setting option in a closed status when the automatic channel search page is opened, and/or a corresponding password inputting option when the automatic channel search page is opened, and the at least one processor is further configured to execute computer instructions to cause the display apparatus to execute:
based on that the function setting option is in an opened status and/or a password corresponding to the password inputting option is in an unconfirmed status, determining that the target setting option and/or a target value of the target setting option do/does not meet a setting condition; and
based on that the target setting option and/or the target value of the target setting option do/does not meet the setting condition, displaying prompt information on the display in order to provide information for a user to close the function setting option according to the prompt information, and/or input a password in the password inputting option according to the prompt information.

2. The display apparatus according to claim 1, wherein the semantic information comprises the target setting option and the target value of the target setting option, and the at least one processor is further configured to execute computer instructions to cause the display apparatus to execute:
acquiring option configuration data of the display apparatus, the option configuration data being configured by using a tree data structure;
searching, in the option configuration data, for a node path that matches the target setting option and the target value of the target setting option, the node path comprising at least one node level, and the node level comprising at least one data node; and
determining the setting parameters based on each node level in the node path and the data node in each node level, the setting parameters comprising an interface level of the target setting interface, a parent level setting option of the target setting option, and the target value of the target setting option.

3. The display apparatus according to claim 2, wherein the setting parameters further comprise a setting identifier of the target setting option, the setting identifier is configured for indicating whether the target setting option and the target value of the target setting option meet the setting condition, and the at least one processor is further configured to execute computer instructions to cause the display apparatus to execute:
based on that the target setting option and/or the target value do/does not meet the setting condition according to the setting identifier in the setting parameters, displaying the prompt information on the display, in order to provide information for the user to set the display apparatus according to the prompt information.

4. The display apparatus according to claim 3, wherein the voice command is configured for indicating to set the target setting option as the target value, and the at least one processor is further configured to execute computer instructions to cause the display apparatus to execute:
based on that the target setting option is not available for setting as the target value, determining that the target setting option and/or the target value do/does not meet the setting condition; and
based on that the target setting option and/or the target value do/does not meet the setting condition, displaying the prompt information on the display, in order to provide information for the user to set the target setting option as other target values according to the prompt information.

5. The display apparatus according to claim 3, wherein the voice command is configured for indicating to open the target setting option, and the at least one processor is further configured to execute computer instructions to cause the display apparatus to execute:
based on that a pre-setting function of the target setting option is not set, determining that the target setting option and/or the target value do/does not meet the setting condition; and
based on that the target setting option and/or the target value do/does not meet the setting condition, displaying the prompt information on the display, in order to provide information for the user to set the pre-setting function of the target setting option according to the prompt information.

6. The display apparatus according to claim 1, wherein the setting parameters comprise at least one of a mode selection parameter, an on-off control parameter, a numeric value setting parameter, or a page control parameter.

7. The display apparatus according to claim 2, wherein the at least one processor is further configured to execute computer instructions to cause the display apparatus to execute:
querying node data of each node, and determining a first data node that matches the target setting option, and a second data node that matches the target value of the target setting option; and
determining the node path that matches the target setting option and the target value of the target setting option according to a node path of the first data node and a node path of the second data node.

8. The display apparatus according to claim 7, wherein the at least one processor is further configured to execute computer instructions to cause the display apparatus to execute:
determining whether the target setting option exists in node information corresponding to the node path;
based on that the target setting option exists in the node information corresponding to the node path, determining whether a level where the target setting option is located and the parent level setting option corresponding to the target setting option is available for setting; and
based on that the parent level setting option is available for setting, setting the display apparatus according to a type of the target setting option.

9. The display apparatus according to claim 7, wherein the at least one processor is further configured to execute computer instructions to cause the display apparatus to execute:
determining whether each level setting option corresponding to the found target setting option is unavailable for being directly set according to the node information corresponding to the node path; and
cutting off the node path based on that the level setting options are available for being directly set.

10. A method for a display apparatus, comprising:
receiving a voice command input from a user, the voice command being configured for setting a target setting option of the display apparatus, wherein, the display apparatus comprises a plurality of setting options, and the target setting option is any one of the plurality of setting options;
sending a voice command to a server, to cause the server to parse the voice command and determine semantic information corresponding to the voice command;
receiving the semantic information sent from the server, and determining setting parameters corresponding to the voice command according to the semantic information; and
controlling a display to display a target setting interface according to the setting parameters, and setting the target setting option in the target setting interface according to the setting parameters;
wherein the voice command is configured for indicating to switch a display page of the display to an automatic channel search page, the target setting option is a function setting option in a closed status when the automatic channel search page is opened, and/or a corresponding password inputting option when the automatic channel search page is opened, and the method further comprises:
based on that the function setting option is in an opened status and/or a password corresponding to the password inputting option is in an unconfirmed status, determining that the target setting option and/or a target value of the target setting option do/does not meet a setting condition; and
based on that the target setting option and/or the target value of the target setting option do/does not meet the setting condition, displaying prompt information on the display in order to provide information for a user to close the function setting option according to the prompt information, and/or input a password in the password inputting option according to the prompt information.

11. The method according to claim 10, wherein the semantic information comprises the target setting option and the target value of the target setting option, and the method further comprises:
acquiring option configuration data of the display apparatus, the option configuration data being configured by using a tree data structure;
searching, in the option configuration data, for a node path that matches the target setting option and the target value of the target setting option, the node path comprising at least one node level, and the node level comprising at least one data node; and
determining the setting parameters based on each node level in the node path and the data node in each node level, the setting parameters comprising an interface level of the target setting interface, a parent level setting option of the target setting option, and the target value of the target setting option.

12. The method according to claim 11, wherein the setting parameters further comprise a setting identifier of the target setting option, the setting identifier is configured for indicating whether the target setting option and the target value of the target setting option meet the setting condition, and the method further comprises:
based on that the target setting option and/or the target value do/does not meet the setting condition according to the setting identifier in the setting parameters, displaying the prompt information on the display, in order to provide information for the user to set the display apparatus according to the prompt information.

13. The method according to claim 12, wherein the voice command is configured for indicating to set the target setting option as the target value, and the method further comprises:
based on that the target setting option is not available for setting as the target value, determining that the target setting option and/or the target value do/does not meet the setting condition; and
based on that the target setting option and/or the target value do/does not meet the setting condition, displaying the prompt information on the display, in order to provide information for the user to set the target setting option as other target values according to the prompt information.

14. The method according to claim 12, wherein the voice command is configured for indicating to open the target setting option, and the method further comprises:
based on that a pre-setting function of the target setting option is not set, determining that the target setting option and/or the target value do/does not meet the setting condition; and
based on that the target setting option and/or the target value do/does not meet the setting condition, displaying the prompt information on the display, in order to provide information for the user to set the pre-setting function of the target setting option according to the prompt information.

15. The method according to claim 10, wherein the setting parameters comprise at least one of a mode selection parameter, an on-off control parameter, a numeric value setting parameter, or a page control parameter.

16. The method according to claim 11, further comprising:
querying node data of each node, and determining a first data node that matches the target setting option, and a second data node that matches the target value of the target setting option; and
determining the node path that matches the target setting option and the target value of the target setting option according to a node path of the first data node and a node path of the second data node.

17. The method according to claim 16, further comprising:
determining whether the target setting option exists in node information corresponding to the node path;
based on that the target setting option exists in the node information corresponding to the node path, determining whether a level where the target setting option is located and the parent level setting option corresponding to the target setting option is available for setting; and
based on that the parent level setting option is available for setting, setting the display apparatus according to a type of the target setting option.

18. The method according to claim 16, further comprising:
determining whether each level setting option corresponding to the found target setting option is unavailable for being directly set according to the node information corresponding to the node path; and
cutting off the node path based on that the level setting options are available for being directly set.

19. The display apparatus according to claim 1, wherein the automatic channel search page refers to a page in the display apparatus for automatically searching for television channels.

20. The method according to claim 10, wherein the automatic channel search page refers to a page in the display apparatus for automatically searching for television channels.
